(19) United States
(12) Patent Application Publication
(10) Pub. No.: US 2024/0108986 A1
(43) Pub. Date: Apr. 4, 2024

(54) GAME SYSTEM, GAME METHOD, GAME PROGRAM, AND GAME SERVER

(71) Applicant: The Pokémon Company, Tokyo (JP)

(72) Inventors: Masaaki HOSHINO, Tokyo (JP); Yuki GABE, Tokyo (JP); Naoya OIKAWA, Tokyo (JP); Norihiro SERA, Tokyo (JP); Yixiang LI, Tokyo (JP)

(73) Assignee: The Pokémon Company, Tokyo (JP)

(21) Appl. No.: 18/533,204

(22) Filed: Dec. 8, 2023

Related U.S. Application Data
(63) Continuation of application No. PCT/JP2022/014261, filed on Mar. 25, 2022.

(30) Foreign Application Priority Data
Jun. 9, 2021 (JP) 2021-096956

(51) Int. Cl. A63F 13/58; A63F 13/35; A63F 13/46; A63F 13/56; A63F 13/847

(52) U.S. Cl. CPC A63F 13/58; A63F 13/35; A63F 13/46; A63F 13/56; A63F 13/847

(57) ABSTRACT

A game system that contributes to a team not through an inter-person battle but through an action in a game and can provide an exciting fight even in a final stage of the game is provided. The game system includes processing circuitry configured to control assignment of a predetermined point associated with a neutral character to a player; set points assigned to the player as a score of the ally team; and determine a victory or a defeat by comparing a score of the ally team with a score of the enemy team, wherein the display, before a victory or a defeat is determined, does not display totals of scores of the ally team and the enemy team and, after a victory or a defeat is determined, displays a total of scores of each team and displays a score progress of a predetermined player character.

### CROSS-REFERENCE TO RELATED APPLICATIONS

This application is a continuation of International Application No. PCT/JP2022/014261, filed Mar. 25, 2022, which claims priority to JP 2021-096956, filed Jun. 9, 2021, the entire contents of each are incorporated herein by reference.

### BACKGROUND

### Technical Field

The present disclosure relates to a game system, a game method, a game program, and a game server. Particularly, the present disclosure relates to a game system, a game method, a game program, and a game server in which a plurality of players can simultaneously play a game through a communication network.

### Description of Related Art

In recent years, multiplayer online battle arenas (MOBAs), which are games in which a plurality of players are divided into a plurality of teams (typically, two teams), and destruction of a headquarter of an opponent team in cooperation with players of a team to which a player belongs (an ally team) and the like are set as victory conditions, are actively played. In a MOBA, a many-to-many inter-person battle can be performed, and thus it has high amusement.

Here, in order to gain a victory in a battle between characters operated by persons, that is, an inter-person battle, a skill is necessary for an operation of a character, and before a character operated by a person actually defeats an opponent, training corresponding thereto may be required. In addition, in a case in which a player without experience with an operation belongs to an ally team, in order for the ally team to defeat an opponent team, players other than this inexperienced player need to support the inexperienced player. For this reason, this inexperienced player may hesitate to participate in a game out of concern that he or she may cause trouble to the ally team.

Thus, conventionally, an information processing system including an operation input reception means that receives a user's operation input and an information processing means that performs information processing on the basis of the operation input received by the operation input reception means is known, in which the information processing means includes a game advancing means that draws corresponding colors of its own character in a virtual space by controlling the own character inside a virtual space on the basis of an operation input and a fighting determining means that performs fighting determination on the basis of a drawing state for a virtual space of corresponding colors of an opponent character different from corresponding colors of the own character and a drawing state for a virtual space of corresponding colors of the own character (for example, see PTL 1). According to the information processing system described in PTL 1, by controlling the own character inside the virtual space, the virtual space can be drawn using corresponding colors of the own character, and fighting determination can be performed on the basis of a drawing state thereof and a drawing state of corresponding colors of an opponent character.

### CITATION LIST

### Patent Literature

[PTL 1] Japanese Patent Application Laid-open No. 2015-216971

### SUMMARY

### Technical Problems

However, in the information processing system as described in PTL 1, although contribution to victory of an ally team can be performed by drawing corresponding colors into a virtual space, there are cases in which there is little room to enjoy an operation of a character with an inter-person battle considered, which is one source of amusement in a MOBA, a review of strategies of an ally team, and the like. In addition, in the information processing system as described in PTL 1, there are also cases in which it is difficult to lower psychological barriers of a beginner who hesitates to join an inter-person battle and a player without experience with an operation for an inter-person battle. Furthermore, in a conventional information processing system, scores acquired through fighting can be easily perceived at any time, and thus there are cases in which desire of players to play a game disappears in a case in which a score difference is large. In a many-to-many fighting game, even when one player leaves, a balance between teams collapses, which becomes a factor that reduces amusement of the fighting game.

Thus, an objective of the present disclosure is to provide a game system, a game method, a game program, and a game server that, in a game in which a plurality of players can participate, can contribute to a team through an action other than an inter-person battle in the game and can provide an exciting fight even in a final stage of the game.

### Solutions to Problems

In order to achieve the object described above, the present disclosure provides a game system in which an ally team to which a player belongs and an enemy team to which other players belong contend with each other on a play field displayed on a display unit, the game system including: a display control unit configured to control display of the display unit; a point assignment control unit configured to control assignment of predetermined points associated with a neutral character to the player on the basis of a result of a fight when the neutral character that operates without being operated by the player and the other players and is associated with the predetermined points and the player character fight each other; a scoring unit configured to set points assigned to the player as a score of the ally team in a case in which the player character is positioned inside a predetermined area disposed inside the play field; and a victory/defeat determining unit configured to determine victory or defeat by comparing a score of the ally team with a score of the enemy team, wherein the display control unit, before victory or defeat is determined by the victory/defeat determining unit, does not display totals of scores of the ally team and the enemy team on the display unit, and after victory or defeat is determined by the victory/defeat determining unit, displays totals of scores of the ally team and the enemy team and displays score progress of each of one or more player characters belonging to the ally team on the display unit.

### Advantageous Effects

According to a game system, a game method, a game program, and a game server according to the present disclosure, the game system, the game method, the game program, and the game server that, in a game in which a plurality of players can participate, can contribute to a team not through an inter-person battle but through an action in a game and can provide exciting fighting even in a final stage of the game can be provided.

### BRIEF DESCRIPTION OF DRAWINGS

FIG. 1 is a schematic view of a game system according to an exemplary embodiment.

FIG. 2 is a schematic view of a play field of a game executed in the game system according to an exemplary embodiment.

FIG. 3 is a block diagram of a functional configuration of the game system according to an exemplary embodiment.

FIG. 4 is a data configuration diagram of each storage unit included in a storage unit according to an exemplary embodiment.

FIG. 5 is a schematic view of a movement instruction for a player character performed using an input unit according to an exemplary embodiment.

FIG. 6 is a schematic view of fighting between a player character and a neutral character in the game system according to an exemplary embodiment.

FIG. 7 is a schematic view of fighting between a player character and a neutral character in the game system according to an exemplary embodiment.

FIG. 8 is a schematic view of fighting between a player character and a neutral character in the game system according to an exemplary embodiment.

FIG. 9 is a schematic view of co-fighting of a player character and an ally character in the game system according to an exemplary embodiment.

FIG. 10 is a schematic view of co-fighting of a player character and an ally character in the game system according to an exemplary embodiment.

FIG. 11 is a schematic view of scoring points in the game system according to an exemplary embodiment.

FIG. 12 is a schematic view of scoring points in the game system according to an exemplary embodiment.

FIG. 13 is a schematic view of a first special character in the game system according to an exemplary embodiment.

FIG. 14 is a schematic view of a first special character in the game system according to an exemplary embodiment.

FIG. 15 is a schematic view of a second special character in the game system according to an exemplary embodiment.

FIG. 16 is a schematic view of a restriction generating unit in the game system according to an exemplary embodiment.

FIG. 17 is a display outline diagram of a display unit in the game system according to an exemplary embodiment.

FIG. 18 is a display outline diagram of a display unit in the game system according to an exemplary embodiment.

FIG. 19 is a diagram of display of a fighting result in the game system according to an exemplary embodiment.

FIG. 20 is a diagram of display of a fighting result in the game system according to an exemplary embodiment.

FIG. 21 is a diagram of display of a fighting result in the game system according to an exemplary embodiment.

FIG. 22 is a diagram of display of a fighting result in the game system according to an exemplary embodiment.

FIG. 23 is a flowchart showing processing performed in the game system according to an exemplary embodiment.

FIG. 24 is a flowchart showing processing performed in the game system according to an exemplary embodiment.

FIG. 25 is a flowchart showing processing performed in the game system according to an exemplary embodiment.

FIG. 26 is a flowchart showing processing performed in the game system according to an exemplary embodiment.

### DETAILED DESCRIPTION

### Embodiment

<Overview of Game System 1>

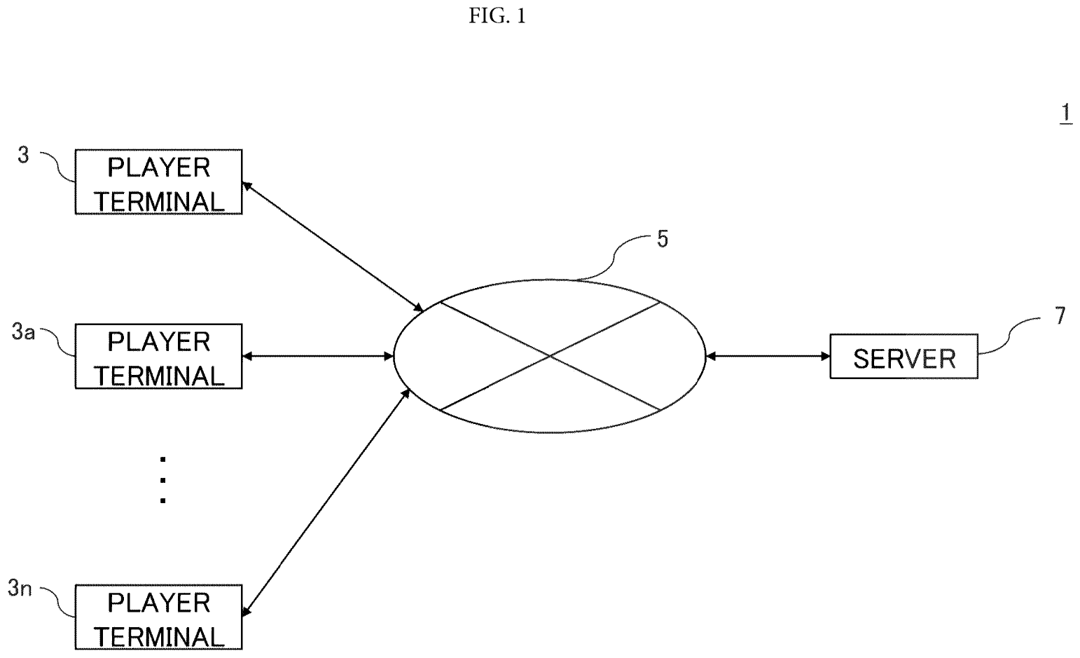

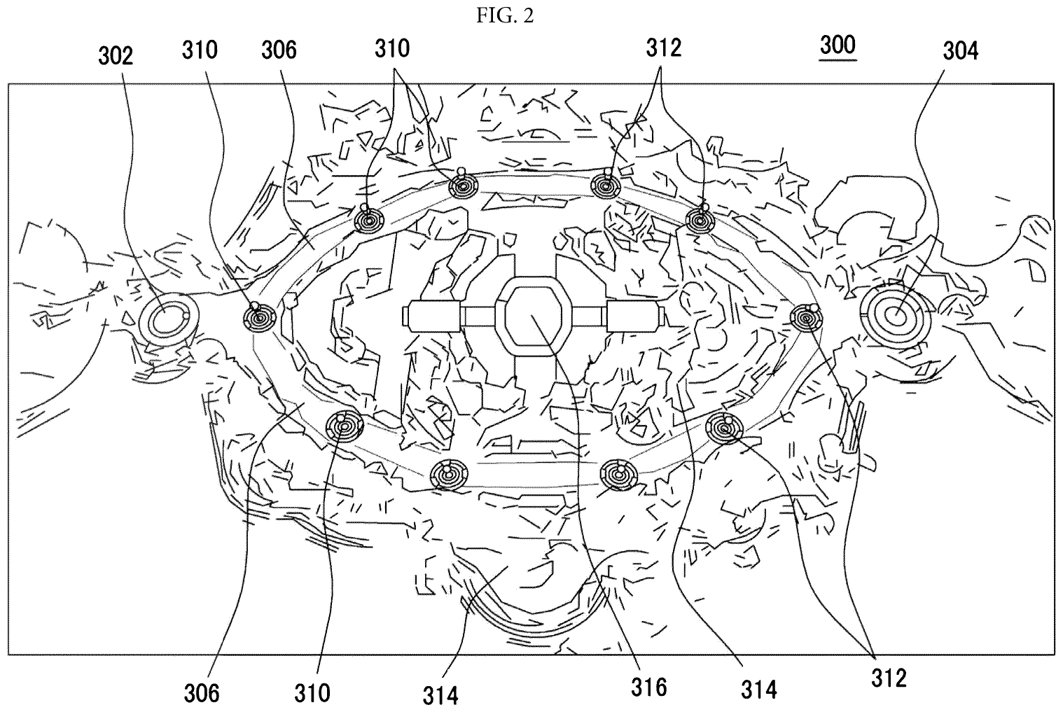

FIG. 1 illustrates an overview of a game system according to an exemplary embodiment. In addition, FIG. 2 is a schematic example of a play field of a game executed in the game system according to an exemplary embodiment.

The game system 1 according to the exemplary embodiment can be executed by information terminals 3 such as smartphones and the like and is a game system in which players can simultaneously play a game by connecting the information terminals 3 of a plurality of the players to a server 7 through a communication network 5. Players are divided at least into one team configured of player characters of one or more players (which may hereinafter be referred as an “ally team”) and another team configured of other player characters of one or more other players (which may hereinafter be referred to as an “enemy team”) and contend with each other, and the game system 1 determines a winning team of a game by comparing a score obtained by the ally team with a score obtained by the enemy team. The game system 1 may be one type of multiplayer online battle arena (MOBA). Here, the server 7 and information terminals owned by players (for example, the information terminal 3, an information terminal 3a, . . . , an information terminal 3n), for example, are connected through the communication network 5 to be able to bidirectionally communicate with each other. In addition, the game system 1 may be a game system of a server-client type.

In addition, a character operated by a player himself or herself will be referred to as a player character, a team to which the player belongs will be referred to as an ally team, a character operated by a player belonging to the ally team other than the player will be referred to as an ally player character, a team to which another player against whom the player fights belongs will be referred to as an enemy team, and a character operated by another player belonging to the enemy team will be referred to as an enemy player character.

In other words, the game system 1 is executed with players being divided into an ally team to which a player character operated by a player belongs and an enemy team to which an enemy player character operated by another player belongs. Then, the game system 1 calculates a score of a team to which each player belongs by scoring points obtained by each player in a case in which a player character of each player (that is, a player character, an ally player character, or an enemy player character) satisfies predetermined conditions during a game and compares scores obtained by teams at the time when a game time ends with each other to determine victory/defeat of the game.

For example, the game system 1 is executed on a play field 300 that is a virtual space. As one example, the play field 300, as illustrated in FIG. 2, includes an ally headquarter 302 of an ally team to which a player character belongs, an enemy headquarter 304 of an enemy team to which an enemy player character belongs, one or more lanes 306 joining the ally headquarter 302 and the enemy headquarter 304, one or more ally bases 310 disposed along at least one or more lanes from the ally headquarter 302 up to a predetermined distance, one or more enemy bases 312 disposed along the at least one or more lanes 306 from the enemy headquarter 304 up to a predetermined distance, a neutral area 314 disposed between the plurality of lanes 306 and in at least a part of the plurality of lanes 306 side, and a center part 316 disposed at a position of an equal distance from the ally headquarter 302 and the enemy headquarter 304. Basically, a player character can freely move to a desired position except for a movement impossible area inside the play field 300 (for example, a wall, a rock, a pond, or the like disposed inside the play field 300) in accordance with an instruction from the player.

Then, the game system 1 causes neutral characters (NPC) to appear at predetermined positions of the lane 306 and/or the neutral area 314. A neutral character is a character operating without being operated by any player. In addition, a neutral character is a character that is automatically controlled by the game system 1 and may be a character for which points are assigned to a player who has succeeded in blowing it down in accordance with a player character, an ally player character and/or an enemy player character attacking and blowing it down, and may be a character that such a player can obtain. In other words, predetermined points according to a type or a status (for example, a level or the like) of a neutral character are associated with the neutral character.

For example, in a case in which a player character attacks and blows down a neutral character present in a predetermined range from the player character in accordance with an instruction from a player, the game system 1 assigns points associated with this neutral character to the player operating this player character. In addition, the game system 1 may cause this neutral character to be obtained by this player. In a case in which this neutral character is caused to be obtained by this player, the game system 1 changes this neutral character to an ally character of this player character and assigns points owned by this neutral character to this player. In accordance with this, the player obtains the points. The game system 1 stores this ally character in a virtual character storage area of this player. In addition, the game system 1 may assign points to the player character.

Then, in accordance with an instruction from a player, the game system 1 can cause an ally character to appear on the play field 300 from the character storage area and store the ally character in the character storage area from the play field 300 in accordance with an instruction from the player. In a case in which the player causes an ally character to appear on the play field 300, by causing the ally character to automatically follow the player character, the game system 1 can also cause the ally character to automatically attack a neutral character and/or an enemy player character present in a predetermined range from the player character or an enemy player character (in other words, the ally character can co-fight together with the player character).

In addition, in accordance with an instruction from a player, the game system 1 can also cause a player character to attack an enemy player character present in a predetermined range from the player character. In a case in which the player character attacks and blows down an enemy player character, the game system 1 assigns predetermined points to the player owning this player character. In other words, in the game system 1, by operating a player character, a player can not only perform an inter-person battle with an enemy player character but also perform a battle with a player character and a neutral character (a battle with a system) in accordance with a player's desire. In accordance with a player character operated by a player blowing down an enemy player character or blowing down a neutral character, the player can obtain points.

In a case in which a player character is present inside a predetermined area (for example, within a predetermined range from the enemy base 312) of the play field 300, by supplying points obtained by a player to the enemy base 312 in accordance with an instruction from the player, the game system 1 can set these points as a score of the ally team. In other words, points are not considered as a score of the ally team until the points are converted into a score (hereinafter, conversion of points into a score may be referred to as “scoring”). In this case, in accordance with scoring of points, the game system 1 resets points obtained until a player performs scoring to zero. In addition, in a case in which the points are set to zero, in a case in which an ally character is stored in the character storage area, the game system 1 may remove this ally character or an ally character that came out of the character storage area and has appeared on the play field 300. Here, removal of an ally character represents that the ally character is restricted from appearing on the play field 300 again in the same game play. In accordance with this, this ally character cannot battle together with a player character. In addition, an endurance value set in advance is set in the enemy base 312, and in a case in which a sum value of points (hereinafter referred to as a “supply value”) supplied to the enemy base 312 becomes equal to or greater than the endurance value, the game system 1 stops the function of the enemy base 312. For example, the game system 1 can represent that the function of the enemy base 312 stops by displaying an appearance of the enemy base 312 being destroyed.

Furthermore, in the game system 1, sum values of scores obtained by an ally team and an enemy team are not displayed until after execution of a game (that is end of a game time) from the middle of execution of the game. The reason for this is as follows. In the game system, in a case in which sum values of scores obtained by both teams during execution of a game can be perceived by each player in real time, when there is a large difference between a sum value of scores of one team and a sum value of scores of the other team during execution of a game, desire of players belonging to the team having the lower sum value to continue the game is eliminated. As a result, knowledge that, during a game, there are many players giving up the play and exiting the game has been acquired by the inventor of the present disclosure who verified a prototype of the game system 1 (in addition, this prototype is neither the game system 1 according to this embodiment nor a game system 1 according to this disclosure). When a player exits a many-to-many fighting-type game, the game itself is not formed. Thus, the inventor of the present disclosure found that the desire of each player to continue a game up to a final stage of the game or the end of the game can be made less likely to be eliminated by not allowing a sum value of a score of each team to be knowable during execution of the game and allowing the sum value of the score of each team to be knowable after execution of the game (after end of the game). The game system 1 according to an exemplary embodiment is on the basis of the relating knowledge. In addition, although an example in which a sum value of the score of each team is indicated during execution of a game will be described in the following description, in the game system 1 according to an exemplary embodiment, a player is not able to perceive a sum value of the score of each team during execution of a game.

In this way, in the game system 1, in accordance with a player character operated by a player attacking and blowing down a neutral character and/or an enemy player character, this player acquires points and supplies the obtained points to the enemy base by operating the player character, whereby the points can be set as a score of the ally team. Here, in the game system 1, a player character can also be caused to obtain a neutral character. In this case, the neutral character obtained by the player character can be caused to act together with this player character as an ally character (in this case, the ally character can be controlled to automatically co-fight together with the player character, move to follow the player, and operate to attack the neutral character and the enemy player character within a predetermined vicinity of the ally character), and in a case in which points obtained by the player are scored, the ally character owned by the player at the scoring time point is eliminated and cannot be caused to appear during the game. In accordance with this, in the game system 1, in a case in which a neutral character is obtained and is set as an ally character, the player can select whether points acquired through obtainment of the neutral character are scored to eliminate the ally character or the ally character is owned and used for co-fighting without scoring the obtained points, and thus the strategic characteristic of the game can be improved.

In the game system 1, a player obtains points by performing a battle with a neutral character even without performing a battle with an enemy player character, that is, an inter-person battle, and can score the obtained points obtained by causing a player character to execute a predetermined operation at the enemy base, and thus even when the player is a player who hesitates to join an inter-person battle or a player who knows he or she is bad at inter-person battles, the player can make a contribution to a team to which he or she belongs. In other words, in the game system 1, a game can be enjoyed without performing an inter-person battle. In addition, in the game system 1, a player can improve his or her skill level in battles in a game through a battle with a neutral character. In accordance with this, according to the game system 1, a player can become accustomed to battle, and his or her impression that he or she is bad at battles is reduced.

Furthermore, in a case in which a player character acquires an experience value when the player character blows down a neutral character or an enemy player character, or the like, and a sum value of acquired experience values becomes equal to or greater than a predetermined value, the game system 1 can change an outer appearance and a capability of the player character (hereinafter, this change will be referred to as “evolution”). In accordance with this evolution, the player character can improve the capability of store a “technique” of attacking a neutral character or an enemy player character. In accordance with this, in a conventional MOBA, in order to improve an offensive power and the like of a player character, while the player character needs to acquire and be equipped with a predetermined item in a game, in the game system 1, a “technique” is automatically stored in accordance with evolution of a player character, and thus the player character can be reinforced without requiring a complicated operation. In addition, in the game system 1, the outer appearance of the player character can be changed in accordance with “evolution,” and thus a player can also perceive a degree of strength of the player character at a glance.

The information terminals 3, 3a, . . . , 3n are information terminals such as a mobile phone, a smartphone, a notebook PC, a tablet PC, a PC, a portable game machine, and/or a home-use game machine. In a case in which a plurality of information terminals are present, types of the information terminals may be different from each other. In addition, while details of the game system 1 according to the an exemplary embodiment will be described below, it is to be understood that names, numerical values, and the like in the description given above and the description given below are merely exemplary, that the present disclosure is not limited to such names, numerical values, and the like, and that such names, numerical values, and the like are not necessarily related to actual names, numerical values, and the like.

<Details of Game System 1>

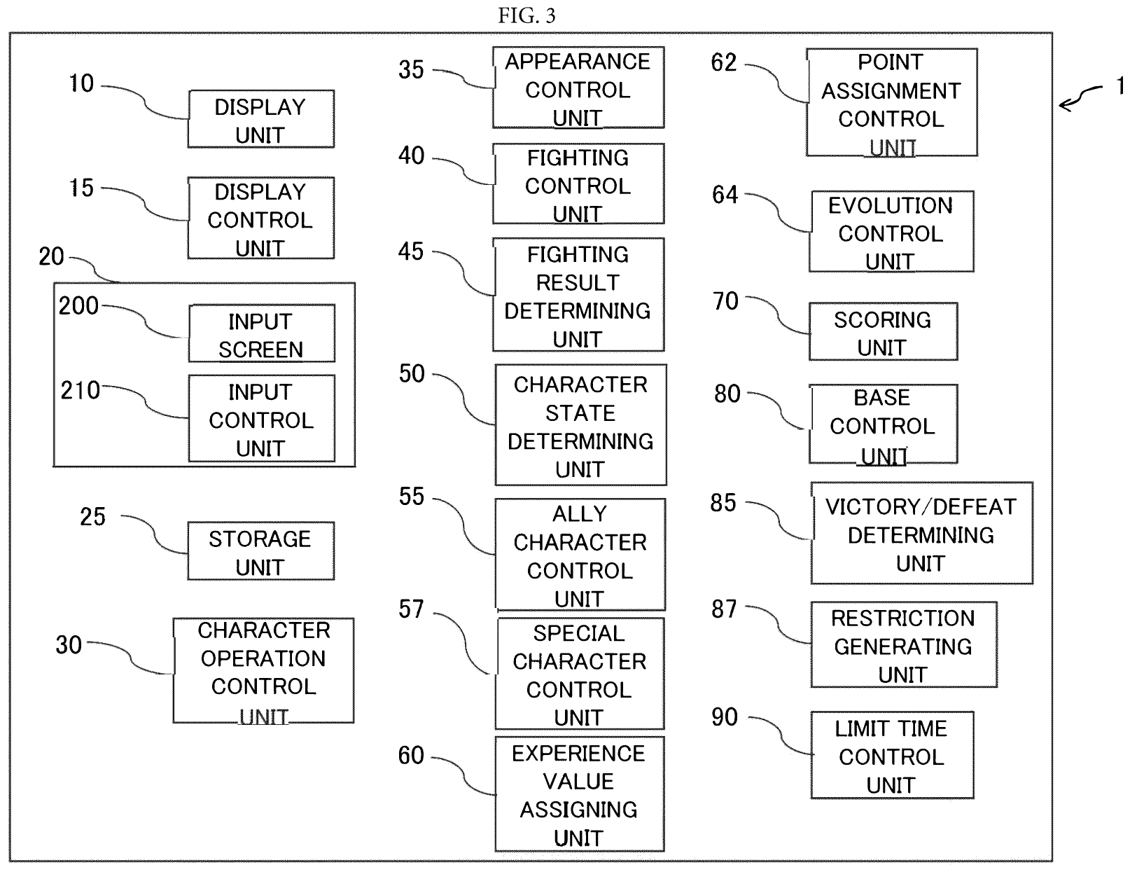

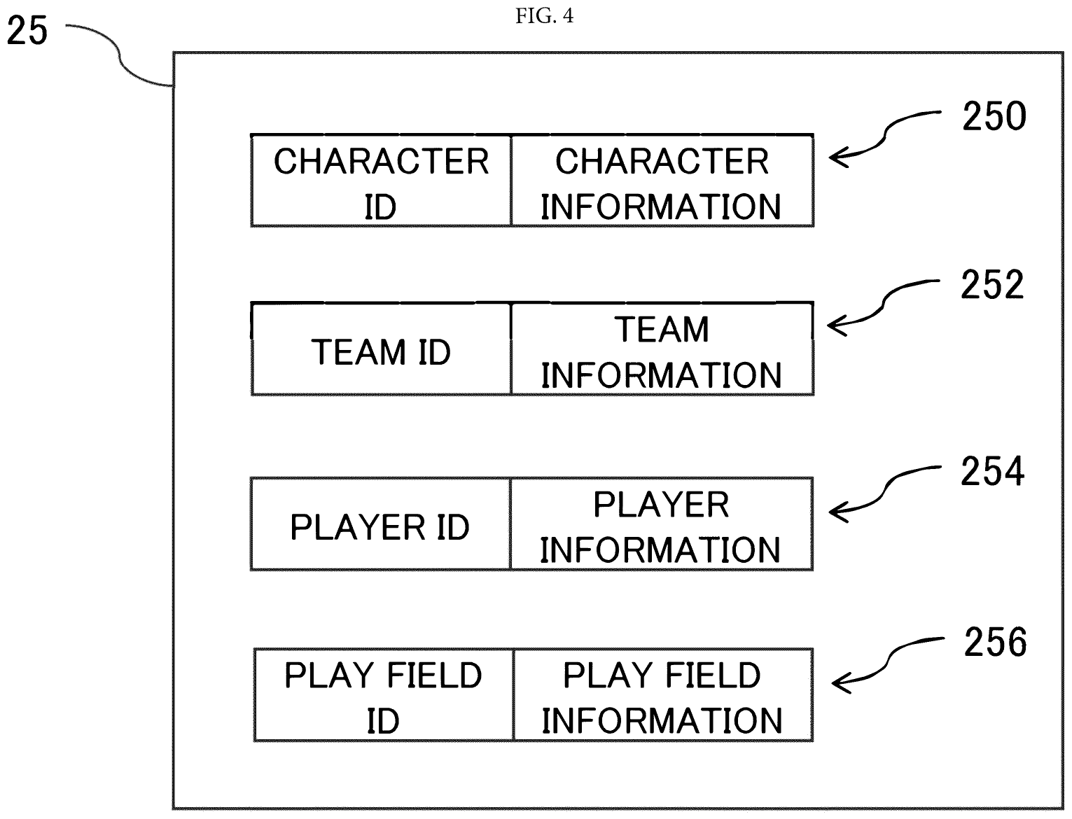

FIG. 3 is a diagram showing a functional configuration of the game system according to an exemplary embodiment. In addition, FIG. 4 shows an example of a data configuration of each storage unit included in a storage unit included in the game system according to an exemplary embodiment.

[Overview of Configuration of Game System 1]

The game system 1 according to an exemplary embodiment is a game system in which an ally team to which a player and an ally player belong and an enemy team to which enemy players belong content with each other inside a play field 300. The game system 1 determines a victory/defeat of a game by comparing scores obtained by the teams with each other. The game system 1 includes a display unit 10 that displays the play field 300, a player character, and the like, a display control unit 15 that controls display of the display unit 10, an input unit 20 that receives an instruction from a player, a storage unit 25 that stores various kinds of information used in a game, a character operation control unit 30 that controls an operation of the player character, an appearance control unit 35 that controls appearances of a neutral character and/or a special character, a fighting control unit 40 that controls fighting between the player character and other various types of characters, a fighting result determining unit 45 that determines fighting results between the player character and other various types of characters, a character state determining unit 50 that determines a state of a character, an ally character control unit 55 that controls an operation and the like of the ally character, a special character control unit 57 that controls an operation and the like of a special character, an experience value assigning unit 60 that assigns an experience value to the player character, a point assignment control unit 62 that assigns points to the player character or a player, an evolution control unit 64 that controls an evolution of the player character, a scoring unit 70 that converts points into a score, a base control unit 80 that controls an ally base and an enemy base, a victory/defeat determining unit 85 that determines a victory/defeat of a game, a restriction generating unit 87 that generates a predetermined restriction between bases, and a limit time control unit 90 that limits a limit time of a game. In addition, a special character is a character that can fight against a player character among neutral characters (NPC) and belongs to a team to which the player character belongs but is not stored in the character storage area even in a case in which the player character has won a fight between the special character and the player character (typically, a character that is displayed in the play field 300 until a predetermined condition is achieved.). In addition, among neutral characters, a special character may be a character that generates an effect that is advantageous to a player character and/or a team to which a player character belongs in a game in a case in which this player character has won a fight against the special character. In addition, in the following description, unless otherwise mentioned, neutral characters are assumed to include a special character.

In addition, the game system 1, for example, is executed in the following processes.

1) Game Pre-Preparation Processing

The game system 1 executes game pre-preparation. For example, the game system 1 displays a home screen in a display unit 10 of a terminal or the like of a player who has logged in a game. In this home screen, each player can select a player character used in a game and perform settings of techniques and equipment used by the player character and the like in the game. In addition, in the game pre-preparation, the game system 1 may assign a predetermined player character to the player in accordance with a lottery and billing (a lottery or billing using in-game virtual currency).

2) Matching Process

The game system 1 executes a process of distributing a plurality of players participating in a game into an ally team and an enemy team. Each player participating in a game belongs to one team.

3) Game Start and Execution Process

After matching ends, the game system 1 starts a game. In description of this specification, in a case in which “during a game”, “during execution of a game”, and/or “during fighting” are displayed, it represents a state before a victory/defeat of a game is determined in which a game play in which players cooperate with each other in the game, a game play in which players fight each other, and the like can be executed. In other words, in the game system 1, between measurement/calculation of a score obtained by each team starts and determination of a victory/defeat in a game, “during game”, “during execution of a game”, and/or “during fighting” are formed.

4) Fighting Result Display Process

After the game ends, the game system 1 displays a fighting result in the display unit 10. In other words, in a period after measurement/calculation of a score obtained by each team in a fight according to a game ends, and a victory/defeat of the game is determined, the game system 1 displays a fighting result in the display unit 10.

5) Subsequent Process

After, the fighting result is displayed, the game system 1 can repeat the process from the game pre-preparation process again.

The storage unit 25 has a character information storage unit 250 that stores information relating to a player character, a neutral character, and/or a special character, a team information storage unit 252 that stores information relating to teams participating in a game, a player information storage unit 254 that stores information relating to players, and a play field information storage unit 256 that stores information relating to the play field 300.

Instead of only physically having the plurality of components described above in a same apparatus or at a same place, the game system 1 may install a part of the plurality of components described above at a physically separated position. In this case, each component may be connected by, for example, a communication network such as the Internet. For example, the game system 1 may have an external server bear a part of the functions of the components. In addition, the game system 1 may be configured as one or more servers. In this case, the game system 1 is configured by combining an information terminal, components of one server, and components of another server. In addition, in an exemplary embodiment, an aggregation of predetermined components can be perceived as one “information processing apparatus” and the game system 1 may be formed as an aggregation of a plurality of information processing apparatuses. A method for distributing a plurality of functions required for realizing the game system 1 according to an exemplary embodiment to one or a plurality of pieces of hardware can be appropriately determined in consideration of the processing capability of each piece of hardware and/or specifications required for the game system 1, and the like. Furthermore, various kinds of information stored in the storage unit 25 may be updated by an instruction by a user or information accepted via the input unit 20 or updated as need by acquiring predetermined information from a predetermined server which is present outside of the game system 1.

[Details of Configuration of Game System 1]

In the following description, a case in which a game provided by the game system 1 is executed by a player mainly using the information terminal 3 (for example, a smartphone, a tablet terminal, a PC, or the like) will be described as an example. The information terminal 3 is configured so as to at least include the display unit 10 and the input unit 20.

(Display Unit 10, Display Control Unit 15)

The display unit 10 displays information relating to a game including a play field 300 in which the game is executed, a player character (an ally player character and an enemy player character), a neutral character, a special character, and/or other items, and the like under the control of the display control unit 15. The display unit 10 outputs various processing results and information stored in the storage unit 25 so as to be perceivable by a player. Specifically, the display control unit 15 causes various processing results in each component, information stored in the storage unit 25, and the like to be displayed by the display unit 10 as data, a still image, a moving image, and/or a text of predetermined formats. The display unit 10 may display information received from an external server.

(Input Unit 20, Input Screen 200, Input Control Unit 210)

The input unit 20 accepts an input such as a predetermined instruction or an operation from a player. The input unit 20 supplies the instruction to a predetermined component of the game system 1. Each component having accepted the instruction exhibits a predetermined function. For example, the input unit 20 is a touch panel, a tablet, a mouse, a motion sensor, or the like. In an exemplary embodiment, an example where the input unit 20 is a touch panel included in the information terminal 3 will be described. Note that the touch panel may be multi-touch-detectable. Specifically, the touch panel as the input unit 20 includes an input screen 200 to which an operation and the like by a player are input and an input control unit 210 which acquires information related to the operation input to the input screen 200. The touch panel is arranged so as to overlap with the display unit 10 and a surface of the touch panel corresponds to the input screen 200.

For example, an area for receiving a predetermined instruction is disposed on the display unit 10, and the input screen 200 detects the predetermined instruction at a position designated by an operation (for example, a touch operation, a tap operation, a slide operation, or the like) of a player for this area of the input screen 200. The input screen 200 supplies the detected information, or in other words information indicating the predetermined instruction in the detected position, to the input control unit 210. The input control unit 210 acquires information indicating the predetermined instruction from the input screen 200 and supplies this information to a predetermined constituent component of the game system 1.

(Storage Unit 25)

The storage unit 25 stores various information relating to the game system 1. Each storage unit included in the storage unit 25 supplies predetermined information to a predetermined constituent component in response to requests from other constituent components of the game system 1. In addition, in the game system 1, in a case in which one game has ended, a next game may be executed without taking over the status of this one game. For this reason, in the game system 1, for all the player character, the ally player character, and the enemy player character, information relating to an experience value, a level, a status, an owned point, an owned ally character and/or an evolution status, and the like are returned to an initial state, and a next game starts. In other words, every time a new game starts, the game system 1 may return at least a part of information stored by the storage unit 25 to an initial value.

(Storage Unit 25: Character Information Storage Unit 250)

The character information storage unit 250 stores various kinds of information relating to characters (character information) in association with character IDs used for identifying characters. Here, characters include a player character, a neutral character, and a special character. Examples of the character information include a name of a character, a status or parameters (for example, an experience value, a level, a hit point (HP), an offensive power, a defensive power, quickness, and the like) of a character, points associated with a character (points owned by the character), an attacking means that can be normally used by a character, a technique that can be used by a character in a case in which a predetermined condition is satisfied, presence/absence of evolution of a character, a character ID of a character of an evolution destination of a case in which the character has evolved, and the like. In addition, a player of the game system 1 can arbitrarily select a player character used in a game among a plurality of characters at the time of starting the game. Here, in a case in which the character is a player character, a status of the character, points owned by the character, presence/absence of evolution of the character, and the like are reset every time a new game starts. Points owned by a character of a case in which the character is a player character have the same meaning as points associated with a player.

In addition, in “technique”, a technique for taking away points owned by an enemy player character (points associated with the enemy player character), an ally character of an enemy player character that has entered a character storage area of the enemy player character, and/or an ally character of the enemy player character appearing in the play field 300 may be included.

(Storage Unit 25: Team Information Storage Unit 252)

The team information storage unit 252 stores various kinds of information (team information) relating to teams in association with team IDs used for identifying the teams. For example, the team information is information such as information relating to players composing a team (for example, player IDs to be described below), a character ID of a character (for example, a special character) associated with a team in a game, a score obtained by each team in a game, and the like. For example, the information of a score obtained by each team (hereinafter, referred to as “score information”) may be information in which a progress time of a game (an elapsed time from a game start time point) or a remaining time (in a case in which a limit time in which one game can be executed in one game is set, a remaining time in which the game can be executed that is acquired by subtracting an elapses time from the limit time) of a game is associated with an obtained score. In addition, the score information, in a case in which a player character of a player belonging to a team has blown down a special character through fighting, may include information indicating that this special character has been blown down in association with a progress time or a remaining time of the game at a time point of blowing-down.

Here, a team is composed of one or more players. In the game system 1, one or more players composing a team can be randomly determined at the time of starting a game, and a team can be composed by allowing one player to invite other players. Thus, the information relating to players as team information that is stored by the team information storage unit 252 in association with a team ID may be reset every time a new game is executed. In addition, the team information stored by the team information storage unit 252 may be reset every time a game ends.

In addition, the team information storage unit 252 can temporarily store character IDs. For example, in a case in which a player character belonging to a team has blown down a special character during execution of a game, the team information storage unit 252 may store a character ID of this special character only for a predetermined time and remove the character ID after elapse of a predetermined time. Furthermore, the team information storage unit 252 may store character IDs of special characters stored during execution of a game in a time series. In addition, the team information storage unit 252 may remove all the character IDs stored during execution of a game at a game end time point.

(Storage Unit 25: Player Information Storage Unit 254)

The player information storage unit 254 stores information relating to players playing a game. More specifically, the player information storage unit 254 stores player information in association with a player ID used for identifying players. For example, the player information is information relating to a name of a player, a neutral character obtained in accordance with a player winning a battle in a game, a reward obtained in the game by the player (points, a score, an experience value, and the like obtained by executing a game), and a player character and the like used in the game by the player. The information of a score and points obtained by the player, for example, may be information in which a progress time or a remaining time of a game is associated with a score and points that have been obtained. In addition, the information of a score and points obtained by the player may include information representing a special character being blown down in association with a progress time or a remaining time of the game at a blowing-down time point in a case in which a player character of the player has blown down the special character through fighting. The player information storage unit 254 can update information relating to a neutral character as player information or store this information in a time series every time a player wins a battle in a game over the neutral character and obtains this neutral character. In addition, in the player information stored by the player information storage unit 254, information relating to a neutral character obtained by the player and a reward and the like obtained in a game by the player is reset every time the game ends. Alternatively, the information relating to a neutral character obtained by a player and a reward and the like obtained in a game by the player as player information stored in association with a player ID by the player information storage unit 254 may be reset every time a game is executed. In addition, the information to be reset here is information used for continuing a series of play processes from start of a play until a victory/defeat of teams is determined, and history information (the number of victories/defeats in a battle, an obtained experience value number) of a game play that is a result of the series of game play processes is not reset and is stored in the player information storage unit 254. For example, by repeating a series of game play processes, the number of kinds of player characters and the number of kinds of techniques of player characters that can be used by a player increase in accordance with winning games of a predetermined times.

(Storage Unit 25: Play Field Information Storage Unit 256)

The play field information storage unit 256 stores information relating to the play field 300. More specifically, the play field information storage unit 256 stores play field information in association with play field IDs used for identifying play fields. The play field information, for example, is information relating to a name of a play field and the arrangement, the number, and the like of various elements configuring the play field. In addition, the game system 1 also can fixedly use a play field set in advance, and, in this case, the storage unit 25 may not have the play field information storage unit 256.

(Character Operation Control Unit 30)

The character operation control unit 30 performs an operation of a player character of a player inside the play field 300 on the basis of an instruction from the player. More specifically, the character operation control unit 30 controls operations such as movement, stop, attacking, defending, execution of scoring of points, and the like of a player character inside the play field 300 on the basis of an instruction from the player that has been received by the input unit 20. The display unit 10 is controlled by the display control unit 15 and displays an operation of a player character controlled by the character operation control unit 30.

(Appearance Control Unit 35)

The appearance control unit 35 controls appearance of a neutral character and/or a special character in the play field 300. The appearance control unit 35 causes a neutral character and/or a special character to appear in places of the play field 300 that are set in advance at predetermined time intervals or random time intervals set in advance. From a point of view of giving equal chances of players belonging to respective teams to meet with a neutral character and/or a special character, the appearance control unit 35 can cause the neutral character and/or the special character to appear at predetermined time intervals set in advance.

Here, from a point of view of giving equal chances of contacting a neutral character between a player character belonging to a first team (for example, an ally team to which a player belongs) and a player character belonging to a second team (for example, an enemy team), for example, a plurality of appearance places of neutral characters can be disposed at line-symmetrical positions in a case in which a predetermined virtual line passing through the center of the play field 300 is set as a symmetrical axis. For example, in a play field 300 having an approximately oval shape illustrated in FIG. 2, the appearance control unit 35 causes a neutral character to appear at a predetermined position of a lane 306 and also causes a neutral character of the same type to appear at a position having a line symmetry with respect to this position using a minor axis passing through the center of the play field 300 as a symmetrical axis. In addition, a plurality of appearance places of neutral characters may be disposed at positions having point symmetry using the center of the play field 300 as a symmetrical point.

In addition, from a point of view of giving equal contact chances for a special character, the appearance control unit 35 also causes special characters to appear in areas in which each team can equally contact a special character as well. For example, the appearance control unit 35 causes special characters to appear at predetermined time intervals set in advance at specific positions of the play field 300, for example, in a case in which the center part 316 and/or the play field 300 have an approximately oval shape, near an intersection of a minor axis passing though the center of the play field 300 and the lane 306. In addition, in a case in which the appearance control unit 35 causes a special character to appear, the display unit 10 can display information (for example, text display and the like) indicating that a special character has appeared at a predetermined position of the display unit 10 under the control of the display control unit 15. In addition, the appearance control unit 35 may set an appearance frequency of a special character to be lower than an appearance frequency of a neutral character.

(Fighting Control Unit 40)

In a case in which a neutral character, a special character, and/or an enemy player character are present within a predetermined range from a player character, in a case in which an attack instruction from a player for such a character (hereinafter, it may be referred to as a “target character”) is received from the input unit 20, the fighting control unit 40 controls fighting by starting a fight (battle) between the player character and the target character. For example, the fighting control unit 40 causes the player character to attack the target character in accordance with an instruction from a player that has been received by the input unit 20, thereby causing a damage based on this attack in the target character. In addition, in a case in which the player character is attacked from the target character, the fighting control unit 40 causes a damage based on this attack in the player character.

For example, the fighting control unit 40 changes the status of the player character on the basis of the damage received by the player character from the target character (as one example, an HP representing a damage that can be endured by a character is decreased) and changes the status of the target character on the basis of the damage received by the target character from the player character. The display unit 10 displays an appearance of fighting between the player character and the target character controlled by the fighting control unit 40 and a damage given to an opponent character, and the like under the control of the display control unit 15. In addition, even in a case in which a target character is not present within a predetermined range from the player character, in a case in which an attack instruction has been received from a player through the input unit 20, the fighting control unit 40 can cause the player character to execute an attack operation.

In addition, the player character may have one or more attacking means. In other words, the player character can also use a predetermined technique on the basis of an experience value obtained by the player character in addition to an attacking means, which can be generally used, that can attack a target character at an arbitrary timing in the game. For example, a predetermined experience value is associated with a technique as character information stored by the character information storage unit 250 in association with a character ID, and, in a case in which an experience value obtained by the player character becomes equal to or greater than this predetermined experience value, the fighting control unit 40 permits the player character to use this technology. In addition, in a case in which an instruction for using a technique has been received from a player through the input unit 20, the fighting control unit 40, after activating a predetermined technique in the player character, may prohibit activation of the technique again until a predetermined time elapses. The fighting control unit 40 supplies information representing a change of the status of the player character and a change of the status of the target character generated in accordance with fighting to the fighting result determining unit 45.

(Fighting Result Determining Unit 45)

The fighting result determining unit 45 determines a fighting result between a player character and a target character in fighting controlled by the fighting control unit 40. More specifically, the fighting result determining unit 45 determines a certain character has won or lost a fight on the basis of the change of the status of the player character and the change of the status of the target character. For example, each character has a hit point (HP) as one of the status, and the fighting result determining unit 45 determines that a character of which the HP becomes zero first through fighting has been defeated and determines that a character having a remaining HP has won.

In addition, in a case in which three or more characters are fighting each other, for example, in a case in which a fight in which a player character of an ally team (an ally player character) and a player character of an enemy team (an enemy player character) attack a neutral character or a special character is executed, the fighting result determining unit 45 may determine that a character that has performed an attack causing the HP of the neutral character or the special character to zero last has satisfied (has won) an obtainment condition of the neutral character (in other words, it may determine that the ally player character has blown down a neutral character or a special character). In addition, the fighting result determining unit 45 may determine that a character of which the number of times of attacking (the number of hits) performed until the HP of the neutral character or the special character becomes zero is a maximum or a character of which a total damage quantity (that is, a sum value of HP reduction quantities) given to a neutral character or a special character is a maximum has won the fight. The fighting result determining unit 45 supplies information representing a fighting result to the character state determining unit 50, the experience value assigning unit 60, and the point assignment control unit 62.

(Character State Determining Unit 50)

The character state determining unit 50 determines states of the player character and/or the target character on the basis of a determination result acquired by the fighting result determining unit 45. In a case in which the determination result (that is, a fighting result) acquired by the fighting result determining unit 45 indicates a victory of the player character, the character state determining unit 50 determines the states of the player character and/or the target character in accordance with a type of target character. Then, the character state determining unit 50 supplies information representing the determination result to the ally character control unit 55 and the special character control unit 57.

For example, in a case in which the target character is a neutral character, the character state determining unit 50 may associate the neutral character with the player in a case in which a predetermined obtainment condition is satisfied. In other words, the character state determining unit 50 associates a neutral character over which the player character has won with the player. The character state determining unit 50 stores a character ID of this neutral character as an ally character in the player information storage unit 254 as player information in association with a player ID. In accordance with this, a state in which the player has obtained this neutral character is determined. Then, the character state determining unit 50 removes display of this neutral character from the play field 300. In other words, the character state determining unit 50 causes the display control unit 15 to remove display of the neutral character in the display unit 10. In addition, the character state determining unit 50 changes this neutral character to an ally character and associates the ally character with the player in accordance with association of the neutral character with the player. In addition, the ally character may be stored in a virtual character storage area used for this player. The display control unit 15, for example, can display the virtual character storage area at a predetermined position of the display unit 10. The character storage area may be displayed in the play field 300 in an overlapping manner. Thus, in this case, a state in which the neutral character becomes an ally character of the player is determined, and a state in which it is stored in the character storage area is determined. In addition, when a neutral character is obtained, the neutral character may not be stored in the character storage area. In this case, the point assignment control unit 62 to be described below assigns points associated with the neutral character to the player. In addition, this neutral character may be caused to appear in the play field 300 and act as an ally character.

Here, a case in which, in a state in which a neutral character has already been associated with a player as an ally character, a player character has fought against a new neutral character and won the fight will be described. In this case, the character state determining unit 50 overwrites a character ID of an ally character stored in the player information storage unit 254 in association with a player ID with a character ID of the neutral character that has newly been blown down. In other words, in one aspect of the game system 1, there may be only one ally character associated with the player (that is, an ally character that is a neutral character that can be obtained and owned by the player), and, in a case in which the player character blows down a plurality of neutral characters, a neutral character that is an opponent over which the player character has won last is associated with the player and becomes an ally character. Then, the character state determining unit 50 removes the ally character that has already been stored in the character storage area and newly stores the neutral character that has newly been blown down in the character storage area as an ally character.

In addition, one aspect of a case in which, in a state in which an ally character has come out from the character storage area to the play field 300, a player character and/or this ally character fight against a new neutral character and won the fight will be described. In this case, the character state determining unit 50 overwrites a character ID of an ally character that is stored in the player information storage unit 254 in association with a player ID (this character ID is a character ID of an ally character appearing in the play field 300) with a character ID of a neutral character that has newly been blown down. Then, the character state determining unit 50 removes the ally character that has come out to the play field 300 and stores the neutral character that has newly been blown down in the character storage area as an ally character. Thus, in this case, a state in which the neutral character that has newly been blown down becomes an ally character of the player and is in a state being stored in the character storage area is determined, after the neutral character is stored in the character storage area, a state in which the original ally character that has appeared in the play field 300 is removed is determined. In addition, a plurality of ally characters may be stored in the character storage area without removing the original ally character. In this case, a plurality of display icons can be displayed in the character storage area in association with a plurality of characters.

In addition, in a case in which the player character has won over the neutral character, the character state determining unit 50 may associate this neutral character with a team to which the player of this player character belongs. For example, the character state determining unit 50 stores a character ID of this neutral character as an ally character as team information in the team information storage unit 252 in association with a team ID. In accordance with this, a state in which a team to which a player of this player character belongs has obtained this neutral character as an ally character can be formed. In addition, in this case, the character state determining unit 50 may set an upper limit on the number of ally characters that can be associated with a team. Here, a player who can acquire points owned by this neutral character by blowing down the neutral character is a player of the player character that is blown down this neutral character. Furthermore, in this case, neutral characters obtained by the team may be stored in the character storage area of one player belonging to the team, or neutral characters obtained by the team may not be stored in the character storage area (in this case, this neutral character may be maintained to appear in the play field 300).

Furthermore, in a case in which the player character has won over a special character, the character state determining unit 50 associates this special character with a team to which a player of this player character belongs. For example, the character state determining unit 50 stores a character ID of this special character in the team information storage unit 252 as team information in association with a team ID. However, in this case, the character state determining unit 50 may cause the special character to be maintained in the state in which it appears in the play field 300 without storing the special character in the character storage area or may remove the special character from the play field 300 without storing it in the character storage area 320.

In addition, in a case in which a plurality of characters (ally player characters and/or enemy player characters) have attacked a neutral character and in a case in which a determination result acquired by the fighting result determining unit 45 represents that a player character that has blown down the neutral character is a player character that has given an attack of causing the HP of the neutral character to zero last, the character state determining unit 50 associates the neutral character with a player of this player character. In addition, in a case in which a plurality of characters have attacked a special character and in a case in which a determination result acquired by the fighting result determining unit 45 represents that a player character that has blown down the special character is a player character that has given an attack of causing the HP of the special character to zero last, the character state determining unit 50 associates the special character with a team to which this player character belongs.

In addition, in a case in which a target character is an enemy player character, the character state determining unit 50 causes an enemy player character that has been defeated in the fight (for example, an enemy player character of which a predetermined parameter such as the HP has become zero) to be in a state in which it is moved from a defeat position of the play field 300 to the enemy headquarter 304 after elapse of a predetermined time (that is, after elapse of a predetermined return time). Then, the character operation control unit 30 controls an operation of the enemy player character that has been moved to the enemy headquarter 304 in accordance with an instruction from a player of the enemy player character. In addition, the character state determining unit 50 can give an advantageous effect (for example, an HP recovery effect or the like) to an enemy player character present inside the enemy headquarter 304.

In addition, in a case in which the player character is defeated by any one target character, the character state determining unit 50 causes the player character to be in a state in which it has moved from a defeat position of the play field 300 to the ally headquarter 302 after elapse of a predetermined time (that is, after elapse of a predetermined return time). In this case, the character operation control unit 30 may recover the HP and the like of the player character up to full. Then, the character operation control unit 30 controls an operation of the player character that has been moved to the ally headquarter 302 in accordance with an instruction from a player of this player character. In addition, the character state determining unit 50 can give an advantageous effect (for example, an HP recovery effect or the like) to an ally player character present inside the ally headquarter 302.

(Ally Character Control Unit 55)

The ally character control unit 55 controls an operation of an ally character on the basis of information representing a determination result acquired by the character state determining unit 50. More specifically, in a case in which a neutral character is associated with a player, the ally character control unit 55 performs control such that a predetermined effect according to the ally character can be generated in the play field 300. In other words, in a case in which a player has an ally character, the ally character control unit 55 performs control such that an effect based on features of the ally character can be generated in the play field 300.

For example, in a case in which a determination result acquired by the character state determining unit 50 represents that a player character satisfies an obtainment condition of a neutral character in a fight between the player character and the neutral character, the player has this neutral character as an ally character, and this ally character is stored in the character storage area. Thus, the ally character control unit 55 performs control such that appearance of an ally character from the character storage area to the play field 300 and storage of the ally character in the character storage area can be repeated. In this case, there is an effect that appearance of the ally character in the play field 300 and storage thereof in the character storage area can be repeated. For example, the ally character control unit 55 prohibits appearance of this ally character from the character storage area in the play field 300 for a predetermined time from obtainment of the neutral character according to a player (in other words, after a neutral character that has disappeared from the play field 300 is stored in the character storage area as an ally character) and enables appearance of an ally character from the character storage area to the play field 300 and storage in the character storage area from the play field 300 in accordance with an instruction from a player that has been received through the input unit 20 after the predetermined time elapses.

In addition, in a case in which an ally character has been caused to appear in the play field 300 in accordance with an instruction from a player, the ally character control unit 55 executes control such that the ally character that has appeared automatically follows the player character in the vicinity of the player character. In other words, in accordance with an instruction from a player that is received through the input unit 20, the ally character control unit 55 causes the ally character to follow a player character moving inside the play field 300. Then, the ally character control unit 55 causes the ally character to automatically execute an attack against an enemy player character, other neutral characters, and/or a special character present within a predetermined range from the ally character appearing in the play field 300. In addition, the ally character control unit 55 prohibits the ally character from attacking against an ally player character and/or an ally character of an ally player character.

Then, the ally character control unit 55 causes the ally character to automatically attack against an enemy player character, other neutral characters, and/or a special character and gives damages based on this attack to “the enemy player character, other neutral characters, and/or the special character (attack target characters)”. Among attack target characters positioned within the predetermined range of the ally character, an attack target character presented at a position closest from the ally character may be configured to be attacked, and the ally character may be configured to attack the attack target character that the player character is attacking. In addition, in a case in which an ally character has been attacked from an attack target character, the ally character control unit 55 gives a damage based on this attack to the ally character. Then, the ally character control unit 55 determines a result of a fight between the ally character and the attack target character. In other words, the ally character control unit 55 determines that a certain character has won or been defeated in a fight on the basis of a change of the status of the ally character and a change of the status of the attack target character. For example, the ally character control unit 55 determines that a character of which the HP has become zero has been defeated. The ally character control unit 55 supplies the determination result to the point assignment control unit 62.

In addition, in a case in which a player obtains a neutral character as an ally character, the ally character control unit 55 can generate a predetermined effect associated with this ally character in advance (for example, an effect of a technique or a skill set to the ally character) in a predetermined area of the play field 300. For example, the ally character control unit 55 can generate an effect (for example, HP recovery or the like) that is advantageous to a player character in a case in which the player character of a team to which this player belongs is present in a predetermined area of the play field 300 and can generate an effect (for example, reduction of an offensive power or the like) that is disadvantageous to this player character of a team against a team to which this player belongs in a case in which the player character is present in a predetermined area.

(Special Character Control Unit 57)

The special character control unit 57 refers to the information representing the determination result received from the character state determining unit 50 and, in a case in which information in which a result of a fight between the player character and the special character represents victory of the player character, and a special character is associated with a team to which the player character belongs (in other words, an ally team), generates a predetermined effect in one or more player characters of the ally team that are present within a predetermined range from the special character as its center. The predetermined effect may be an effect that is advantageous to a team to which a player character that has won over the special character belongs in the progress of the game. In addition, in a case in which a special character is associated with an ally team, the special character control unit 57 may cause the special character to automatically progress toward the enemy base of the enemy team disposed inside the play field 300.

Here, as the special character, there is a character having various features. Examples of the special character include a special character (hereinafter, this may be also referred to as a “first special character”) succeeding points owned by a player in a case in which it is defeated by a player character, a special character (hereinafter, this may be referred to as a “second special character”) that has points that is equal to or greater than a predetermined value in advance and, in a case in which it is defeated by a player character, is associated with a team (an ally team) to which this player character belongs and moves toward an enemy base while attacking against an enemy player character, and the like.

More specifically, in a case in which a player character and a first special character fight each other, the special character control unit 57 refers to the information representing a determination result received from the character state determining unit 50 and, in a case in which a result of the fight between the player character and the first special character represents a victory of the player character, causes the first special character to succeed points owned by a player that has blown down the first special character. Then, the special character control unit 57 causes the first special character to progress from a place at which the first special character has been defeated by the player character toward the closest enemy base 312 of the enemy team by controlling the first special character. In a case in which the first special character enters the inside of a predetermined range from the enemy base 312, the special character control unit 57 supplies information indicating that it is positioned within this range to the scoring unit 70.

In addition, in a case in which the first special character is attacked by an enemy player character, the special character control unit 57 decreases the HP of the first special character in accordance with this attack. Then, in a case in which the HP of the first special character becomes zero, the special character control unit 57 can cause the first special character to disappear. In this case, the special character control unit 57 may remove points that have been succeeded by the first special character from the player.

Furthermore, in a case in which a player character and a second special character fight each other, the special character control unit 57 refers to the information indicating a determination result received from the character state determining unit 50 and, in a case in which a result of the fight between the player character and the second special character indicates a victory of the player character, causes the second special character to belong to the team of this player character. Then, the special character control unit 57 causes the second special character to progress from a place at which the second special character has been defeated by the player character toward the closest enemy base 312 of the enemy team by controlling the second special character. The special character control unit 57 may cause the second special character to attack against an enemy player character present within a predetermined range from the second special character. In a case in which the second special character enters the inside of a predetermined range from the enemy base 312, the special character control unit 57 supplies information indicating that it is positioned within this range to the scoring unit 70.

In addition, in a case in which the second special character is attacked by an enemy player character, the special character control unit 57 decreases the HP of the second special character in accordance with this attack. Then, in a case in which the HP of the second special character becomes zero, the special character control unit 57 can cause the second special character to disappear.

(Experience Value Assigning Unit 60)

The experience value assigning unit 60 assigns an experience value to a player character. The experience value is a value obtained by the player character, a level is a numerical value determined in accordance with a total of assigned experience values and is a numerical value representing a rank of the player character. In addition, in a case in which an experience value obtained by the player character achieves a predetermined condition (for example, this experience value exceeds a threshold set in advance), the level of the player character can be raises in a stepped manner.

The experience value assigning unit 60 assigns a predetermined experience value to a player character on the basis of information representing a fight result received from the fighting result determining unit 45. In other words, in a case in which the player character wins a fight against a neutral character and/or a special character and/or in a case in which the player character wins a fight against an enemy player character, the experience value assigning unit 60 assigns an experience value to the player character. The experience value assigning unit 60 may set an experience value assigned in a case in which the player character wins over the enemy player character to be higher than an experience value assigned in a case in which the player character wins over the neutral character. In addition, the experience value assigning unit 60 can assign a predetermined experience value to the player character on the basis of elapse of a game time, assign an experience value to the player character in accordance with supply of points to the enemy base according to the player character, and/or assign a predetermined experience value to the player character in a case in which information from the base control unit 80 to be described below represents destruction of the enemy base according to the player character.

In addition, the experience value assigning unit 60 can continuously assign an experience value of a predetermined quantity to the player character from a game start time point to an end time point and, in a case in which the player character is defeated in a fight against another character, a neutral character, and/or a special character, and the character state determining unit 50 moves this player character to the ally headquarter 302, the experience value assigning unit 60 can assign no experience value to the player character in a time from a time point at which the player character has been defeated to a time point at which movement to the ally headquarter 302 is completed.

Furthermore, the game system 1 can cause an item for which the player character can obtain an experience value by acquiring the item to appear at a predetermined position of the play field 300 or to appear in accordance with blowing down a neutral character or the like. In a case in which the player character has acquired this item, the experience value assigning unit 60 assigns an experience value to the player character. The experience value assigning unit 60 supplies information relating to the experience value assigned to the player character to the evolution control unit 64.

(Point Assignment Control Unit 62)

The point assignment control unit 62 controls assignment of a predetermined point associated with a neutral character (also including a special character) to the player. For example, the point assignment control unit 62 controls assignment of points owned by a neutral character associated with a player to the player on the basis of determination results acquired by the fighting result determining unit 45 and/or the ally character control unit 55. In other words, in a case in which a player character has won over a neutral character in a fight against the neutral character, the point assignment control unit 62 assigns points owned by the neutral character to the player. In addition, in a case in which the player character has won over an enemy player character in a fight against the enemy player character, the point assignment control unit 62 assigns a predetermined point to the player.

In addition, in a case in which the player character wins over a special character in a fight against the special character, the point assignment control unit 62 my assign a predetermined point to the player. However, since an effect that is advantageous to a team to which a player character that has won over the special character belongs is given to the special character, from a point of view of consideration of a game balance and the like, in a case in which the player character has won over the special character, the point assignment control unit 62 may not assign a predetermined point to the player.

Then, in a case in which points are assigned to the player, the point assignment control unit 62 adds this assigned points to points owned by the player in advance and causes the player to own points after the addition. In addition, an upper limit may be set on points that can be owned (held) by a player (for example, an upper limit may be set such that an upper limit point number is 50 points, 100 points, or the like). In a case in which points owned by a player achieve the upper limit, the point assignment control unit 62 assigns no point to the player even when the player character newly blows down a neutral character. In this case, the point assignment control unit 62 sets the owned points to zero through a scoring process performed by the scoring unit 70 to be described below or prohibits assignment of points to the player even when the player character newly blows down the neutral character unless the points are less than the upper limit. In this way, by setting the upper limit on points that can be owned, an incentive to a scoring process performed by the scoring unit 70 to be described below can be easily applied to the player.

In addition, in a case in which a player having points is defeated in a fight against an enemy player character, a special character, and/or a neutral character, the point assignment control unit 62 may reduce the points owned by the player by a predetermined quantity. Furthermore, in a case in which a determination result indicating that an ally character on the play field 300 has been defeated in a fight against a player character, another neutral character, and/or a special character is acquired from the ally character control unit 55, the point assignment control unit 62 may reduce the points owned by the player having this ally character by a predetermined quantity. In addition, the point assignment control unit 62 causes the display unit 10 to display the number of points owned by the player near the player character and/or near the character storage area.

In addition, in a state in which a neutral character is associated with a player in advance (that is, a state in which an ally character is present in advance), in a case in which the player character has won over a new neutral character through a fight, the character state determining unit 50 may remove the ally character stored in the character storage area. In addition, in a state in which an ally character is out in the play field 300 from the character storage area, in a case in which the player character and/or this ally character fights have won over a new neutral character through a fight, the character state determining unit 50 may remove the ally character that is out in the play field 300. In such a case, although the ally character has been removed, the point assignment control unit 62 may not reduce points owned by the player and may not change points that can be obtained by the player in accordance with a remaining HP of the ally character at a time at a time point at which the new neutral character has been blown down.

(Evolution Control Unit 64)

The evolution control unit 64 causes a player character to evolve on the basis of an experience value assigned to the player character by the experience value assigning unit 60. More specifically, in a case in which the player character reaches a predetermined level and/or in a case in which the player character obtains an experience value that is equal to or greater than a predetermined value, the evolution control unit 64 may cause this character to evolve. The evolution control unit 64 may enable the player character to use a predetermined technique in accordance with evolution of the player character. In addition, in accordance with a level of the player character, the evolution control unit 64 may change details of techniques that this player character can use and/or effects of the techniques.

In this way, in the game system 1, a player character can use a predetermined technique in the player character on the basis of an experience value obtained by the player character. Thus, in the game system 1, differently from a conventional game, a player does not need to purchase of items such as a weapon and the like using in-game currency or the like in a game, and thus a game can be enjoyed by reinforcing a player character smoothly without requiring a complicated operation.

(Scoring Unit 70)

In a case in which at least one of a player character or an ally character is positioned inside a predetermined area disposed inside the play field 300, the scoring unit 70 sets points assigned to the player as a score of the ally team. More specifically, at least one of a player character or an ally character is positioned inside a predetermined range of the enemy base 312 of an enemy team disposed inside the play field 300, the scoring unit 70 converts points owned by the player into a score of the ally team of this player in accordance with a predetermined operation of the player received through the input unit 20. In this case, in a case in which the scoring unit 70 sets the points as a score of the ally team, the character state determining unit 50 removes the ally character stored in the character storage area or the ally character appearing in the play field 300. Furthermore, the scoring unit 70 supplies a supply value according to this score to the enemy base 312 to accumulate the supply value in the enemy base 312. The scoring unit 70 supplies a score of each team to the victory/defeat determining unit 85 and supplies information relating to the supply value accumulated in the enemy base 312 to the base control unit 80.

Here, in a case in which points of the player are converted into a score of the ally team (in other words, in the case of scoring) and in a case in which a supply value according to this score is accumulated in the enemy base 312, the scoring unit 70 may complete scoring and accumulation at a time point at which a time set in advance has elapsed. In other words, until the time set in advance elapses from a time point at which the player character enters the inside of a predetermined range of an enemy base 312, the scoring unit 70 is able to not to complete the scoring and the accumulation of the supply value. In addition, in one enemy base 312, the scoring unit 70 can perform scoring of points until an endurance value of this one enemy base 312 to be described below reaches an upper limit. Furthermore, the scoring unit 70 may not start time elapse of the time set in advance only in accordance with the player character entering the inside of a predetermined range of the enemy base 312 and may start time elapse after the player performs a scoring operation.

In addition, in a case in which a predetermined special character (for example, the first special character) belonging to an ally team is present within a predetermined range of the enemy base 312, the scoring unit 70 may shorten the time set in advance that is necessary for completion of scoring and accumulation of supply values. In this case, a player character that is present within a predetermined range from this special character and belongs to an ally team present within the predetermined range of the enemy base 312, at a time point at which the time set in advance that has been shortened has elapsed, can perform scoring of points owned by a player of this player character and supply a supply value according to the score acquired through scoring to the enemy base 312.

Furthermore, in a case in which information representing that the first special character is positioned within a predetermined range from the enemy base 312 is received from the special character control unit 57, the scoring unit 70 sets at least points succeeded by the first special character as a score of the ally team and supplies a supply value corresponding to this score to the enemy base 312 to accumulate the supply value in the enemy base 312. In addition, in a case in which information representing that the second special character is positioned within a predetermined range from the enemy base 312 is received from the special character control unit 57, the scoring unit 70 sets points owned by the second special character as a score of the ally team and supplies a supply value corresponding to this score to the enemy base 312, thereby being able to accumulate the supply value in the enemy base 312.

Furthermore, in a case in which points owned by a player are set as a score of the ally team of this player, the scoring unit 70 limits generation of an effect of the ally character. For example, the scoring unit 70 removes an ally character stored in the character storage area or an ally character appearing in the play field 300. Here, the ally character may be removed immediately after scoring, or, after scoring, the ally character may be removed further after a predetermined time elapses. In addition, the scoring unit 70 may change a status of the ally character without removing the ally character. For example, in accordance with scoring of points, the scoring unit 70 may decrease the HP, the offensive power, the defensive power, and the like of the ally character. In accordance with this, a player can select scoring of points in spite of weakening the ally character or using the ally character as a co-fighting force with the points not converted as a score without weakening the ally character. In addition, in a case in which points are set as a score of the ally team, the scoring unit 70 may remove effects according to the ally character that have been generated in a predetermined area of the play field 300.

(Base Control Unit 80)

First, an endurance value set in advance is set in each base, that is, each of the ally base and the enemy base. In a case in which a plurality of bases are present, endurance values of the bases may be the same or different from each other. Here, from a point of view of improvement of a strategic characteristic and the like of the game, in a case in which a plurality of bases are present, by disposing an upper limit on the endurance value of each base, the endurance values of the bases may be different from each other. For example, in a case in which a plurality of enemy bases 312 are present in the play field 300, as an enemy base becomes closer to the ally headquarter 302, the lower the endurance value of the enemy base 312 can be set, and as an enemy base becomes farther from the ally headquarter 302, the higher the endurance value of the enemy base 312 can be set. In addition, for an enemy base 312 (a final base) that is the closest to the enemy headquarter 304, a substantial upper limit may not be set on the endurance value. In addition, the endurance value being high corresponds to an increase in the score quantity that can be scored by the opponent team. Then, in a case in which a sum value of supply values accumulated in the enemy base 312 by the scoring unit 70 becomes equal to or greater than the endurance, the base control unit 80 stops the function of the enemy base. The base control unit 80 similarly controls also the ally base 310. The base control unit 80 supplies information representing a control result to the experience value assigning unit 60 and the victory/defeat determining unit 85. In addition, in a case in which the function of a predetermined base is stopped, the base control unit 80 may remove display of this predetermined base displayed in an entire view 318.

In addition, in a case in which a plurality of bases are present, the base control unit 80 can stop the function from a base on a side close to the headquarter of a team to which a player character belongs (the ally headquarter 302 in the case of the ally team, and the enemy headquarter 304 in the case of the enemy team). For example, in a case in which the player character is a player character of an ally team, and a plurality of enemy bases 312 are present with being spaced from each other from a side close to the ally headquarter 302 toward the enemy headquarter 304, if not after the function of one enemy base 312 closest to the ally headquarter 302 is stopped (in other words, until the one enemy base 312 is destroyed), the base control unit 80 can be configured such that the function of another enemy base 312 near the one enemy base 312 (that is, an enemy base 312 second closest to the ally headquarter 302) cannot be stopped.

In addition, in a case in which, within a predetermined range from a predetermined base, a player character of a team to which this base belongs is present (for example, a player character of an ally team and an ally player character are present within a predetermined range from the ally base), the base control unit 80 can generate an effect that is advantageous to the player character. For example, the advantageous effect may be gradual recovery of the HP of the player character of the ally team present within a predetermined range from the ally base according to elapse of time, improvement of the offensive power, the defensive power, and the like at a predetermined ratio for a predetermined time, or the like. In addition, in a case in which, within a predetermined range from a base, a player character of a team to which this base belongs enters once, the base control unit 80 may continuously generate the advantageous effect for a predetermined time even when the player character comes out of this predetermined range.

In addition, in a case in which, within a predetermined range from a base of one team, a player character of the other team and/or an ally character of this player character are present, the base control unit 80 may cause this base to execute an attack on the player character and/or the ally character of this player character that have entered the inside of this range. However, from a point of view of allowing progress of a game to be intuitively and easily understood, the base control unit 80 may cause the base not to attack on the character.

(Victory/Defeat Determining Unit 85)

The victory/defeat determining unit 85 ends a game at a time point at which a game time set in advance has elapsed and determines victory/defeat of the game using the score of each team at the end time point. The victory/defeat determining unit 85 determines victory/defeat of the game on the basis of information received from the scoring unit 70 and/or information received from the base control unit 80. In other words, the victory/defeat determining unit 85 determines victory/defeat of the game on the basis of not points owned by each player but a sum score of a score acquired by scoring points on the basis of an instruction from a player and a score acquired by scoring points on the basis of an operation of the special character. The victory/defeat determining unit 85 compares the score of the ally team with the score of the enemy team and determines a team having a higher score as a victory team. The victory/defeat determining unit 85 causes the display unit 10 to display victory/defeat of each team together with the score of each team.

(Restriction Generating Unit 87)

Inside the play field 300, a plurality of bases of each team are disposed with being spaced from each other. In other words, a plurality of bases of an ally team (ally bases) and a plurality of bases of an enemy team (enemy bases) are disposed with a predetermined space interposed therebetween. Then, in a case in which, between one base and another base near the one base, a player character of a team different from a team to which such bases belong and an ally character of this player character penetrate, the restriction generating unit 87 applies a restriction on movement of this player character and this ally character. For example, the restriction is a restriction for lowering the movement speed, an effect for reducing the HP, or the like. For example, in a case in which, between one enemy base and another enemy base near the one enemy base, a player character of an ally team and/or an ally character penetrate, the restriction generating unit 87 can lower the movement speed of this player character and/or this ally character. The restriction generating unit 87 may display a status in which the movement is restricted in the display unit 10. For example, the restriction generating unit 87 may display a status in which the movement is restricted by displaying a predetermined mark, a shape, or the like in the vicinity of a player character and/or an ally character of which movement is restricted in an overlapping manner.

Here, in a case in which a predetermined restriction is applied between one base and another base positioned near the one base, in a case in which the function of at least one of the one base or the other base is stopped by the base control unit 80, the restriction generating unit 87 releases this predetermined restriction. In addition, under a condition that the function of one base of another team on a side close to a headquarter of one team is stopped, the restriction generating unit 87 also can enable stopping of the function of another base positioned near this one base. In other words, in a case in which a plurality of bases (for example, enemy bases) are present, after the function of the enemy base on a side close to the headquarter of the ally is stopped (in other words, after a player character of an ally destroys this enemy base), the restriction generating unit 87 enables stopping of the function of the enemy base on a side second closest to the ally headquarter (in other words, destruction of the this enemy base using the player character of the ally can be performed).

(Limit Time Control Unit 90)

In the game system 1, a limit time in which a game can be executed is set in advance. In addition, inside the play field 300, an extension base that can extend the limit time is disposed and may appear after elapse of a predetermined time from start of the game. Then, in a case in which one or more player characters belonging to an ally team are present within a predetermined range from the extension base for a predetermined time (hereinafter, it may be referred to as an “extendable time”), the limit time control unit 90 extends the limit time by a time set in advance. Here, the extension base may be configured to be able to be destroyed by an opponent player character attacking the extension base and giving a predetermined damage thereto. In addition, in a case in which one or more player characters belong to the ally team are present within a predetermined range from the extension base, in a case in which the enemy player character attacks on these one or more player characters of the ally team, the limit time control unit 90 may reset counting of the extendable time or extend the extendable time itself.

[Example of Operation of Input Unit of Game System 1]

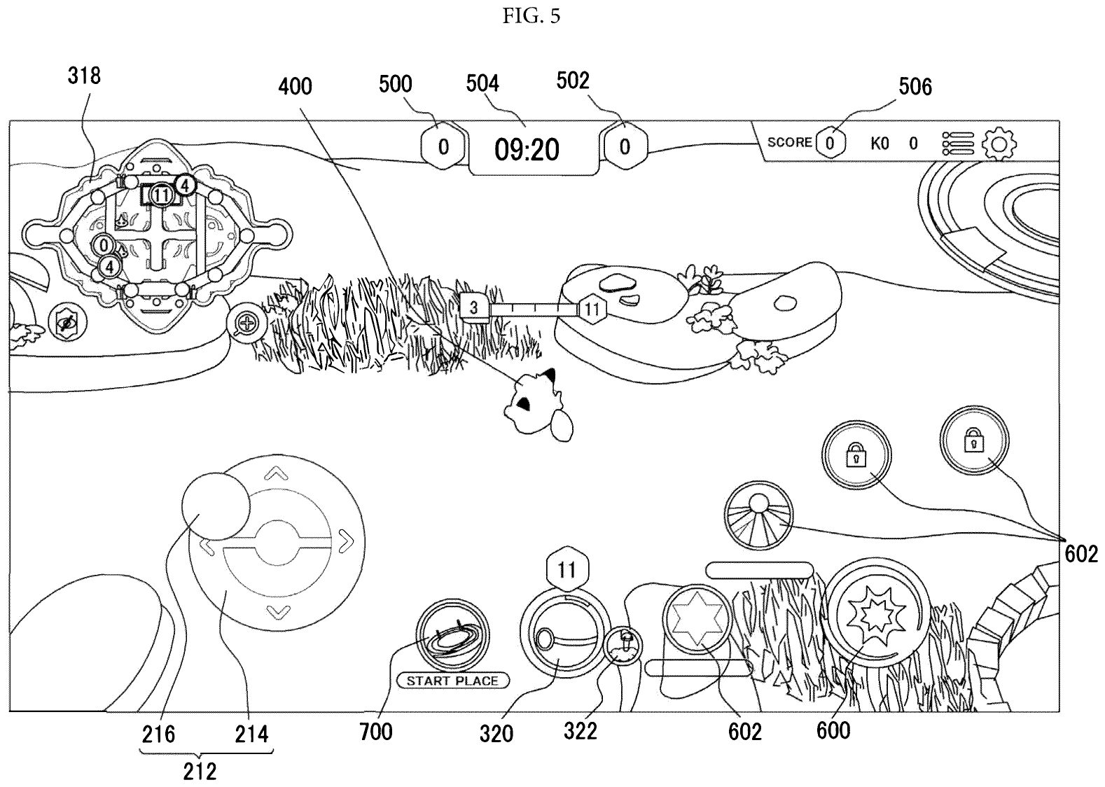

FIG. 5 illustrates an overview of one example of a movement instruction and the like for a player character using the input unit in the game system according to an exemplary embodiment.

In the game system 1, a player can operate the play field 300 that is a virtual space and the player character 400 using an information terminal 3 equipped with a touch panel as an example. Here, the game system 1 displays a movement instruction input area 212 that accepts a movement instruction for the player character 400 in the display unit 10 such that it can be perceived by a player. The movement instruction input area 212 includes a direction display area 214 that represents a movement direction of the player character 400 and a direction instruction section 216 that receives a movement direction and a movement instruction for the player character 400 from a player.

For example, as illustrated in FIG. 5, the display control unit 15 displays the direction display area 214 in a predetermined area of the display unit 10. Then, in a case in which the input unit 20 does not receive a movement instruction for the player character 400 from a player or at the moment at which the movement instruction is received, the display control unit 15 causes the display unit 10 to display the direction instruction section 216 at a predetermined position (for example, the center) of the direction display area 214. Then, in a case in which the input unit 20 receives a movement instruction for the player character 400 from a player, for example, in a case in which a finger of the player is in contact with a position near the direction display area 214 of the touch panel, and a movement direction and a movement instruction (for example, a movement instruction performed by sliding the finger in a predetermined direction) for the player character 400 are received in accordance with the finger of the player, the direction instruction section 216 is displayed at the contact position (hereinafter, a position at which the finger not in contact with the touch panel is brought into contact with the touch panel will be referred to as an “initial position”). In addition, the direction instruction section 216 is displayed in an area in which it can be displayed to overlap the direction display area 214.

Then, as illustrated in FIG. 5, the input unit 20 detects a current position (hereinafter, a position on the touch panel with which the finger is currently brought into contact will be referred to as a “current position”. Here, in this stage, it is assumed that the finger is not substantially detached from the touch panel until reach of the “current position” from the “initial position”) of the finger on the touch panel, and the display unit 10 displays an appearance of movement of the direction instruction section 216 to a predetermined position, which is a position corresponding to a direction from the initial position to the current position, in the vicinity of the direction display area 214 on the basis of detection using the input unit 20. In the example illustrated in FIG. 5, a movement instruction for the player character 400 is input in an upper leftward direction of the play field 300. Then, the character operation control unit 30 moves the player character 400 on the basis of an instruction received by the input unit 20. In the example illustrated in FIG. 5, the player character 400 moves in the upper leftward direction.

In addition, the direction instruction section 216 may be moved and displayed on the inside and along the periphery of the direction display area 214. Then, in a case in which a contact of the finger on the touch panel disappears, the input control unit 210 may remove display of the direction instruction section 216. In a case in which the finger is brought into contact with a position near the direction display area 214 the next time, the input control unit 210 repeats the control as described above. In addition, although the input control unit 210 receives an instruction from a player through the touch panel in the example described above, the input control unit 210 may receive an instruction from a player through another input unit 20 such as a mouse, a keyboard, or the like.

In addition, in the display unit 10, an attack instruction area 600 in which the player character 400 receives an attack instruction for a target character such as a neutral character, an enemy player character, or the like and a technique generation area 602 that receives an instruction for generating a predetermined technique are displayed. The input control unit 210 receives an instruction from a player for the attack instruction area 600 and the technique generation area 602 and supplies a received instruction to the fighting control unit 40. The fighting control unit 40 controls a fight between the player character 400 and the target character on the basis of the received instruction. In addition, in a case in which use of a predetermined technique for the player character 400 is not permitted, a mark indicating that the technique cannot be used is displayed in the technique generation area 602, and, in a case in which use of the technique is permitted in accordance with obtainment of an experience value, level-up, evolution, or the like, a mark representing usable techniques is displayed in the technique generation area 602.

Furthermore, the display unit 10 can display an entire view 318 that is a map acquired by reducing the entire play field 300, a character storage area 320, a storage character display 322 that displays ally characters stored in the character storage area 320, an ally team score 500 that represents a score of an ally team, an enemy team score 502 that represents a score of an enemy team, a remaining game time 504 representing a remaining time of a game time, and a player score 506 representing a score of the player in predetermined areas. In the entire view 318, positions of an ally player character, an enemy player character, a neutral character, and/or a special character may be displayed in real time. For the ally player character and the enemy player character, points owned by each character and/or each player may be displayed (in a case in which points owned by each player are displayed, points may be displayed at a position at which a player character of each player is present inside the play field 300). In addition, the display unit 10 also can display a return instruction area 700 that is able to return the player character 400 to the ally headquarter 302 by taking a predetermined time regardless of a position at which the player character 400 is present in the play field 300 at this instruction time point in accordance with an instruction from a player received through the input unit 20.

In the following description, for simplification of the description, illustrating and description of the movement instruction input area 212 are omitted.

[Example of Fight Against Neutral Character]

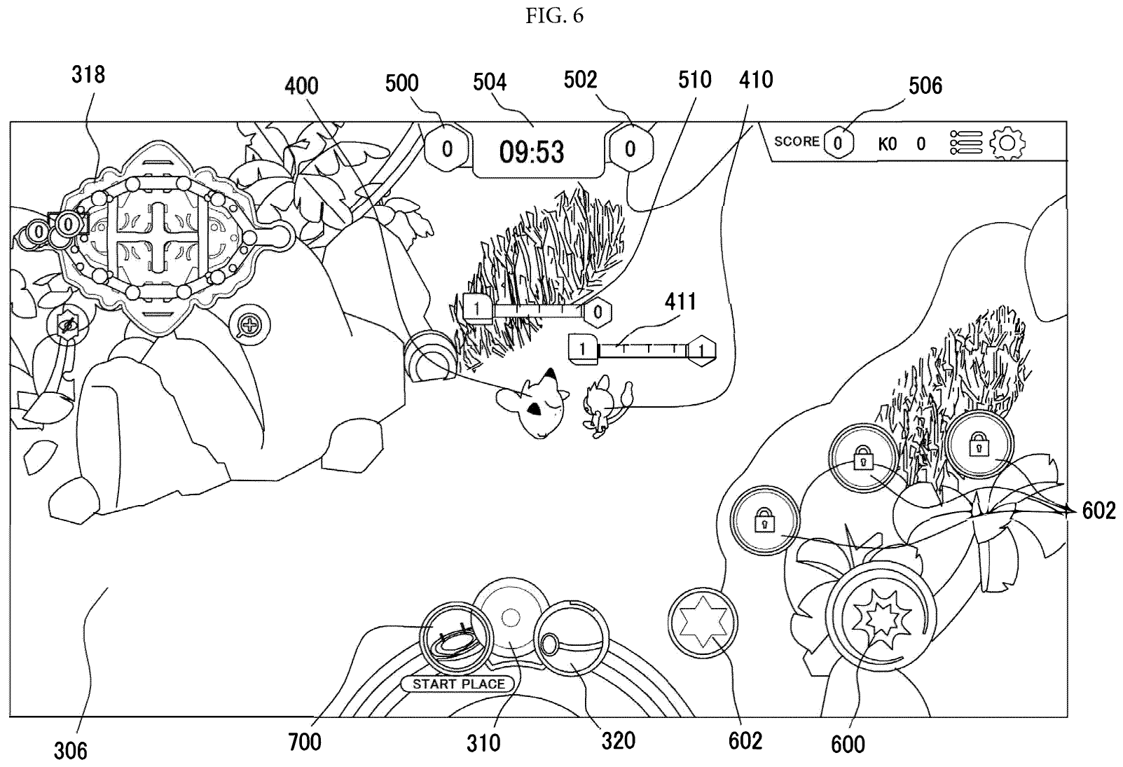

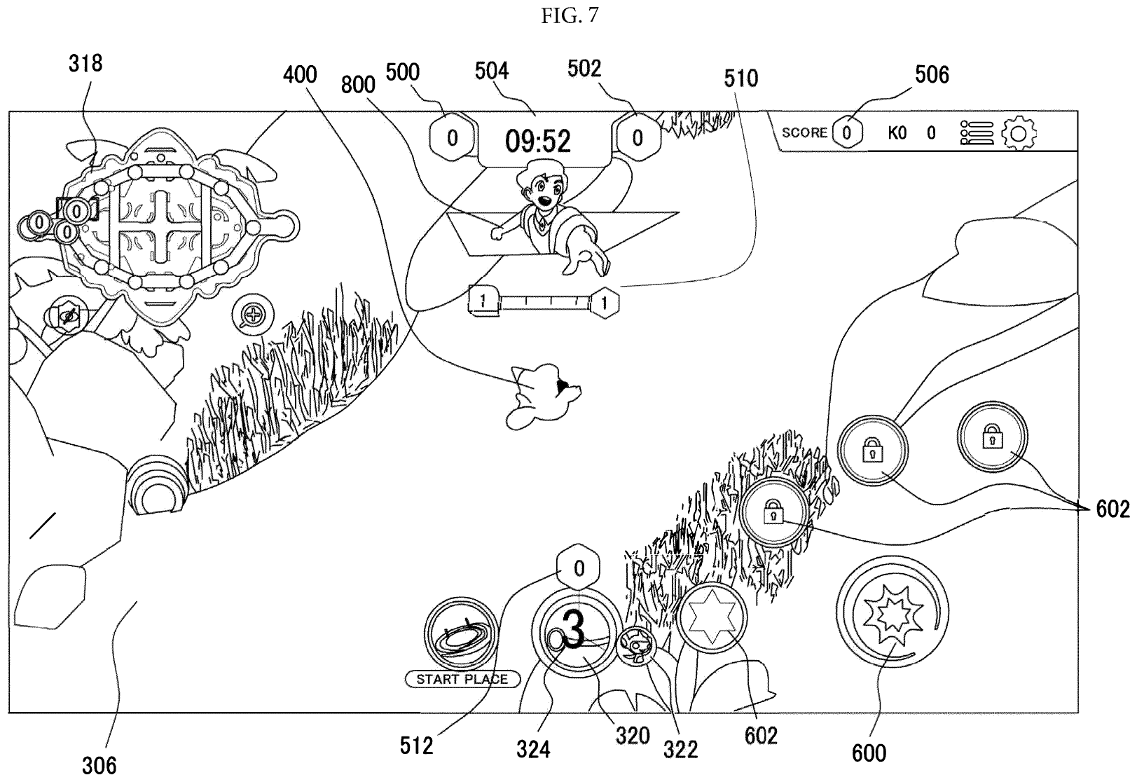

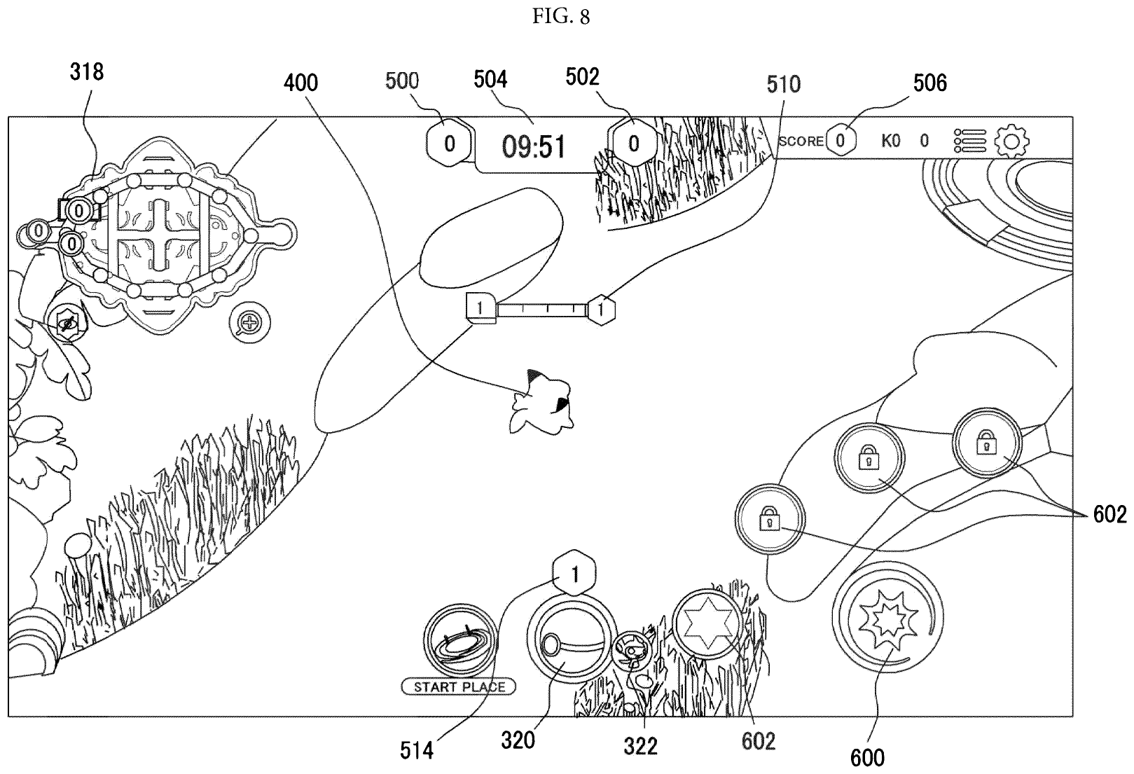

FIGS. 6 to 8 illustrate overviews of appearances of a fight between a player character and a neutral character in the game system according to an exemplary embodiment. More specifically, FIG. 6 illustrates an overview of an appearance at the time of starting an attack, FIG. 7 illustrates an overview of an appearance immediately after victory of the player character 400, and FIG. 8 illustrates an overview of point display.

For example, as illustrated in FIG. 6, in a case in which a neutral character 410 is present within a predetermined range from a player character 400 moving in a lane 306 of a play field 300 in accordance with an operation of a player, the fighting control unit 40 enables an attack of the player character 400 on a neutral character. Then, in a case in which an instruction for attacking using a player on the neutral character 410 is received through the input unit 20, the fighting control unit 40 starts a fight between the player character 400 and the neutral character 410. For example, in a case in which an instruction from a player for the attack instruction area 600 is received by the input unit 20, the fighting control unit 40 causes the player character 400 to execute an attack on the neutral character 410 (for example, a normal attack that can be used by the player character 400 initially from the start of the game).

Here, the display unit 10 displays a status 510 of the player character 400 near the player character 400 and can display a status 411 of the neutral character 410 near the neutral character 410. In the status, for example, a level, an HP, and owned points of each character (points owned by a player of this player character in a case in which the character is a player character) are displayed. For example, the status has a rectangular part representing the HP using a length of a horizontal bar and has a level display area of an approximately square shape displaying a level of the character at a left end of the rectangular part using a numerical value and a point display area of a hexagonal shape representing points owned by the character at a right end of the rectangular part. In the example illustrated in FIG. 6, the status 510 represents that the level of the player character 400 is “1”, the HP is full, and owned points owned by the player of the player character 400 are zero, and the status 411 represents that the level of the neutral character 410 is “1”, the HP is full, and the owned points are “1”.

The fighting control unit 40 causes the display unit 10 to display situations of the status 510 and the status 411 changing in accordance with a fight between the player character 400 and the neutral character 410 (for example, a situation of a decrease of the HP and the like). Then, in accordance with an attack using the player character 400, for example, in a case in which the HP of the neutral character 410 becomes zero, the fighting result determining unit 45 determines that the player character 400 has won over the neutral character 410. Next, the character state determining unit 50 associates this neutral character 410 with the player of the player character 400 on the basis of a determination result acquired by the fighting result determining unit 45. In accordance with this, the player has obtained the neutral character 410.

Then, as illustrated in FIG. 7, the character state determining unit 50 removes the display of the neutral character 410 from the play field 300 and stores the blown-down neutral character 410 in the character storage area 320 for players as an ally character. For example, the display unit 10 displays a character storage area 320 of a ball shape at a predetermined position and displays a storage character display 322 displaying a contact position in the character storage area 320 or an ally character stored in the character storage area 320 nearby. In the examples illustrated in FIGS. 6 and 7, the neutral character 410 becomes an ally character, and thus, by referring to the storage character display 322, it can be perceived that the neutral character 410 is stored in the character storage area 320 as an ally character. Although the storage character display 322, for example, displays an image of an ally character, it may display a name of an ally character. In addition, in this case, in order to allow the player to easily understand that the player character 400 has obtained the neutral character 410, the display unit 10 may display a performance display 800 representing obtainment of a neutral character and obtainment of points/an experience value at a predetermined position.

In addition, until an appearance of an ally character from the character storage area 320 to the play field 300 according to the ally character control unit 55 and storage of the ally character in the character storage area 320 can be repeated, elapse of a predetermined time may be set as a condition. In other words, until a predetermined time elapses after the ally character is stored in the character storage area 320, an appearance of the ally character in the play field 300 may be prohibited. The display unit 10 may display the elapse of this predetermined time in the character storage area 320 in an overlapping manner to be perceivable for a player. For example, the display unit 10 displays a time until control of an appearance of an ally character in the play field 300 according to the ally character control unit 55 and storage thereof in the character storage area 320 can be performed in a count-down display 324. After a time point at which the count-down display 324 ends, the ally character control unit 55 enables the ally character stored in the character storage area 320 to appear in the play field 300 in accordance with an instruction from a player.

Furthermore, since the player character 400 has won over the neutral character 410, the point assignment control unit 62 assigns points owned by the neutral character 410 to the player of the player character 400. In this case, the point assignment control unit 62 updates the point display area of the status 510 of the player character 400 and causes the display unit 10 to display that the player of the player character has obtained points. In the example illustrated in FIG. 7, since the point owned by the neutral character 410 is “1”, the point obtained by the player is “1”, the owned point of the player before obtainment of this point is “0”, and thus “1” is displayed in the point display area of the status 510.

In addition, the point assignment control unit 62 also can display points obtained by the player near the character storage area 320 as a point display 512. Here, until a predetermined time until an appearance of an ally character from the character storage area 320 to the play field 300 according to the ally character control unit 55 and storage of the ally character in the character storage area 320 can be repeated elapses, the point assignment control unit 62 sets the display of the point display 512 as display of points owned before the player of this player character obtains points by the player character blowing down the neutral character 410. In the example illustrated in FIG. 7, a point owned by the player before the player character 400 blows down the neutral character 410 is zero (as in the status 510 displayed in FIG. 6), and thus the point display 512 is also zero. In addition, in a case in which, before the player character 400 of the player blows down the neutral character 410, this player has a predetermined number of points, this predetermined number is displayed in the point display 512.

Then, at a time point at which the predetermined time until an appearance of an ally character from the character storage area 320 to the play field 300 according to the ally character control unit 55 and storage of the ally character in the character storage area 320 can be repeated has elapsed (in this case, the count-down display described above is removed), as illustrated in FIG. 8, in accordance with points owned by the neutral character 410 that has been blown down by the player character 400, the point assignment control unit 62 updates the display of the point display 512. In other words, in the example illustrated in FIG. 8, since points owned by the neutral character 410 that has been blown down by the player character 400 are “1” as illustrated in FIG. 6, “0” of the point display 512 illustrated in FIG. 7 is updated with “1” of a point display 514 illustrated in FIG. 8. In accordance with this, “1” is display also in the point display 514.

Furthermore, since the player character 400 has won a fight with the neutral character 410, the experience value assigning unit 60 assigns a predetermined experience value to the player character 400. The experience value assigning unit 60 displays the level of the player character 400 determined in accordance with a total of experience values obtained by the player character 400 in a level display area of the status 510.

[Example of Co-Fight with Ally Character]

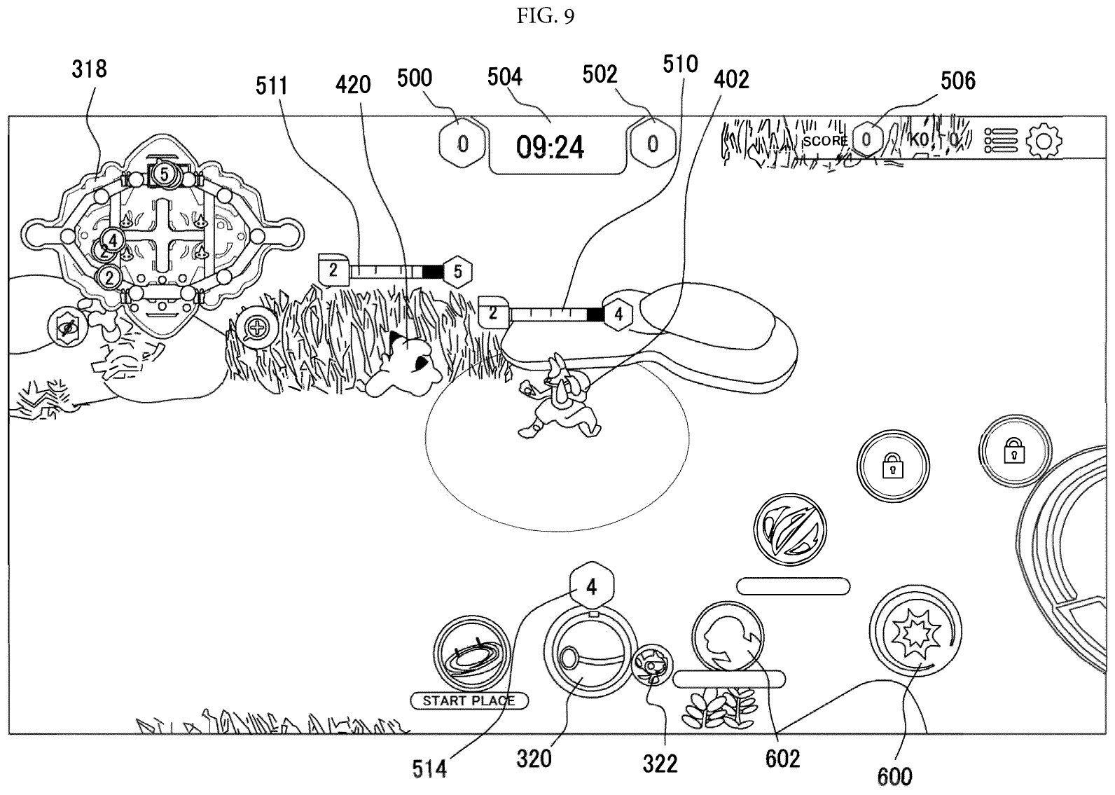

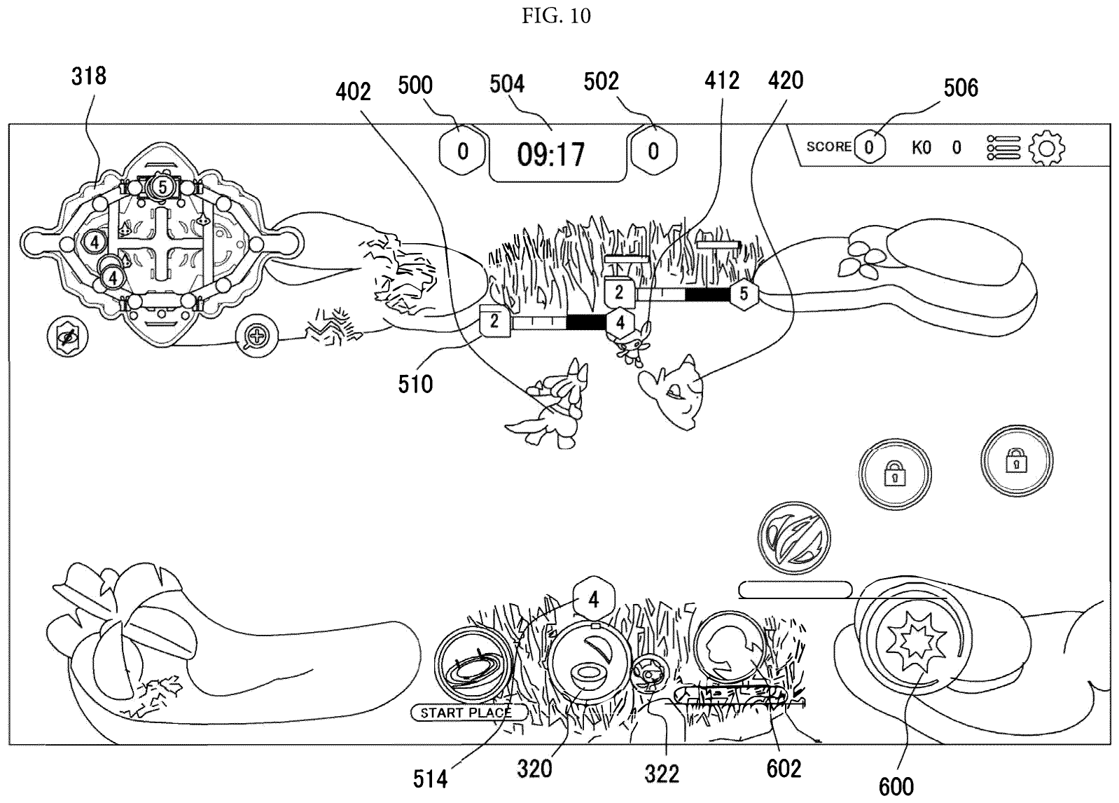

FIGS. 9 and 10 illustrates overviews of an appearance in which a player character and an ally character perform co-fighting in the game system according to an exemplary embodiment. More specifically, FIG. 9 illustrates an example of the state in which the ally character is stored in the character storage area 320, and FIG. 10 illustrates an example of a state in which an ally character appears in a play field 300.

First, as illustrated in FIG. 9, it is assumed that a player character 402 fights against an enemy player character 420 in a state in which an ally character of the player character 402 is stored in the character storage area 320. In addition, in accordance with the storage character display 322, an ally character stored in the character storage area 320 can be perceived. Then, the fighting control unit 40 controls a fight between the player character 402 and the enemy player character 420. In addition, the fighting control unit 40 causes the display unit 10 to display situations of the status 510 of the player character 402 and the status 511 of the enemy player character 420 changing in accordance with the fight between the player character 402 and the enemy player character 420. In addition, the status 510 is displayed near the player character 402, and the status 511 is displayed near the enemy player character 420.

More specifically, in a case in which the enemy player character 420 is present within a predetermined range from the player character 402, the fighting control unit 40 enables the player character 402 to attack on the enemy player character 420. Then, in a case in which an instruction of attack on the enemy player character 420 using the player is received through the input unit 20, the fighting control unit 40 starts a fight between the player character 402 and the enemy player character 420. For example, the fighting control unit 40 causes the player character 402 to execute an attack on the enemy player character 420 in a case in which an instruction from a player for the attack instruction area 600 has been received by the input unit 20 and causes the player character 402 to execute an attack using a technique on the enemy player character 420 in a case in which an instruction from the player for the technique generation area 602 has been received by the input unit 20. In addition, in a case in which the player causes the player character 402 to attack using a technique through a technique generation area 602, the fighting control unit 40 may prohibit execution of this technique again until a predetermined time elapses from the execution of this technique.

Next, as illustrated in FIG. 10, the ally character control unit 55 causes an ally character 412 stored in the character storage area 320 in the play field 300 on the basis of an instruction for causing the ally character 412 to appear in the play field 300 from a player. Here, “the stored ally character” represents the ally character 412 that can be caused to appear in the play field 300 at an arbitrary timing in accordance with an instruction from the player. In addition, in the storage character display 322, the ally character 412 appearing in the play field 300 is displayed. More specifically, in accordance with an instruction from the player for the character storage area 320 received through the input unit 20 (for example, an instruction according to a tap operation on the character storage area 320 that is performed by the player), the ally character control unit 55 causes the ally character 412 stored in the character storage area 320 to appear in the play field 300. Then, the ally character control unit 55 performs control of the ally character 412, which has appeared, to automatically follow the player character 402 and move in the vicinity of the player character 402. Furthermore, the ally character control unit 55 automatically executes an attack on the enemy player character 420 present within a predetermined range from the ally character 412. In the example illustrated in FIG. 10, the ally character 412 executes an attack on the enemy player character 420 under the control of the ally character control unit 55. In addition, the ally character control unit 55 re-stores the ally character 412 appearing in the play field 300 in the character storage area 320 in accordance with an instruction made again from the player for the character storage area 320 received through the input unit 20.

In a case in which the ally character 412 is caused to appear in the play field 300, the ally character control unit 55 can configure a display icon of the character storage area 320 to be a display representing a situation in which the ally character 412 has come outside. For example, in a case in which the character storage area 320 is denoted by a display icon of a ball shape, when the ally character is stored, as illustrated in FIG. 9, a state in which the ball is closed can be illustrated, and, when the ally character appears in the play field 300, as illustrated in FIG. 10, a state in which the ball is opened can be illustrated.

Then, in a case in which the enemy player character 420 has been blown down in accordance with attack from the player character 402 and/or the ally character 412, the experience value assigning unit 60 assigns a predetermined quantity of an experience value to the player character 402. Here, in a case in which the ally character 412 has been blown down in accordance with an attack from the enemy player character 420, the ally character control unit 55 removes the ally character 412 from the play field 300. In accordance with this, the ally character owned by the player disappears. Thereon, the point assignment control unit 62 acquires a determination result indicating that the ally character 412 has been defeated from the ally character control unit 55 and reduces points owned by the player of the player character by a predetermined quantity.

In addition, the method of co-fighting with the ally character 412 is not limited to the example described above and can be realized using various methods. For example, movement of the ally character 412 and an attack on the enemy player character 420 from the ally character 412 may not be automatically executed and executed on the basis of an operation instruction from the player. In addition, the ally character 412 may not appear in the play field 300 in accordance with an instruction from the player for the character storage area 320 that is received through the input unit 20, and a predetermined game effect such as a technique or an item associated with the ally character 412 may be generated in a predetermined range of the play field 300. In this case, in a case in which a predetermined condition that the player character is blown down in accordance with an attack from the enemy player character 420 is satisfied, the ally character control unit 55 can restrict the use of a technique and an item associated with the ally character 412.

[Example of Scoring of Point]

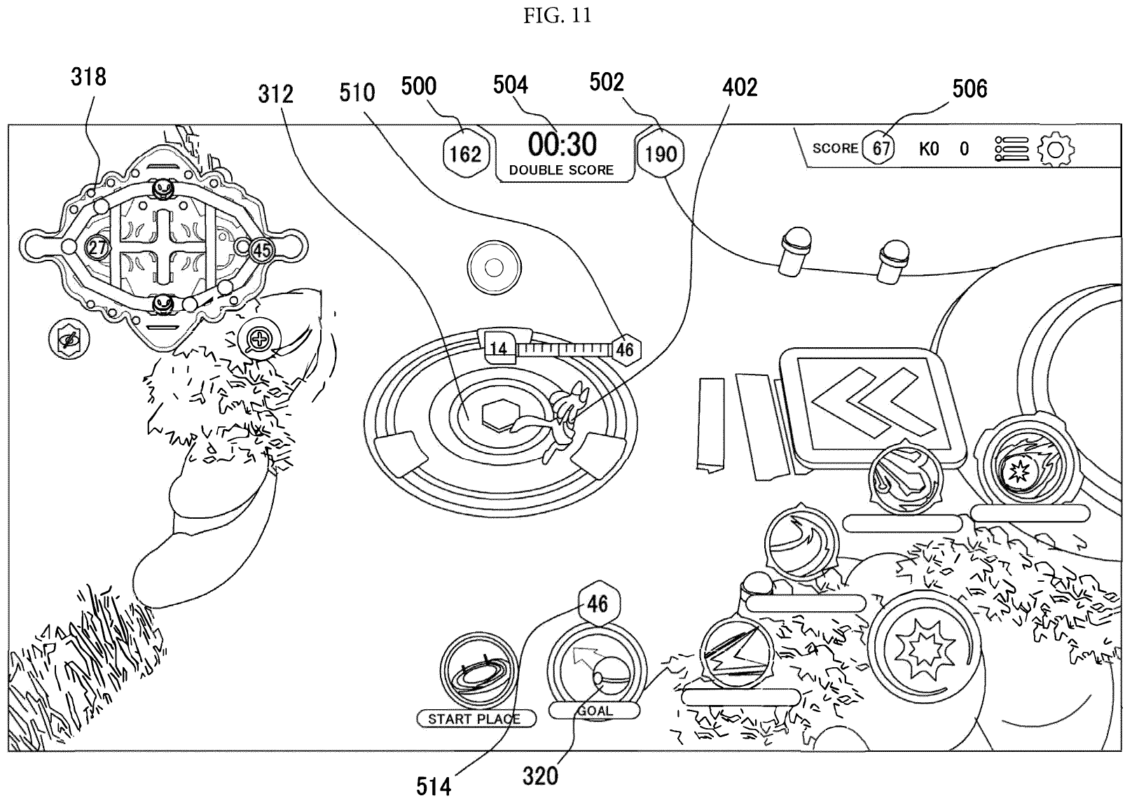

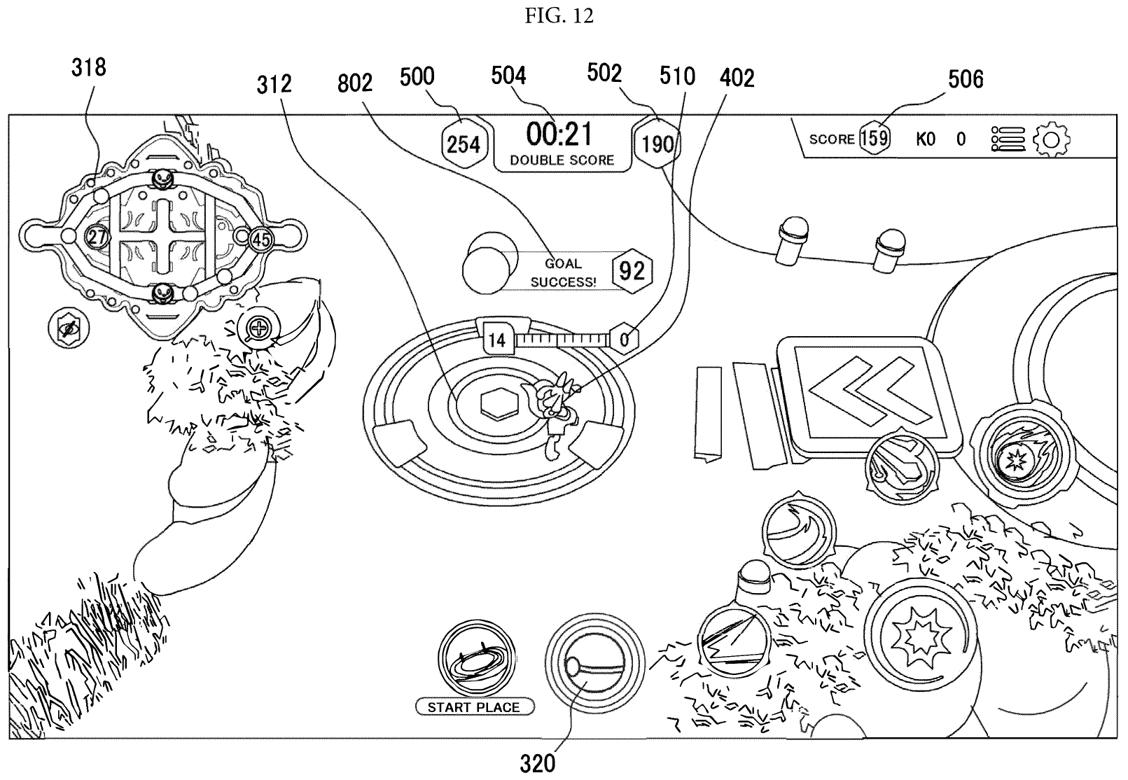

FIGS. 11 and 12 illustrate overviews of an example of scoring points in the game system according to an exemplary embodiment. More specifically, FIG. 11 illustrates an example of a state before points owned by the player character 402 are set as a score, and FIG. 12 illustrates an example of a state after points owned by the player character 402 are set as a score.

In a case in which a player of the player character 402 owns points, the scoring unit 70 can set these points as a score of a team to which the player of the player character 402 belongs under a predetermined condition. In FIGS. 11 and 12, an example in which a score enters the team (the ally team) of the player character 402 is illustrated. In addition, in FIG. 11, it is illustrated that an ally team score 500 is “162 points”, and an enemy team score 502 is “190 points”, and points obtained individually by the player up to a time point at which the state illustrated in FIG. 11 is formed being “67 points” is represented in a player score 506. In addition, in FIG. 11, a remaining game time 504 is also displayed (in FIG. 11, an example in which the remaining time is 30 seconds is illustrated).

First, as illustrated in FIG. 11, the player of the player character 402 owns predetermined points. The points owned by the player of the player character 402 are displayed in the point display area of the status 510 of the player character 402 and the point display 514 displayed near the character storage area 320 (in the example illustrated in FIG. 11, the player of the player character 402 owns “46” points. In addition, in the example illustrated in FIG. 11, the level of the player character 402 is displayed in the level display area and is level “14”.

Then, in a case in which the player character 402 enters the inside of a predetermined range (hereinafter, this may be referred to as an “enemy base area”) from the enemy base 312, in accordance with an instruction of scoring from the player that is received through the input unit 20, points owned by the player of the player character 402 are set as a score of the ally team. More specifically, the enemy base 312, for example, has an area of an approximately circular shape. Then, in a case in which the player character 402 enters this area, the scoring unit 70 can display in which scoring can be performed in the character storage area 320. In the example illustrated in FIG. 11, an arrow is assigned to the ball shape displayed in the character storage area 320, and a text “goal is reached” is displayed.

Then, in a case in which an instruction for the character storage area 320 (for example, a tap operation, a long-press operation, or the like) from the player is received by the input unit 20 in this state, the scoring unit 70 executes a scoring process. More specifically, the scoring unit 70 does not perform scoring of points until a predetermined time elapses from a time point at which an instruction for scoring for the character storage area 320 is made by the player and executes scoring of points when the predetermined time elapses. In other words, the scoring unit 70 executes a count-down process up to scoring. Here, in a case in which the player character 402 has come out of the enemy base area or has been blown down by the enemy player character 420 before completion of scoring of points, the count-down process performed by the scoring unit 70 may be reset.

Then, when the predetermined time elapses, the scoring unit 70 sets points owned by the player character 402 as a score of the ally team. In the example illustrated in FIG. 12, “46” points owned by the player of the player character 402 are converted into a score (scored), and the score is added to the score of the ally team. In a case in which points owned by the player of the player character 402 are set as a score, the scoring unit 70 sets the points owned by the player of the player character 402 to zero and displays an indication thereof. For example, the display of the point display area of the status 510 of the player character 402 is set to “0”, and the point display 514 displayed near the character storage area 320 is removed.

After points are set as a score, and the score is added to the score of the ally team, the scoring unit 70 updates the display of the score of the ally team and the display of scores of individual players. In the example illustrated in FIG. 12, it is illustrated that the ally team score 500 becomes “254 points”, and the player score 506 that is individual players' score is “159 points”. In addition, in a case in which scoring of points has been completed, the scoring unit 70 may display a display 802 representing that scoring has been successful at a predetermined position of the display unit 10 (for example, a text display such as “goal success!” or the like can be displayed).

In addition, in a case in which a remaining time of the game becomes a time set in advance or less, the scoring unit 70 may apply a correction to the score obtained by each team. For example, in the example illustrated in FIG. 12, the scoring unit 70 sets a score that can be obtained by each team to be “two times” with being triggered upon the remaining time of the game being a predetermined time or less. For this reason, in the example illustrated in FIGS. 11 and 12, although points owned by the player are “46”, the score of the ally team becomes not “208 points” but “254 points” in accordance with scoring, and the score obtained by an individual player becomes not “46 points” but “92 points” (for this reason, the score of the individual player after scoring becomes “159 points”). Thus, before the remaining time of the game becomes a predetermined time or less, the scoring unit 70 sets points owned by the player as a score without applying a correction thereto, and the score is added to the ally team and the individual player score (for example, in the example illustrated in FIGS. 11 and 12, in a case in which the remaining time of the game is not equal to or less than a predetermined time, points “46” owned by the player are “46 points”, “46 points” are added to the score “162 points” of the ally team to be “208 points” and are added to the individual player score “67 points” to be “113 points”.).

In addition, the scoring unit 70 supplies a supply value according to the score acquired by scoring the points to the enemy base 312. Then, the scoring unit 70 accumulates the supply value in the enemy base 312. The supply value may be the same as the value of the score. In a case in which a sum value of supply values accumulated by the scoring unit 70 in the enemy base 312 is equal to or greater than an endurance value set in advance in the enemy base 312, the base control unit 80 stops the function of the enemy base 312. After stopping the function of the enemy base 312, scoring of points by supplying the points to this enemy base 312 and accumulation of supply values cannot be performed. Thus, the player of the ally team has another enemy base 312 as a goal and has scoring of points and accumulation of supply values in the other enemy base 312/function stop as a goal.

In an exemplary embodiment, as one example, a plurality of enemy bases 312 are arranged from a side close to the ally headquarter 302 toward the enemy headquarter 304, and the farther an enemy base is from the side close to the ally headquarter 302, the higher the endurance value of the enemy base 312 can be set. In other words, the quantity of scoring of points in the enemy base 312 on a far side is set to be larger than the quantity of scoring of points in the enemy base 312 on a side close to the ally headquarter 302. In accordance with this, the player of the ally team allows his or her player character to accumulate an experience value to achieve a level-up while executing the game on a side close to the ally headquarter 302 in an early stage of the game and can have a goal of scoring points in an enemy base 312 on a side close to the enemy headquarter 304 in the state of owning many points for obtainment of more scores from a middle stage to a final stage of the game as his or her goal.

[Example of First Special Character]

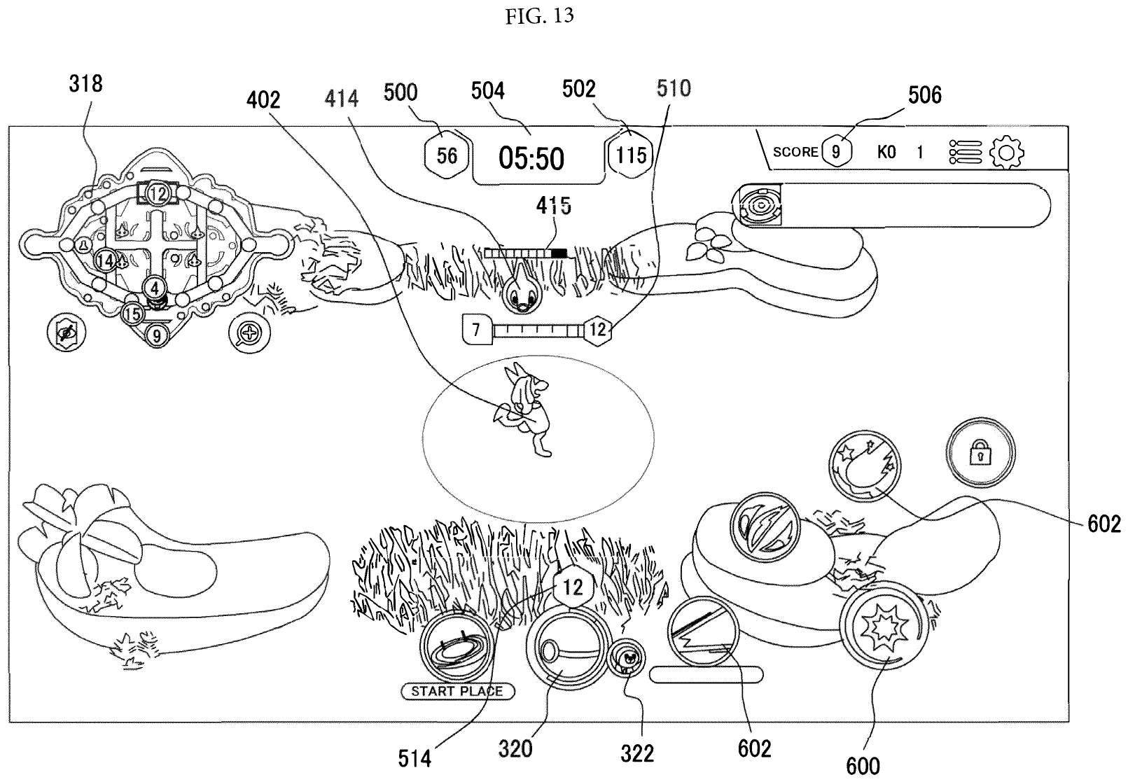

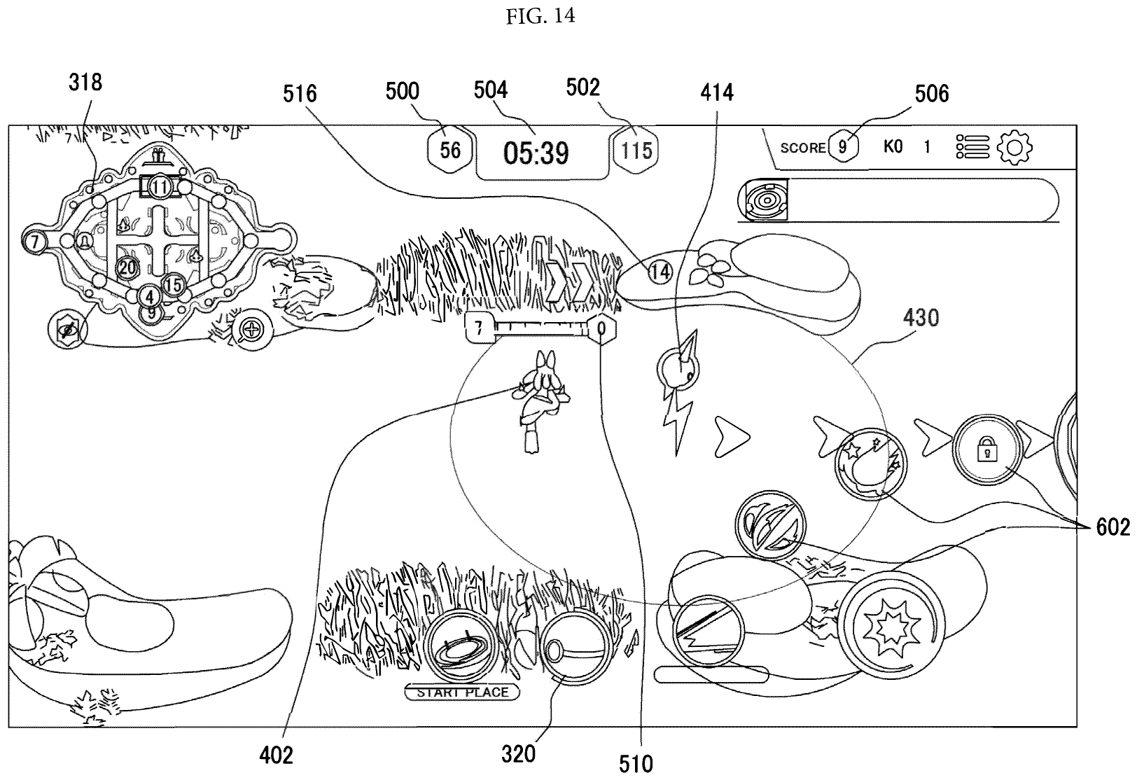

FIGS. 13 and 14 illustrate an overview of examples of the first special character in the game system according to an exemplary embodiment. More specifically, FIG. 13 illustrates an example of a fight between a player character 402 and a first special character 414, and FIG. 14 illustrates an example in which the first special character 414 belongs to an ally team.

First, the appearance control unit 35 causes the first special character 414 to simultaneously appear at predetermined two places of the play field 300. For example, in a case in which the play field 300 has an approximately oval shape and in a case in which a lane 306 is disposed along near the outer periphery, the appearance control unit 35 causes the first special character 414 to appear near two intersections between a minor axis of the oval and the lane 306. In accordance with this, a chance to meet with the first special character 414 can be equally provided for the ally team player character of the ally team and the enemy player character of the enemy team.

As illustrated in FIG. 13, in a case in which the first special character 414 is present within a predetermined range from the player character 402 present in the play field 300 in accordance with an operation of the player, the fighting control unit 40 enables the player character 402 to attack on the first special character 414. Then, in a case in which an attack instruction for the first special character 414 according to the player has been received through the input unit 20, the fighting control unit 40 starts a fight between the player character 402 and the first special character 414.

The fighting control unit 40 causes the display unit 10 to display situations (for example, situations of decreases of the HP and the like) of the status 510 of the player character 402 and the status 415 of the first special character 414 changing in accordance with a fight between the player character 402 and the first special character 414. In addition, the status 415 of the first special character 414 is displayed near the first special character 414. In the example illustrated in FIG. 13, in the status 510 of the player character 402, it is displayed that the level of the player character 402 is “7”, and the player of the player character 402 has already own points of “12” points (similarly, also in the point display 514 displayed near the character storage area 320, the player of the player character is displayed to have “12” points.).

Then, for example, in a case in which the HP of the first special character 414 becomes zero in accordance with the attack of the player character 402, the fighting result determining unit 45 determines that the player character 402 has won over the first special character 414. Next, the character state determining unit 50 associates this first special character 414 with a team (an ally team) to which the player of the player character 402 belongs on the basis of the determination result acquired by the fighting result determining unit 45. More specifically, the character ID of the first special character 414 is associated with a team ID or a player ID. In accordance with this, the first special character 414 belongs to the ally team.

In addition, in a case in which the ally player character of the ally team and the enemy player character of the enemy team attack on the first special character 414 in the same time period, and the first special character 414 is blown down, the fighting result determining unit 45 may determine a character that has made an attack causing the HP of the first special character 414 to zero last (in other words, a character of a “last hit”) as a character that has won the fight. In this case, the character state determining unit 50 causes the first special character 414 to belong to the team to which the character that has won the fight belongs.

Then, the special character control unit 57, as illustrated in FIG. 14, causes the first special character 414 to succeed points owned by the player of the player character 402. In other words, the special character control unit 57 delivers points owned by the player of the player character 402 that is a character that has won the fight to the first special character 414, adds the points to a predetermined point uniquely owned by the first special character 414, and sets the point after the addition as points owned by the first special character 414. In the example illustrated in FIG. 14, “12” points owned by the player of the player character 402 are delivered to the first special character 414, points “14” acquired by adding the points to the point “2” owned by the first special character 414 in advance are owned by the first special character 414. The special character control unit 57 displays the points owned by the first special character 414 near the first special character 414 (a point display 516). In addition, in a case in which the first special character 414 is causes to succeed points owned by the player of the player character 402, the special character control unit 57 sets the point display of the status 510 to zero and removes the point display 514 displayed near the character storage area 320. In this case, the special character control unit 57 removes the ally character stored in the character storage area 320 and the ally character appearing in the play field from the character storage area 320.

Subsequently, the special character control unit 57 controls the first special character 414 and causes the first special character 414 to progress from a place belonging to the ally team to the closest to the enemy base 312. In this case, in a case in which characters (a player character and/or an ally character) of the ally team are present within a predetermined range (hereinafter, referred to as an “effective range 430”) having the first special character 414 as its center, the special character control unit 57 may increase the movement speed of the first special character 414. In addition, in a case in which a character of the ally team is present within the effective range 430, the special character control unit 57 may change the status of the character of the ally team. For example, the special character control unit 57 may gradually recover the HP of the character of the ally team within the effective range 430.

Then, in a case in which the first special character 414 reaches the inside of a predetermined range from the enemy base 312, the scoring unit 70 automatically adds points owned by the first special character 414 to the score of the ally team, supplies a supply value corresponding to the score to the enemy base 312, accumulates supply values in the enemy base 312, and removes the first special character 414. In this case, the base control unit 80 may invalidate generation of an advantageous effect given to the character of the enemy team (an enemy player character and/or an ally character of the enemy player character) for a predetermined time using this enemy base 312.

Here, there are cases in which the first special character 414 is blown down by an attack from an enemy player character and/or an ally character of an enemy player character. In addition, the special character control unit 57 may not cause the first special character 414 to attack on the enemy player character and/or an ally character of the enemy player character. Then, in a case in which the first special character 414 is blown down, points owned by the first special character 414 are removed, and the first special character 414 is also removed from the play field 300. Thus, in a case in which the first special character 414 is caused to belong to the ally team, an incentive for keeping the first special character 414 is generated by operating his or her player character in the player of the ally team, and an incentive for attacking on the first special character 414 is generated by operating his or her player character in the player of the enemy team.

[Example of Second Special Character]

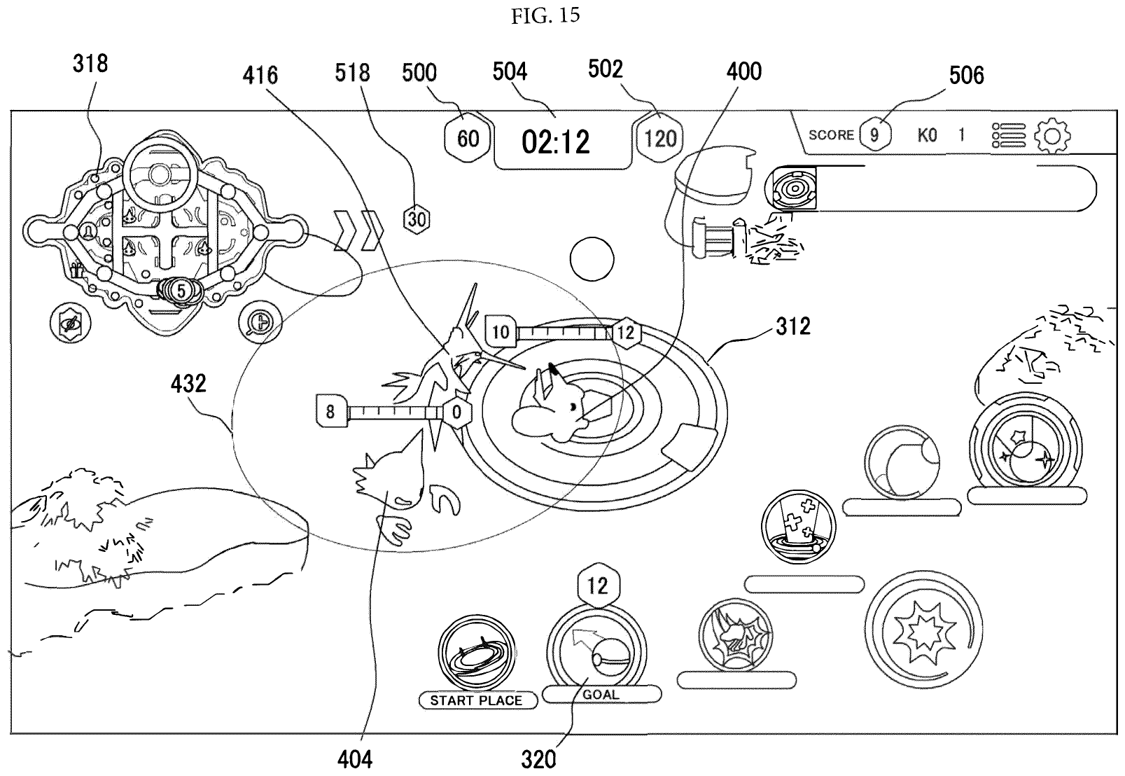

FIG. 15 illustrates an overview of an example of a second special character in the game system according to an exemplary embodiment.

First, the appearance control unit 35 causes a second special character 416 to appear at a predetermined place of the play field 300. For example, the appearance control unit 35 causes the second special character 416 to appear at a center part 316 of the play field 300. In accordance with this, a chance to meet with the second special character 416 can be equally provided for the ally player character of the ally team and the enemy player character of the enemy team. In addition, the second special character 416 has predetermined points in advance. In the example illustrated in FIG. 15, an example in which “30” points are owned is illustrated.

In a case in which the second special character 416 is present within a predetermined range from a player character present in the play field 300 in accordance with an operation of a player, the fighting control unit 40 enables the player character to attack on the second special character 416. Then, in a case in which an attack instruction on the second special character 416 has been received from the player through the input unit 20, the fighting control unit 40 starts a fight between the player character and the second special character 416. Similar to the fight between the player character 402 and the first special character 414, the fighting control unit 40 causes the display unit 10 to display situations of the status of the player character and the status of the second special character 416.

Then, in a case in which the HP of the second special character 416 becomes zero in accordance with an attack from a player character (for example, the player character 400), the fighting result determining unit 45 determines that the player character 400 has won over the second special character 416. Next, the character state determining unit 50 associates this second special character 416 with a team (an ally team) to which the player of the player character 400 belongs on the basis of a determination result acquired by the fighting result determining unit 45. In accordance with this, the second special character 416 belongs to the ally team. In addition, also for the second special character 416, similar to the case of the first special character 414, a character of a “last hit” may be determined as a character that has won the fight. The character state determining unit 50 causes the second special character 416 to belong to a team to which the character that has won the fight belongs. Then, the special character control unit 57, as illustrated in FIG. 15, displays points assigned to the second special character 416 in advance near the second special character 416 (a point display 518).

Subsequently, by controlling the second special character 416, the special character control unit 57 causes the second special character 416 to progress from a place at which the second special character 416 belongs to the ally team to the closest enemy base 312. In this case, in a case in which characters of the ally team (a player character and/or an ally character) are present within a predetermined range (hereinafter, referred to as an “effective range 432”) having the second special character 416 as its center, the special character control unit 57 may increase the movement speed of the second special character 416. In addition, in a case in which a character of the ally team is present within the effective range 432, the special character control unit 57 may change the status of the character of the ally team. For example, the special character control unit 57 may gradually recover the HP of the character of the ally team within the effective range 432. In the example illustrated in FIG. 15, a player character 400 and a player character 404 belonging to the ally team are present within the effective range 432, an advantageous effect is generated in such player characters. In addition, characters of types different from the second special character 416 may be set as a third special character, a fourth special character, and the like. In this case, the special character control unit 57 may generate a different advantageous effect in characters of the ally team present within the effective range 432 in accordance with the type of special character.

Then, in a case in which the second special character 416 has reached the inside of a predetermined range from the enemy base 312, the scoring unit 70 automatically converts points owned by the second special character 416 into a score of the ally team in accordance with elapse of time, supplies a supply value corresponding to this score to the enemy base 312, and accumulates the supply value in the enemy base 312. In other words, the scoring unit 70, for points owned by the second special character 416, scores a quantity set in advance for elapse of a time set in advance and sets the score as a supply value supplied to the enemy base 312 (for example, one point in one second is scored and is set as a supply value). In a case in which all the points owned by the second special character 416 are set as a score, the special character control unit 57 removes the second special character 416 from the play field 300.

Here, a case in which a supply value corresponding to points owned by the second special character 416 is accumulated in the enemy base 312, and a sum value of the accumulated supply values becomes equal to or greater than an endurance value of the enemy base 312 and a case in which points owned by the second special character 416 remain will be described. In this case, first, the base control unit 80 stops the function of this enemy base 312. Then, the special character control unit 57 causes the second special character 416 to progress toward another enemy base 312 closest to the enemy base 312 of which the function has been stopped and, similar to the description presented above, controls the second special character 416. In other words, in a case in which points owned by the second special character 416 are supplied to the enemy base 312 as a supply value, a sum value of supply values reaches the endurance value, and the enemy base 312 is destroyed, in a case in which points owned by the second special character 416 remain, the special character control unit 57 causes the second special character 416 to progress toward the next enemy base 312. The special character control unit 57 executes a similar process until points owned by the second special character 416 becomes zero.

Here, there are cases in which the second special character 416 is blown down in accordance with an attack from an enemy player character and/or an ally character of an enemy player character. In addition, the special character control unit 57 may cause the enemy player character and/or the ally character of the enemy player character to make an attack while moving the second special character 416. Then, in a case in which the second special character 416 is blown down, points owned by the second special character 416 are removed, and the second special character 416 is also removed from the play field 300. Thus, in a case in which the second special character 416 is caused to belong to the ally team, an incentive for keeping the second special character 416 is generated by operating his or her player character in the player of the ally team, and an incentive for attacking on the second special character 416 is generated by operating his or her player character in the player of the enemy team.

[Example of Restriction Generating Unit]

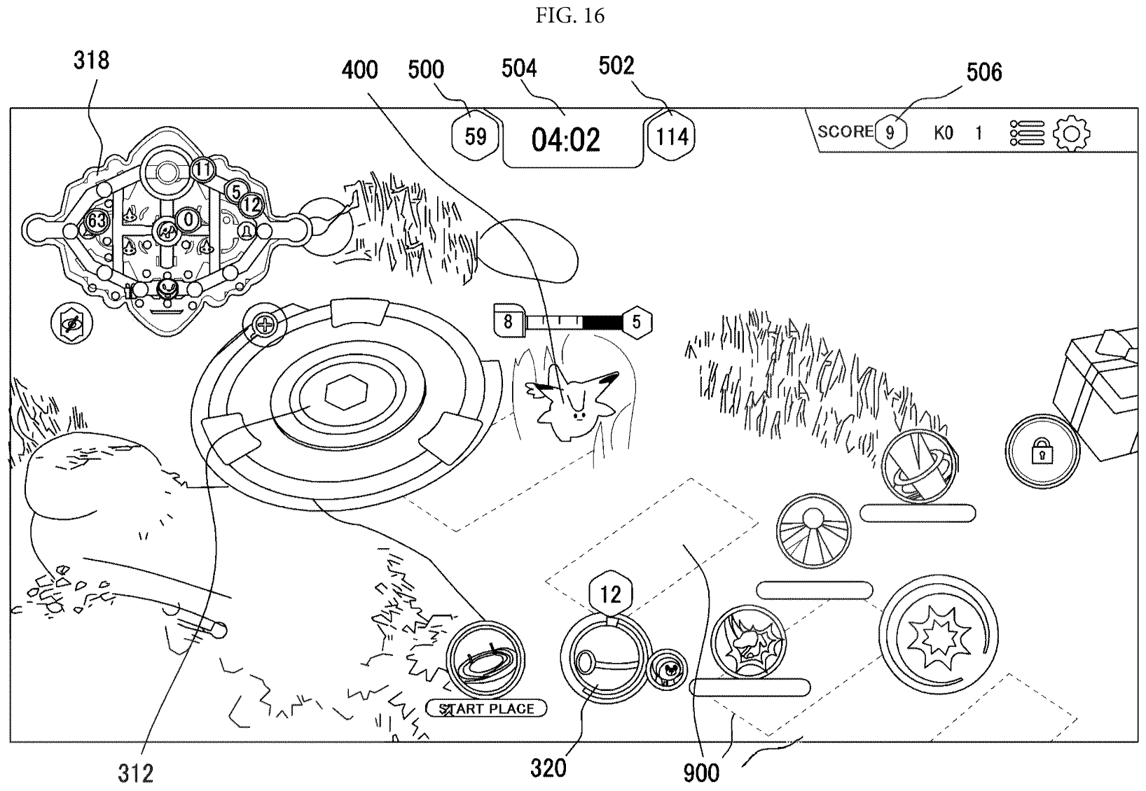

FIG. 16 illustrates an overview of the function of the restriction generating unit in the game system according to an exemplary embodiment. The example illustrated in FIG. 16 illustrates an appearance in which a player character 400 of an ally team goes over an enemy base 312 of which the function has not been stopped and progresses toward an enemy base 312 near the enemy base 312 disposed along a lane 306.

In a case in which a player character 400 penetrates between one enemy base 312 and another enemy base 312 disposed near the one enemy base 312, the restriction generating unit 87 lowers the movement speed of the player character 400. The restriction generating unit 87 causes the display unit 10 to display a restriction area 900 that is an area in which the movement speed of a player character of the ally team is restricted. The restriction area 900 is an area in which movement is restricted in the lane 306 between the one enemy base 312 and another enemy base 312 disposed near the one enemy base 312 and is displayed to be able to be perceived by a player. As one example, the restriction area 900 has a form to overlap the lane 306 in display. The restriction generating unit 87 may apply a predetermined color to this form or may be caused to blink or the like. In addition, the restriction generating unit 87 may display a predetermined shape on the periphery of a player character 400 present within the restriction area 900. In the example illustrated in FIG. 16, although a plurality of areas are displayed using dotted lines, an area acquired by adding the plurality of areas denoted by the dotted lines and spaces between the areas is the restriction area 900 (In other words, the entire lane 306 between one enemy base 312 and another enemy base 312 positioned near is the restriction area 900.).

In addition, in a case in which a restriction of movement speed between one enemy base 312 and another enemy base 312 positioned near the one enemy base 312 is applied, in a case in which the function of the one enemy base 312 is stopped by the base control unit 80, the restriction generating unit 87 releases the restriction of the movement speed, and the display of the restriction area 900 is removed. In accordance with this, a player character of the ally team can move at a normal speed.

[Example of Appearance of Neutral Character According to Fighting Status]

The appearance control unit 35 may change an appearance timing and/or an appearance place of a predetermined neutral character in the play field 300 in accordance with the status of a fight between an ally team and an enemy team. As the predetermined neutral character, for example, there is a neutral character having an effect of decreasing a score of an opponent team fighting against a team to which a player character that has blown down a predetermined neutral character belongs in a case in which this predetermined neutral character has been blown down. In addition, similar to other neutral characters, this predetermined neutral character may also have a predetermined point, and this predetermined point is assigned to a player of a player character that has blown down this predetermined neutral character.

More specifically, the appearance control unit 35 changes an appearance place of the predetermined neutral character in accordance with a difference between the score of the ally team and the score of the opponent team (hereinafter referred to as a “score difference”). For example, the appearance control unit 35 can shift the appearance place of this predetermined neutral character to an ally headquarter 302 side by a predetermined distance in a case in which the score difference has a positive value (in other words, the score of the ally team is higher than that of the enemy team) and can shift the appearance place of this predetermined neutral character to an enemy headquarter 304 side by a predetermined distance in a case in which the score difference has a negative value.

First, in a case in which there is no score difference between the score of the ally team and the score of the enemy team, the appearance control unit 35 causes this predetermined neutral character to appear at a middle place between the ally headquarter 302 and the enemy headquarter 304. On the other hand, in a case in which the score difference is a predetermined value or less (for example, in a case in which the score of the ally team is “10 points”, and the score of the enemy team is “1 point”), the appearance control unit 35 shifts the appearance position of this predetermined neutral character to the ally headquarter 302 side by a distance corresponding to the score difference (for example, the appearance position is shifted to the ally headquarter 302 side by a distance corresponding to 10% of a linear distance from the ally headquarter 302 to the enemy headquarter 304). In addition, in a case in which the score difference exceeds the predetermined value (for example, in a case in which the score of the ally team is “90 points”, and the score of the enemy team is “10 points”), the appearance control unit 35 shifts the appearance position of this predetermined neutral character to the ally headquarter 302 side by a distance corresponding to the score difference (for example, the appearance position is shifted to the ally headquarter 302 side by a distance corresponding to 90% of a linear distance from the ally headquarter 302 to the enemy headquarter 304). In other words, the appearance control unit 35 can increase the distance by which the appearance position is shifted as the score difference becomes larger. In accordance with this, a player belonging to a team having a smaller obtained score can increase a chance for blowing down this predetermined neutral character on a side close to the base of the opponent team using his or her player character and a chance for quickly scoring points (in other words, a time until a player character of the player having points reaches a base of the opponent and scores the points can be shortened).

[Example of Non-Display of Total Score During Game]

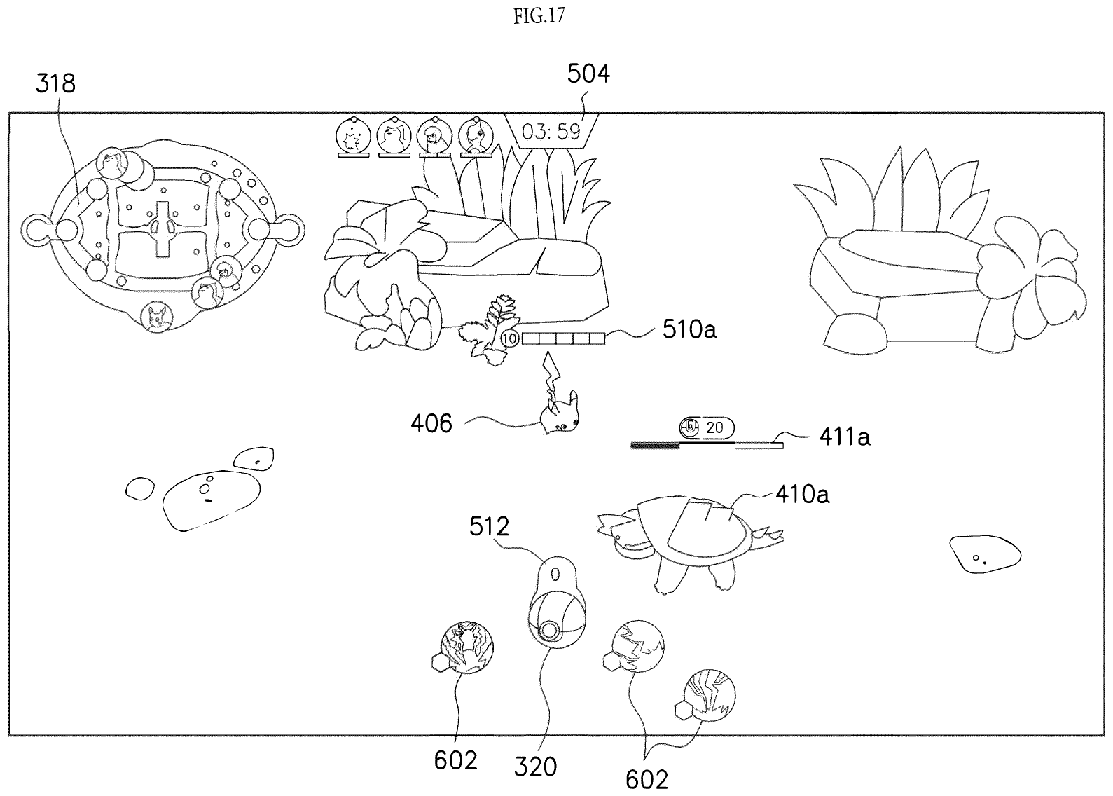

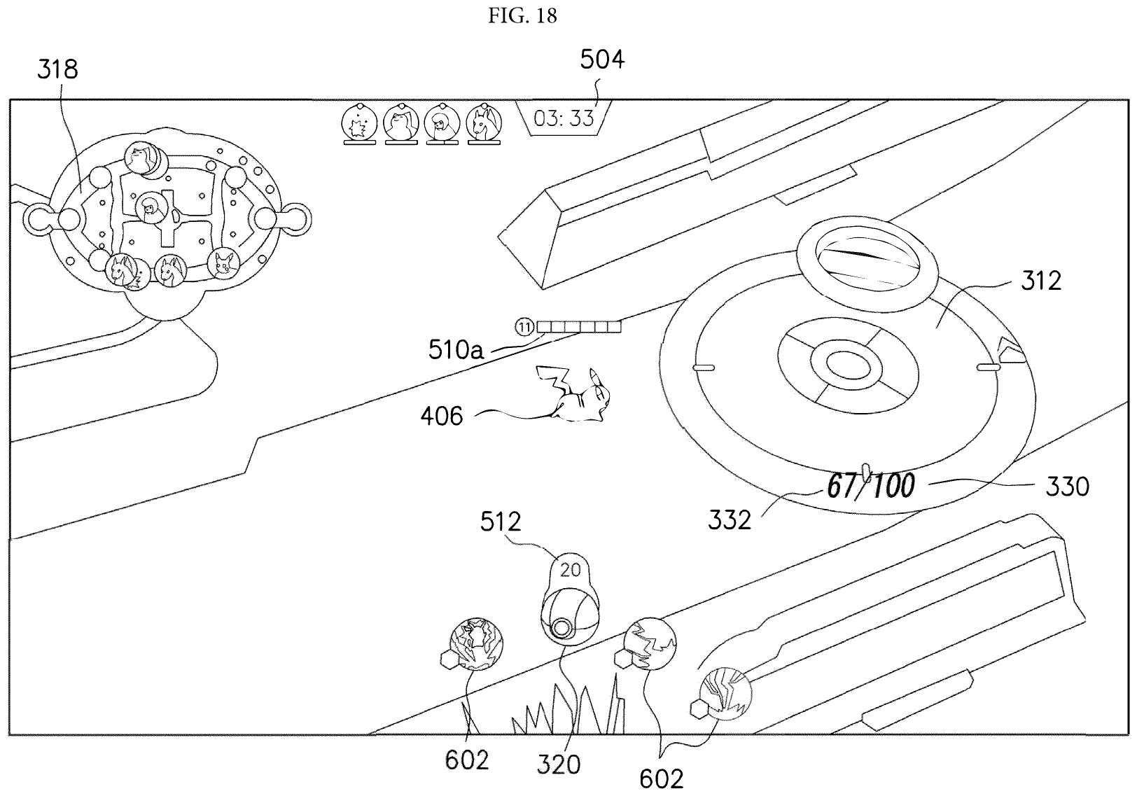

FIGS. 17 and 18 illustrate examples of an display overview of the display unit in the game system according to an exemplary embodiment. In the game system 1 according to the example illustrated in FIG. 17, the display unit 10 have functions and components that are approximately the same as those described above except that the ally team score 500, the enemy team score 502, and the player score 506 are not displayed, and thus detailed description other than different points will be omitted.

More specifically, in the description presented above, an example in which the display unit 10 displays scores of the ally team score 500, the enemy team score 502, and the player score 506 in predetermined areas together with the entire view 318, the character storage area 320, and the point display 512 (displaying points owned by the player of the player character 406), the technique generation area 602, the remaining game time 504, and the like displayed near the character storage area 320 has been described. On the other hand, FIG. 17 illustrates an example in which the display unit 10 does not display the ally team score 500, the enemy team score 502, and the player score 506 during a game according to an exemplary embodiment.

On the other hand, the display unit 10 displays the remaining game time 504 that is a remaining time of the game near an upper center of the display unit 10 and does not display a sum value of scores of each of the ally team and the enemy team and a score obtained by the player character 406 during execution of the game. In addition, in the example illustrated in FIG. 17, the player character 406 and a neutral character 410a are displayed. Furthermore, a status 510a of the player character 406 is displayed near the player character 406 (the level of the player character 406 being “10” and the like are displayed), and a status 411a of the neutral character 410a is displayed near the neutral character 410a (the neutral character 410a having 20 points is displayed).

Here, in a case in which the player character 406 has won a fight against the neutral character 410a, the point assignment control unit 62 assigns points associated with the neutral character 410a to the player of the player character 406. Then, the display control unit 15 displays a total of points obtained by the player of the player character 406 in the point display 512 by controlling the display unit 10. In the example illustrated in FIG. 17, a total of points owned by the player of the player character 406 before blowing down the neutral character 410a is “0”, and thus the point display 512 represents “0”, and in a case in which the neutral character 410a has been blown down, the point display 512 is changed to “20”.

FIG. 18 will be referred to. FIG. 18 illustrates an example in which an endurance value and a remaining endurance value of a base are displayed in the base of each team.

First, the display control unit 15 causes the display unit 10 to display an endurance value 330 set to each base (that is, each of ally bases and enemy bases) near each base. In the example illustrated in FIG. 18, the endurance value 330 (the endurance value “100” in the example illustrated in FIG. 18) is displayed near the enemy base 312 (near a lower side of the enemy base 312 in the display unit 10). Furthermore, the display control unit 15 causes the display unit 10 to display a value acquired by subtracting a sum value of supply values accumulated in each base from the endurance value 330 (hereinafter, referred to as a “remaining endurance value 332”) together with the endurance value 330. In the example illustrated in FIG. 18, “67” is displayed as the remaining endurance value 332 near the enemy base 312 (in other words, “33” points have been supplied in advance and are scored). The display control unit 15 causes the display unit 10 to display the remaining endurance value 332 and the endurance value 330 while updating them in real time for each of all the bases of the inside of the play field 300. In other words, the display control unit 15 causes the display unit 10 to display the endurance value 330 and the remaining endurance value 332 of each base, for example, in the form of “a/b” (here, a is the remaining endurance value 332, and b is the endurance value 330) near the base. Every time the value of the remaining endurance value 332 changes, the display unit 10 displays the value after the change in real time.

In addition, in the example illustrated in FIG. 18, the player of the player character 406 owns points of 20 points (the display of the point display 512 is “20”). In this state, in a case in which the player character 406 is positioned within a predetermined range from the enemy base 312, and a predetermined operation (for example, a predetermined input operation executed by the player of the player character 406 within this predetermined range) is executed, points owned by the player of the player character 406 are supplied to the enemy base 312 and are accumulated in the enemy base 312, and these points are scored. Then, the display control unit 15 causes the display unit 10 to subtract a supply value corresponding to the score from the remaining endurance value 332 of the enemy base 312 and update the display of the remaining endurance value 332. In the example illustrated in FIG. 18, in a case in which points owned by the player of the player character 406 are scored in the enemy base 312, a supply value corresponding to “20” points are accumulated in the enemy base 312, and thus the display unit 10 updates the display of the remaining endurance value 332 from “67” to “47”. In this case, a score corresponding to “20” points (for example, “20 points”) are added to the score of the ally team in an internal process of the game system 1.

In addition, the display control unit 15 can cause the display unit 10 to display the endurance value 330 and the remaining endurance value 332 of each base in one place near each of bases (the ally base 310 and enemy base 312) present in the play field 300. Thus, it is possible for a player accustomed to game play (for example, a person with advanced skills) to calculate a total of scores of a team to which he or she belongs and a total of scores of the opponent team at a perception time point by perceiving the endurance value 330 and the remaining endurance value 332 of each base and then totaling values acquired by subtracting the remaining endurance value 332 from the endurance value 330 of each base that have been perceived. However, in the game system 1, a total of scores of each team is not displayed in the display unit 10 during a game.

[Example of Display of Fight Result]

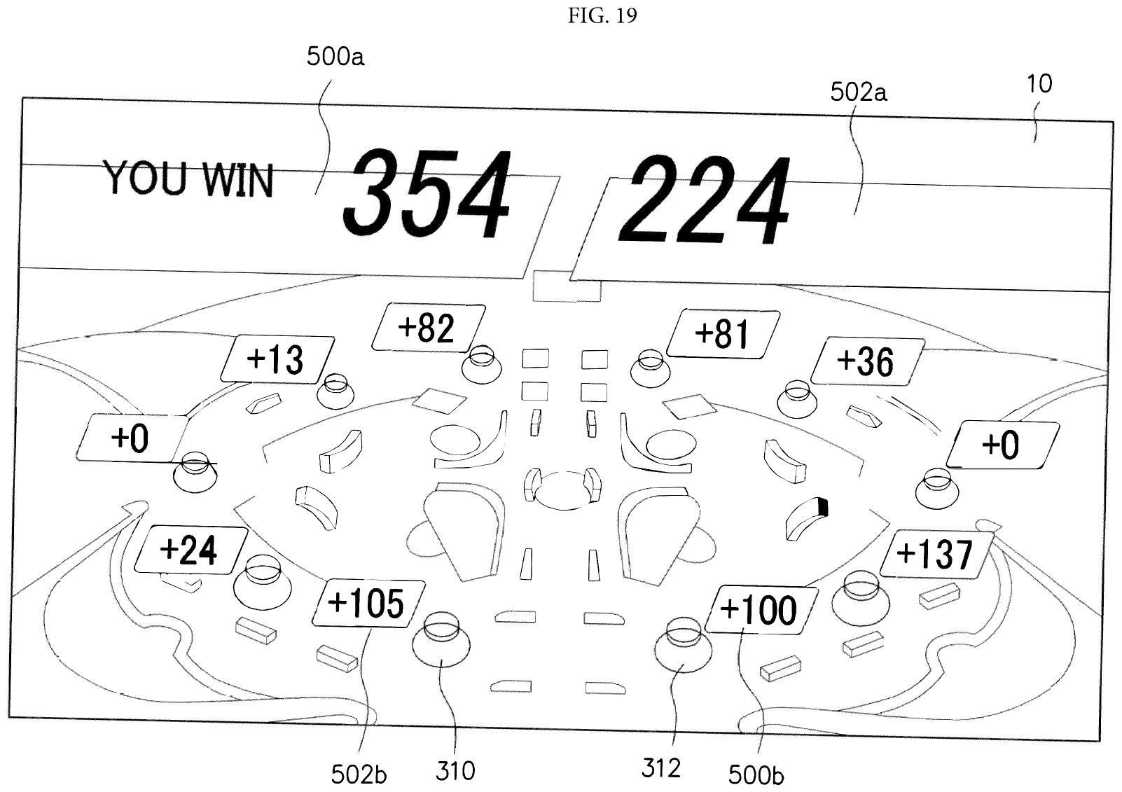

FIGS. 19 to 22 illustrate one example of an overview of display of a fight result in the game system according to an exemplary embodiment.

The display control unit 15, after execution of a game (after the game ends), enables the display unit 10 to display a total score of the ally team and a total score of the enemy team, a score progress of each of one or more player characters belonging to the ally team and the enemy team, and furthermore fight results, and the like. In other words, before a victory/defeat is determined by the victory/defeat determining unit 85, the display control unit 15 does not cause the display unit 10 to display a total of scores of the ally team and a total of scores of the enemy team. On the other hand, after a victory or defeat is determined by the victory/defeat determining unit 85, the display control unit 15 causes the display unit 10 to display a total of scores of the ally team and a total of scores of the enemy team and causes the display unit 10 to display a score progress of each of one or more player characters belonging to the ally team. The display control unit 15 enables the display unit 10 to display a fight result, a total score and a score progress of each team, a score scored for each base, and/or a scoring progress of each player character after end of the game on the basis of the information stored in the team information storage unit 252 and the player information storage unit 254 and/or results of determination of a victory or defeat acquired by the victory/defeat determining unit 85, and information from the scoring unit 70 used in a case in which the victory/defeat determining unit 85 determine a victory or defeat. In accordance with this, in the game system 1, after the end of a game, each player can perceive a victory/defeat of the game, the quantity of scores acquired by a certain player character at a certain timing, and the like.

For example, as illustrated in FIG. 19, the display control unit 15, after execution of a game, displays an ally team score 500a that is a total of scores of the ally team and an enemy team score 502a that is a total of scores of the enemy team in an upper side of the display unit 10. In this case, the display control unit 15 causes the display unit 10 to display information representing a victory (for example, a text such as “YOU WIN”, a diagram, or the like) representing a victory near the total of scores of the team that has won the fight. In addition, the display control unit 15 may cause the display unit 10 to display a score scored by each team in each base as well. For example, the display unit 10 displays each base ally score 500b that is a score scored by the ally team in each enemy base 312 near each enemy base 312 (in the example illustrated in FIG. 19, a score “+100” is displayed as the base ally score 500b in the enemy base 312 disposed in the lowest right side of the display unit 10). Similarly, the display unit 10 displays each base enemy-side score 502b that is a score scored by the enemy team in each ally base 310 near each ally base 310 (in the example illustrated in FIG. 19, a score “+105” is displayed as the base enemy-side score 502b in the ally base 310 disposed in the lowest left side of the display unit 10).

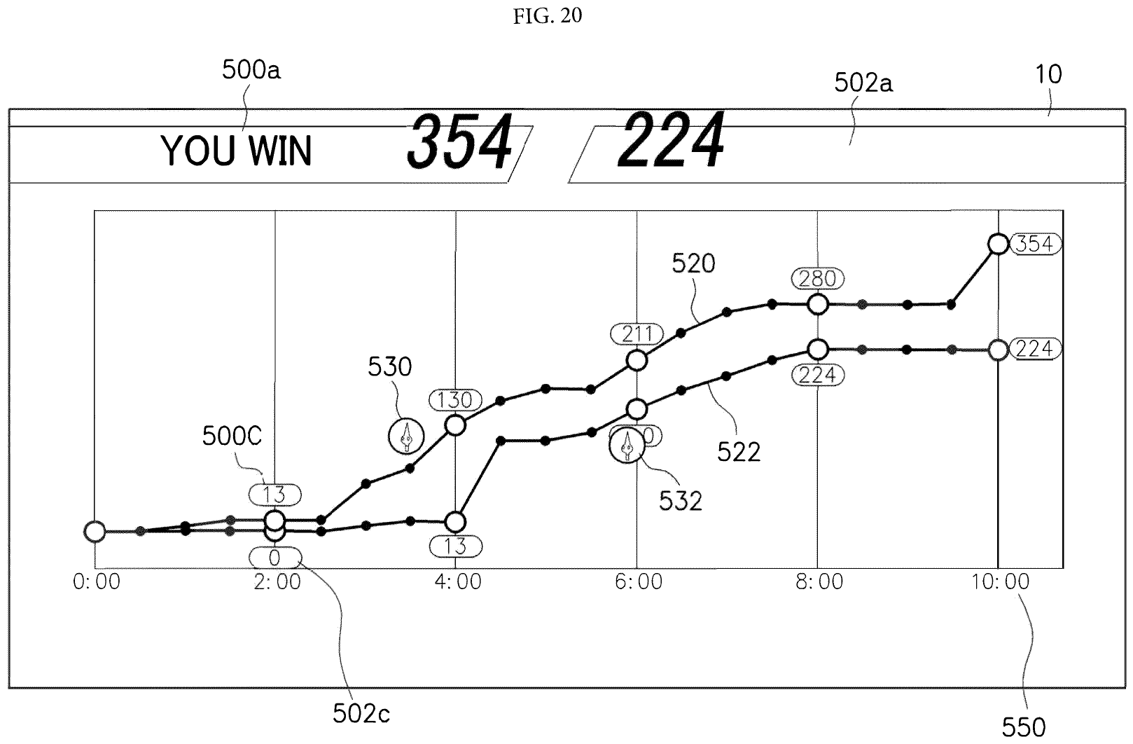

In addition, as illustrated in FIG. 20, the display control unit 15, after execution of a game, also can display graphs of total scores of the ally team and the enemy team. For example, the display control unit 15 causes the display unit 10 to display a total graph 520 of scores (that is, scores acquired by scoring points) obtained by the ally team and a total graph 522 of scores obtained by the enemy team. FIG. 20 illustrates an example in which a score of a certain degree having been obtained at a certain timing of the progress time of the game by each team along a time axis 550 (a time axis representing elapse of time from start of the game to the end) is displayed in the display unit 10. In addition, the display control unit 15 may cause the display unit 10 to display a total score of each team at this timing time point together with the total graph of each team for every predetermined timing. For example, in FIG. 20, a total score at this timing time point is displayed for every predetermined timing (for example, it is illustrated that, at a time point of “2:00” minutes of the total graph 520, the ally team makes a score “13” (total score 500c), and the enemy team is maintained to have “0” score (total score 502c)).

Furthermore, in a case in which points associated with a special character are acquired by a player of a player character in accordance with this player character having won a fight against the special character or the like, the display control unit 15 causes the display unit 10 to display a score progress including a predetermined mark at the time point of the winning. In the example illustrated in FIG. 20, a certain player character of the ally team wins over the special character, a mark 530 is displayed at a time point at which points owned by this special character are acquired by the player of this player character (before 4 minutes in the time axis 550), a certain player character of the enemy team wins over the special character, and a mark 532 is displayed at a time point at which points owned by this special character are acquired by this player character (about 6 minutes in the time axis 550).

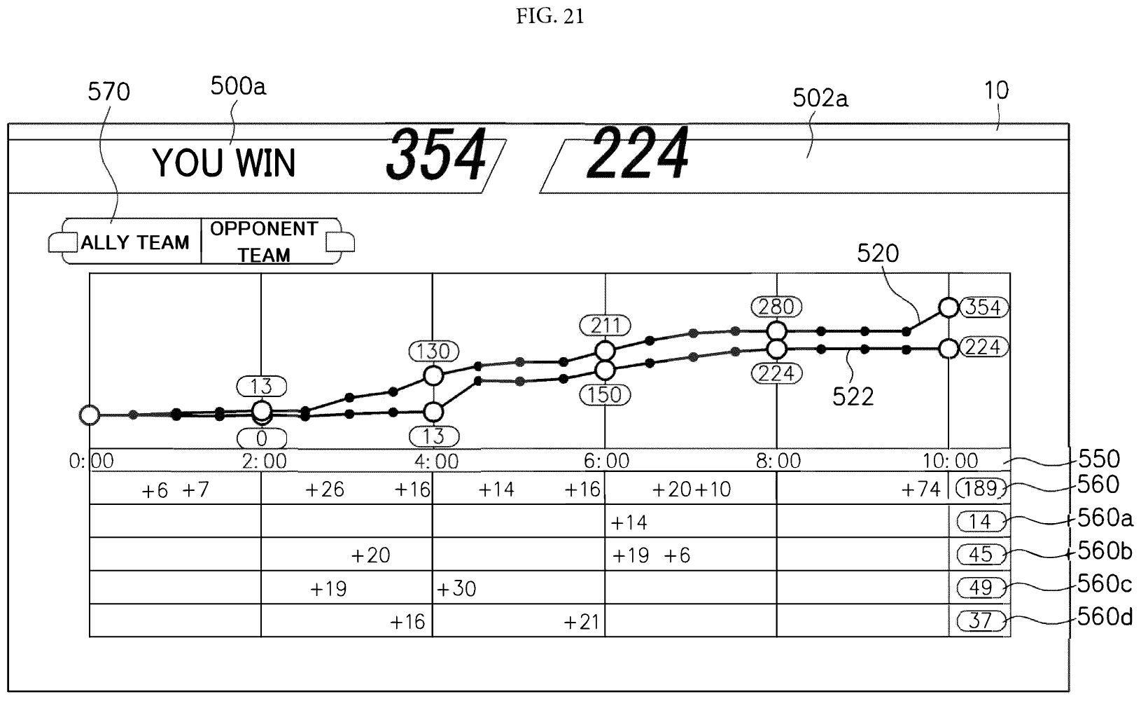

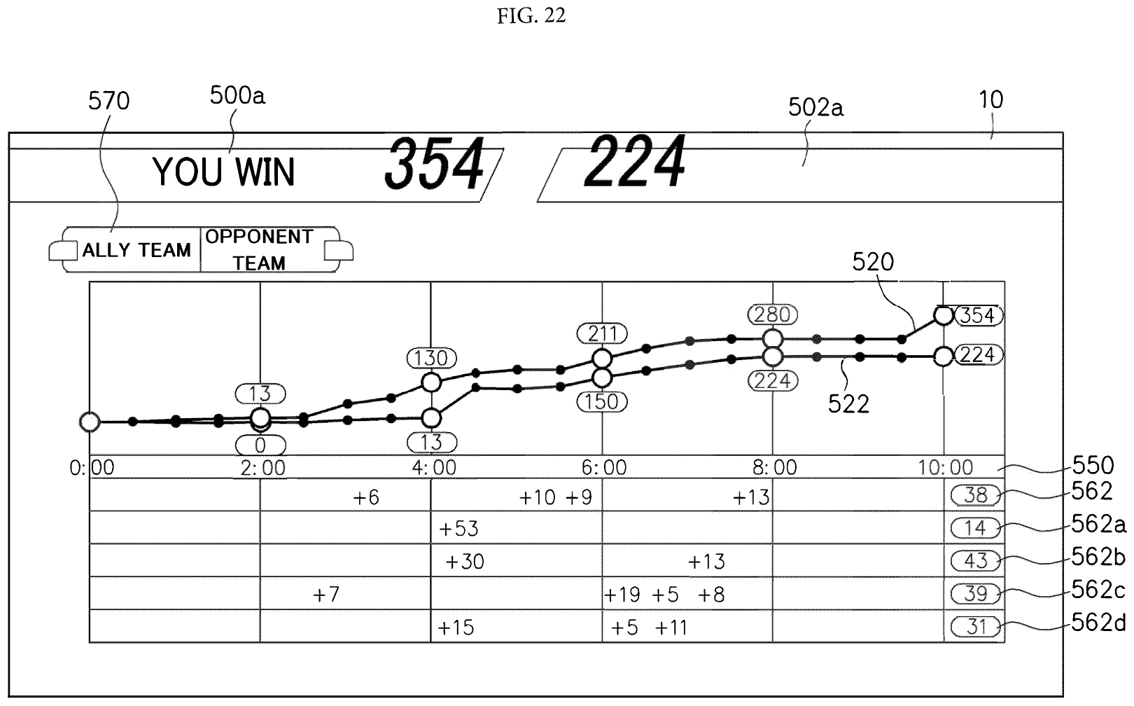

In addition, as illustrated in FIGS. 21 and 22, the display control unit 15 can cause the display unit 10 to display a score obtained by each of one or more player characters belonging to each team as a graph or a table including a timing at which each score has been obtained for each team.

For example, as illustrated in FIG. 21, the display control unit 15 causes the display unit 10 to display a score obtained by each player character operated by each player belonging to the ally team in a time series in the form of a table. In the example illustrated in FIG. 21, under a total graph 520 and a total graph 522, a score progress of each of player characters belonging to the ally team is displayed. For example, in order from the top, an ally player character score progress 560, an ally player character score progress 560a, an ally player character score progress 560b, an ally player character score progress 560c, and an ally player character score progress 560d are displayed. In each ally player character score progress, along a time axis 550, a timing at which each player character makes a score (a timing at which points are scored) and a score obtained at each timing are displayed. As one example, by referring to the ally player character score progress 560 of one player character of the ally team, it is illustrated that scores “+6” and “+7” are obtained by one player character in this order before 2 minutes have elapsed from the start of the game, scores “+26” and “+16” are obtained in this order from 2 minutes to elapse of 4 minutes, scores “+14” and “+16” are obtained in this order from 4 minutes to elapse of 6 minutes, scores “+20” and “+10” are obtained in this order from 6 minutes before elapse of 8 minutes, and a score “+74” is obtained immediately before a game end time point (10 minutes from the start of the game). This similarly applies also to other player characters.

In the example illustrated in FIG. 21, for example, a player character corresponding to the ally player character score progress 560a has not obtained a score from a first half to a middle stage of the game (until elapse of 6 minutes from start of the game) and has obtained a score in a second half of the game (after elapse of 6 minutes from start of the game). On the other hand, a player character corresponding to the ally player character score progress 560c has obtained a score from the first half to the middle stage of the game and has not obtained a score in the second half of the game. In this way, in accordance with the display control unit 15 displaying a score progress of each player character in the display unit 10, it can be perceived whether or not the score can be easily obtained by a player or a player character in any one of the first half, the middle stage, and/or the second half of the game.

In addition, the display control unit 15 also can cause the display unit 10 to perform switching display between the score progress of each player character of the ally team and the score progress of each player character of the enemy team using a switching tap 570. For example, in a case in which the input unit 20 receives an input operation (for example, a designation operation) of a player for “opponent team” of the switching tap 570 illustrated in FIG. 21, the display control unit 15, as illustrated in FIG. 22, causes the display unit 10 to display a table representing a score progress of each player character of the “opponent team”, that is, the enemy team. In this case, similar to the description presented with reference to FIG. 21, the display unit 10 displays a score progress of each player character belonging to the enemy team below the total graph 520 and the total graph 522. For example, in order from the top, the enemy player character score progress 562, the enemy player character score progress 562a, the enemy player character score progress 562b, the enemy player character score progress 562c, and the enemy player character score progress 562d are displayed. A method for analyzing a graph and a table illustrated in FIG. 22 is similar to that illustrated in FIG. 21. In addition, the types of graphs and tables are not limited to the examples illustrated in FIGS. 20 to 22, and graphs and tables of different forms such as a bar graph, a circle graph, and the like may be used.

### Modified Example

In the game system 1 according to an exemplary embodiment, in a case in which a player character blows down a neutral character, points owned by the neutral character are acquired by a player of the player character. On the other hand, in a modified example, a neutral character may have a predetermined item. In this case, in a case in which a player character blows down the neutral character, the player character acquires this predetermined item. Then, by providing this predetermined item for a base of the opponent from the player character, a score may be assigned to a team to which this player character belongs on the basis of the provided item.

### Modified Example 2

The game system 1 according to an exemplary embodiment can determine display/non-display of a total of the score of each team in the display unit 10 for each phase by dividing one fighting game into a plurality of phases. In other words, before victory/defeat is determined by the victory/defeat determining unit 85, the display unit 10 is caused to display totals of scores of the ally team and the enemy team in at least some phases among a plurality of phases, the display unit 10 is caused not to display totals of the scores of the ally team and the enemy team in the remaining phases (displayed totals are removed), and, after a victory or a defeat is determined by the victory/defeat determining unit 85, the display unit 10 is caused to display totals of the scores of the ally team and the enemy team, and the display unit 10 is caused to display a score progress of each of one or more player characters belonging to the ally team.

For example, one fighting game is divided into n (here, n is an integer equal to or greater than 1) phases, a phase including a game start time can be set as a first phase, and a phase including a game end time can be set as an n-th phase. The phases progress in order of the first phase, a second phase, a third phase, . . . , an n-th phase. In this case, the display control unit 15 causes the display unit 10 to display totals of the scores of the ally team and enemy team in the first phase to the x-th phase (here, x is an integer equal to or greater than 2 and is equal to or less than n). Then, in an (x+1)-th phase (here, x+1 n) following the x phase and thereafter, the display control unit 15 causes the display unit 10 not to display totals of the scores of the ally team and the enemy team.

For example, in a case in which one fighting game is divided into a first phase that is a first half of the game and a second phase that is a second half of the game, the display control unit 15 can cause the display unit 10 to display totals of the scores of the ally team and the enemy team in the first phase and cause the display unit 10 not to display the totals of the scores of the ally team and the enemy team in the second phase. In accordance with this, by allowing a player of each team to perceive a total score of each team in the first half of the game and not allowing the player not to perceive a total score in the second half of the game, the game system 1 can maintain desire of each player for the game.

In addition, lengths of the phases may be the same or different from each other. For example, in a case in which one fighting game is divided into the first phase and the second phase as described above and in a case in which a length of one game is 15 minutes, the length of the first phase can be set to one minutes, and the length of the second phase can be set to the remaining 14 minutes. In accordance with this, a phase in which total scores can be perceived can be restrictively set in an initial phase of the game, and thus, even in a case in which there is a large difference between scores of teams in a final stage from a middle stage of the game, it can be made difficult for players to perceive the large difference. As a result, desire of each player for a game can be suppressed from being reduced until the final stage of the game.

In addition, in a case in which one fighting game is divided into n phases, the display control unit 15 may cause the display unit 10 to display totals of the scores of the ally team and the enemy team in an a-th phase (here, a is an odd number) and cause the display unit 10 not to display the totals of the scores of the ally team and the enemy team in a b-th phase (here, b is an even number).

[Modified Example of Example of Fighting Game and Display of a Fighting Result]

The game system 1 also can cause other information terminals and/or display devices to display details of a game through the communication network 5 in addition to the information terminals of players. The other information terminals and/or display devices (hereinafter, simply referred to as “other devices”), for example, are other devices to which details of a game fight are delivered, a terminal used by an observer observing event details in an e-sports event or the like, other devices such as a large vision device and the like and/or other devices of a live-caster performing live-casting a game fight and commentator commenting a fight. All the other devices have display units.

In this case, the display control unit 15 causes display units of one or more other devices to display details (of at least some or all of the game that is, 1) game pre-preparation process, 2) matching process, 3) game start and execution process, and 4) fight result display process). More specifically, the display control unit 15 can control whether or not the display unit is caused to display a total score of the ally team and a total score of the enemy team, a score progress and/or a fight result, and the like of each of one or more player characters belonging to the ally team and the enemy team regardless of presence/absence of determination of a success/defeat acquired by the victory/defeat determining unit 85 for each type of other devices.

For example, the display control unit 15 controls display in the display units of other devices as follows.
a) Case in which other devices are information terminals of a live-caster and a commentator of a game (hereinafter, referred to as a “live/commentary terminal”) and the like

The display control unit 15 displays totals of scores of the ally team and the enemy team in the display unit of the live/commentary terminal also before a victory or a defeat is determined by the victory/defeat determining unit 85. In addition, the display control unit 15 displays a score progress of each of one or more player characters belonging to each team in real-time also before a victory or a defeat is determined by the victory/defeat determining unit 85. In accordance with this, a live-caster or a commentator can easily perform live-casing or game commenting that is appropriate to the progress of the game.
b) Case in which other devices are an information terminal or a large vision device (hereinafter, referred to as an “observer terminal”) of an observer of a game

The display control unit 15 may be configured to cause the display unit of the observer terminal not to display totals of scores of the ally team and the enemy team even before a victory or a defeat is determined by the victory/defeat determining unit 85. Here, the display control unit 15 can cause the display unit of the observer terminal to display totals of scores of the ally team and the enemy team also before a victory or a defeat is determined by the victory/defeat determining unit 85 in accordance with a display instruction from a sponsor or the like of the game (for example, an administrator of a game championship or the like). In addition, the display control unit 15 may display a score progress of each of one or more player characters belonging to each team in real-time in the display unit of an observer terminal in accordance with this display instruction even before a victory or a defeat is determined by the victory/defeat determining unit 85. The display control unit 15 removes totals of scores of the ally team and the enemy team and/or a score progress of each of one or more player characters belonging to each team from the display unit of the observer terminal in accordance with a removal instruction from a sponsor or the like of the game. In addition, this display instruction may be made before start of a game or in the middle of execution of a game, and a subject of a display instruction received by the display control unit 15 may be a sponsor of the game or a live-caster or a commentator of the game. In accordance with this, for example, a commentator of a game comments while allowing game watchers to view a current state such as scores of the game, and the display is removed again after the end of the commentary, whereby the game system 1 can realize smooth game live-casting.

[Flow of Processing of Game System 1]

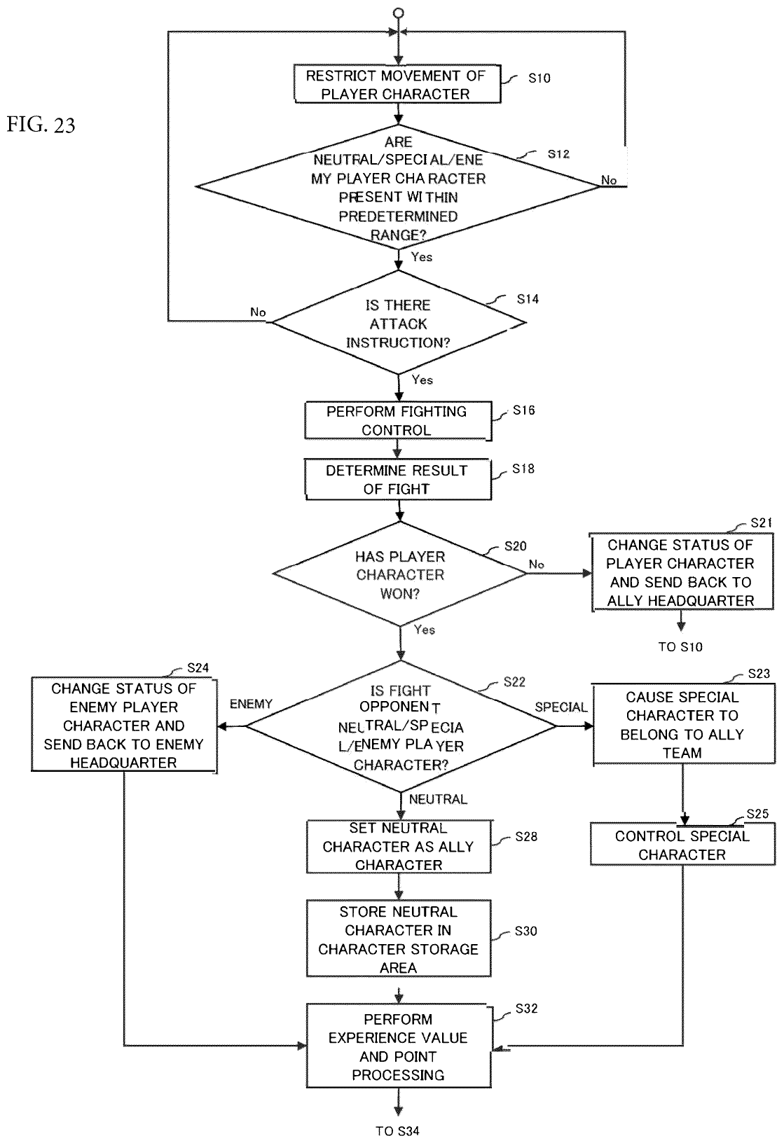

FIGS. 23 to 26 illustrates an example of a flow of processing performed in the game system according to an exemplary embodiment.

First, at the time of starting a game in the game system 1, one or more players belonging to one team (an ally team) select their player characters (ally player characters), and one or more other players belonging to the other team (an enemy team) also select their player characters (enemy player characters). Hereinafter, one player of the ally team will be described as a subject.

As illustrated in FIG. 23, after a game is started, the character operation control unit 30 controls movement of a player character of a player in a play field 300 in accordance with an instruction from this player that is received through the input unit 20 (Step 10; hereinafter a step will be represented as “S”.). In this way, the player character moves a lane 306, a neutral area 314, a center part 316, or the like of the play field 300. Then, in a case in which a neutral character, a special character, or an enemy player character (hereinafter, referred to as a “target character”) is present inside a virtual circular area having a predetermined radius having the player character as its center (hereinafter, this will be referred to as an attack possible area) (Yes in S12), while the character operation control unit 30 executing movement control of a player character, the fighting control unit 40 determines presence/absence of an attack instruction from a player that is received through the input unit 20 (S14). On the other hand, in a case in which a target character is not present within an attack possible range (No in S12), the character operation control unit 30 continuously executes control of movement of the player character (S10). In addition, also in a case in which the fighting control unit 40 does not receive an attack instruction from the player through the input unit 20 (No in S14), the character operation control unit 30 continuously executes control of the movement of the player character (S10).

In a case in which the fighting control unit 40 has received an attack instruction from a player through the input unit 20 (Yes in S14), the fighting control unit 40 controls a fight between a player character and a target character within the attack possible range (S16). The fighting control unit 40 supplies information representing changes of the statuses of both characters generated in accordance with a fight between the player character and the target character to the fighting result determining unit 45. The fighting result determining unit 45 determines which one out of both the characters has won the fight on the basis of the information received from the fighting control unit 40 (S18). In a case in which the fighting result determining unit 45 determines that the player character has won over the target character (Yes in S20), a process according to the type of target character is execute (S22).

(Case in which Player Character has Won Target Character)

First, in a case in which the target character is a neutral character (“neutral” in S22), by associating the neutral character with a player, the character state determining unit 50 sets the neutral character as an ally character of the player character (S28). In other words, the character state determining unit 50 associates a character ID of this neutral character with a player ID. Then, the character state determining unit 50 removes display of the neutral character from the play field 300 and stores this neutral character in the character storage area as an ally character (S30). In this case, an image (that is, an icon) of the stored ally character is displayed in contact with or near the character storage area. In addition, the experience value assigning unit 60 assigns a predetermined experience value based on blowing-down of the neutral character to the player character, and the point assignment control unit 62 assigns points associated with the neutral character in advance to the player (S32).

In addition, in a case in which the target character is an enemy player character (“enemy” in S22), the character state determining unit 50 applies a change to the status of the enemy player character (for example, the HP that has become zero in accordance with being defeated by the player character is returned to full in a predetermined time) and sends back the enemy player character to the enemy headquarter 304 (S24). In addition, the character state determining unit 50 prohibits an operation on the enemy player character until the enemy player character is sent back to the enemy headquarter 304 from a time point at which it is defeated. Then, the experience value assigning unit 60 assigns a predetermined experience value based on blowing-down of the enemy player character to the player character, and the point assignment control unit 62 assigns a predetermined point based on blowing-down of the enemy player character to the player (S32).

In addition, in a case in which the target character is a special character (“special” in S22), the character state determining unit 50 causes the special character to belong to the ally team to which the player belongs (S23). In other words, the character state determining unit 50 associates a character ID of this special character with a team ID of the ally team. In addition, differently from the neutral character, the character state determining unit 50 does not store the special character in the character state area and maintains the special character to appear in the play field 300. Then, the special character control unit 57 causes the special character to execute a predetermined operation according to a type of special character by controlling the special character (S25). In addition, the experience value assigning unit 60 assigns a predetermined experience value based on blowing-down of the special character to the player character. In addition, the point assignment control unit 62 may not assign a predetermined point based on blowing-down of the special player character to the player (S32).

(Case in which Player Character is Defeated by Target Character)

On the other hand, in a case in which the player character is defeated in a fight against the target character (No in S20), the character state determining unit 50 applies a change to the status of the player character (for example, the HP that has become zero in accordance with being defeated by the target character is returned to full in a predetermined time) and sends back the player character to the ally headquarter 302. In addition, the character state determining unit 50 prohibits an operation on the player character until the player character is sent back to the ally headquarter 302 from a time point at which it is defeated. After the player character is returned to the ally headquarter 302, Step from S10 is executed again.

(Control of Ally Character)

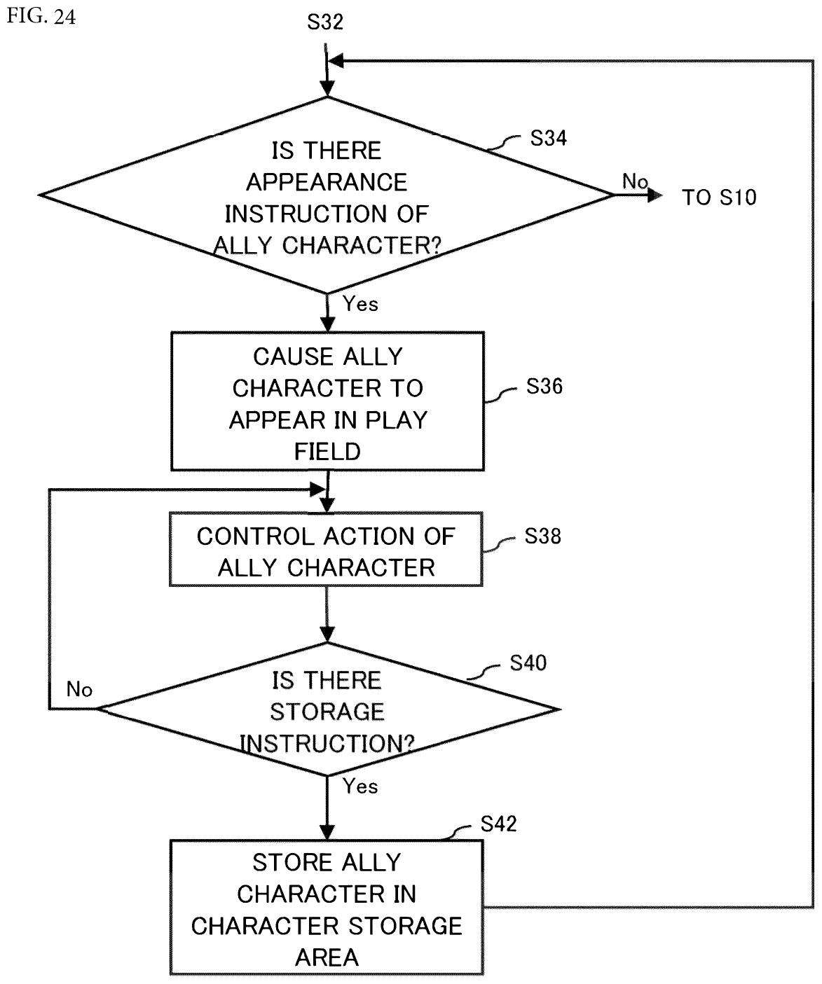

Subsequently, FIG. 24 illustrates a control flow of an ally character. First, in a state in which the ally character is stored in the character storage area, the ally character control unit 55 determines presence/absence of an appearance instruction for the ally character in the play field 300 from a player through the input unit 20 (S34). In a case in which there is no appearance instruction (No in S34), Step from S10 is executed. On the other hand, in a case in which there is an appearance instruction (Yes in S34), the ally character control unit 55 causes the ally character to appear from the character storage area in the play field 300 (S36). Here, the character storage area, for example, can be displayed to have a ball shape, a closed ball state is displayed in a case in which the ally character is stored, and an open ball state is displayed in a case in which the ally character comes out.

Then, the ally character control unit 55 controls an action of the ally character that has appeared in the play field 300 (S38). More specifically, the ally character control unit 55 moves the ally character to follow the player character. In addition, in a case in which an enemy player character, another neutral character, and/or a special character are present within a predetermined range from the player character or the enemy player character, the ally character control unit 55 causes the ally character to automatically execute an attack on the enemy player character, another neutral character, and/or a special character.

Subsequently, in a case in which an instruction for storing the ally character in the character storage area has been received from the player through the input unit 20 (Yes in S40), the ally character control unit 55 stores the ally character appearing in the play field 300 in the character storage area and removes display of the ally character from the play field 300 (S42). Then, Step S34 and subsequent steps are executed. On the other hand, in a case in which the ally character control unit 55 has not received an instruction for storing the ally character in the character storage area from the player through the input unit 20 (No in S40), Step S38 and subsequent steps are executed.

(Control of Case in which New Neutral Character is Obtained)

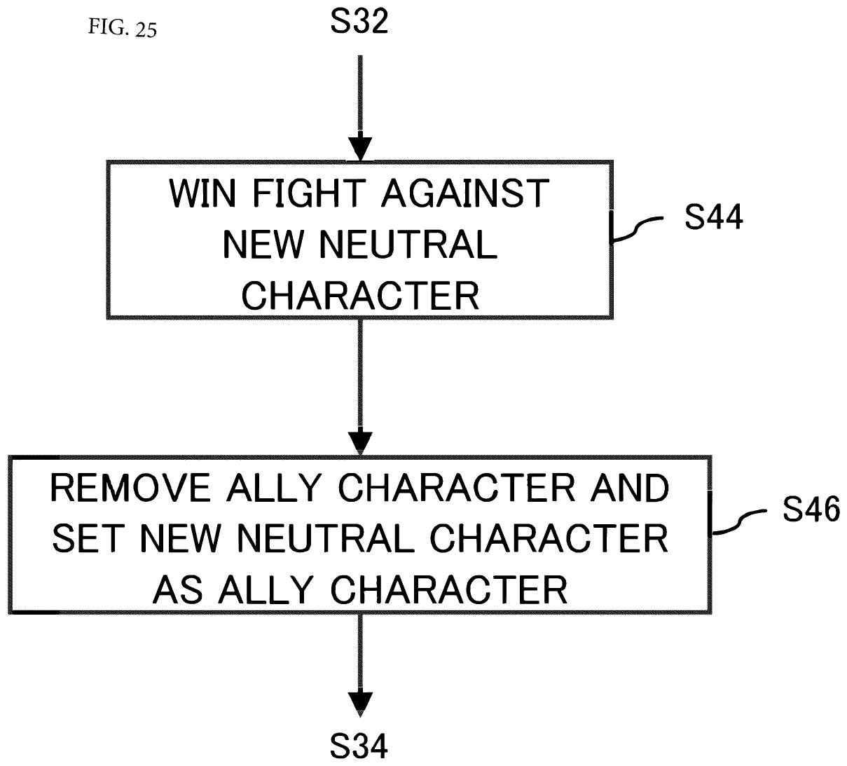

FIG. 25 illustrates a control flow of a case in which a player character fights against a new neutral character. In a case in which the player character owns an ally character, in a case in which the player character fights against and a new neutral character and wins over the new neutral character (S44), the character state determining unit 50 sets this new neutral character as a new ally character (S46). Then, the character state determining unit 50 removes the ally character stored in the character storage area or the ally character appearing in the play field 300 and stores the new neutral character in the character storage area as an ally character. Then, Step S34 and subsequent steps are executed.

(Control of Scoring Process)

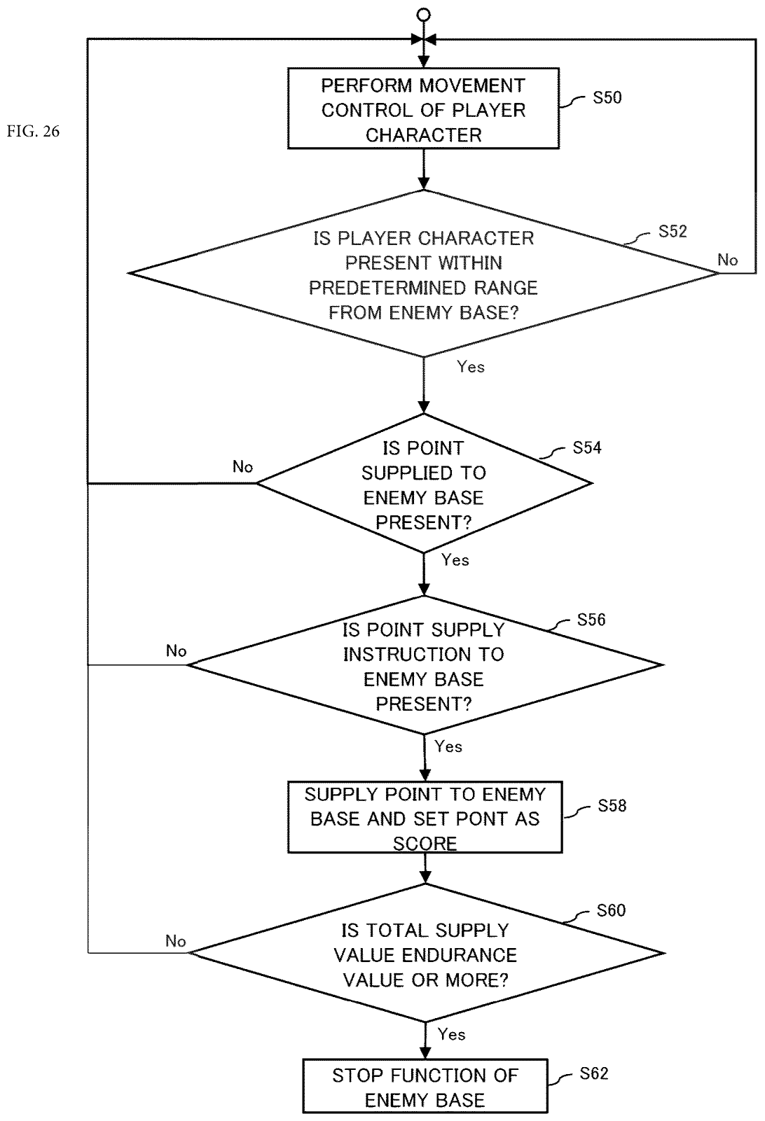

Next, FIG. 26 illustrates a control flow of a point scoring process. First, the character operation control unit 30 controls movement of the player character (belonging to the ally team) in the play field 300 in accordance with an instruction from a player that has been received through the input unit 20 (S50). Then, the scoring unit 70 determines whether or not the player character is present within a predetermined range from the enemy base 312 (S52). In a case in which the player character is not present within the predetermined range from the enemy base 312 (No in S52), Step S50 and subsequent steps are executed.

On the other hand, in a case in which the player character is present within the predetermined range from the enemy base 312 (Yes in S52), the scoring unit 70 determines whether or not a player of the player character has points (S54). In a case in which this player does not have points (No in S54), Step S50 and subsequent steps are executed. In a case in which this player has points (Yes in S54), the scoring unit 70 determines whether or not there is an instruction for supplying points to the enemy base 312 from the player through the input unit 20 (S56). In a case in which there is no instruction for supplying points from the player (No in S56), Step S50 and subsequent steps are executed.

On the other hand, in a case in which there is an instruction for supplying points from the player (Yes in S56), the scoring unit 70 supplies the points owned by the player to the enemy base 312 and converts the points into a score of the ally team. The scoring unit 70 can set a numerical value of the points as a score as it is or can set a value acquired by multiplying the points by a predetermined coefficient determined in accordance with a remaining time of the game as a score. In addition, the scoring unit 70 supplies a supply value corresponding to this score or points to the enemy base 312 and accumulates the supply value in the enemy base 312 (S58). For example, the scoring unit 70 can set a numerical value of the points as a supply value as it is or can set a value acquired by multiplying the points by a predetermined coefficient determined in accordance with a remaining time of the game as a supply value.

Then, the base control unit 80 compares a sum value of supply values accumulated in the enemy base 312 by the scoring unit 70 with an endurance value set in the enemy base 312 in advance (S60). Here, the sum value of supply values is a sum value of a supply value corresponding to points supplied to the enemy base 312 by one player character and a supply value corresponding to points supplied to this enemy base 312 by another player character of the same team as the one player character. In a case in which the base control unit 80 determines that the sum value of supply values is less than the endurance value (No in S60), Step S50 and subsequent steps are executed. On the other hand, in a case in which the base control unit 80 determines that the sum value of supply values is equal to or greater than the endurance value (Yes in S60), the base control unit 80 stops the function of the enemy base 312 (S62). Then, the victory/defeat determining unit 85 ends the game at a time point at which a game time set in advance has elapsed and determines a victory/defeat of the game using scores of the teams at the end time point.

[Game Program]

Each of the constituent components included in the game system 1 according to an exemplary embodiment shown in FIGS. 1 to 26 can be realized by having a calculation processing device such as a central processing unit (CPU) execute a program (in other words, a game program), or in other words by means of processing executed using software. Alternatively, the constituent components can be realized by writing the program into hardware serving as an electronic component, such as an integrated circuit (IC), in advance. Note that software and hardware can also be used in combination.

The game program according to an exemplary embodiment can be incorporated into an IC, a ROM, or the like in advance, for example. In addition, the game program can be recorded as a file with an installable format or an executable format in a computer-readable recording medium such as a magnetic recording medium, an optical recording medium, or a semiconductor recording medium to be provided as a computer program. The recording medium storing the program may be a non-transitory recording medium such as a CD-ROM or a DVD. Furthermore, the game program can be stored in advance in a computer connected to a communication network such as the Internet, and can be provided by being downloaded through the communication network.

A game program according to an exemplary embodiment, by using a CPU or the like, a game program is caused to function as the display unit 10, the display control unit 15, the input unit 20, the storage unit 25, the character operation control unit 30, the appearance control unit 35, the fighting control unit 40, the fighting result determining unit 45, the character state determining unit 50, the ally character control unit 55, the special character control unit 57, the experience value assigning unit 60, a point assignment control unit 62, the evolution control unit 64, the scoring unit 70, the base control unit 80, the victory/defeat determining unit 85, the restriction generating unit 87, the limit time control unit 90, the character information storage unit 250, the team information storage unit 252, the player information storage unit 254, and the play field information storage unit 256 described over FIGS. 1 to 20.

### Advantageous Effects

In the game system 1 according to an exemplary embodiment, a player can acquire points by blowing down a neutral character automatically controlled in the system by operating his or her player character and convert the acquired points into a score of his or her team at the base of an opponent. In accordance with this, in the game system 1, a player can enjoy a game without performing an inter-person battle with a player character of an opponent operated by another player and contribute to a team to which he or she belongs without performing an inter-person battle. In other words, in the game system 1, a player can contribute to a team to which he or she belongs by performing an action other than an inter-person battle (an action of blowing down a neutral character or the like) in a game and improve a degree of skill of an operation required for an inter-person battle in accordance with this action. Thus, by experiencing a battle with a neutral character, a player can reduce an awareness of being hard to deal with an inter-person battle.

In addition, in the game system 1, a player can set a neutral character that has been blown down by his or her player character as an ally character in association with the player, cause this ally character to appear in the play field 300, and cause the ally character to follow movement of the player character and automatically attack on another neutral character and an enemy player character. In this way, in the game system 1, a player can not only blow down a neutral character by fighting against it but set the neutral character as an ally and cause this neutral character to fight together with his or her player character.

In addition, in the game system 1, a player can freely select storage of an ally character in the character storage area and to cause the ally character to appear from the character storage area in the play field 300. In other words, in the game system 1, before scoring points owned by a player of a player character, an owned ally character can be caused to appear in the play field 300 and can be used as a fighting power fighting together with the player character. In accordance with this, in the game system 1, for example, the ally character can be caused to appear in the play field 300 and co-fight together while the HP of the ally character is high, and the ally character can be stored in the character storage area and used for scoring in a case in which the HP becomes low.

Then, in the game system 1, a total of scores of each team is not displayed in the display unit 10 during execution of a game, and after the end of the game, a total of scores of each team, a victory/defeat of the game, and a score progress of each player character can be displayed. In this way, in the game system 1, players can be caused not to clearly recognize a victory/defeat of a fight during execution of a game, and thus desire of players can be suppressed from being reduced till the end of the game, and an exciting fight can be maintained until the final stage of the game. In addition, in the game system 1, an obtained score of each player character at a certain timing during execution of a game can be checked after the end of the game. In this way, according to the game system 1, a player can perceive whether or not there is difficulty in his or her game play in any one of a first half, a middle stage, a second half, and the like of the game and can have perceived details to be helpful to the play of the next time and thereafter. In other words, a player can perceive whether or not there was difficulty in his or her play in a certain time frame during an execution time of a game and look back the game, whereby a game play of the next time and thereafter can be configured to be better.

While exemplary embodiments embodiment of the present disclosure have been described above, the exemplary embodiments described above are not intended to limit the disclosure as set forth in the scope of claims. In addition, it should be noted that not all combinations of features described in the embodiment are essential as solutions to the problem addressed by the disclosure. Furthermore, technical elements of the embodiment described above can be applied independently or applied by being divided into a plurality of units such as program components and hardware components.

### REFERENCE SIGNS LIST

1 Game system
3, 3a, 3n Information terminal
5 Communication network
7 Server
10 Display unit
15 Display control unit
20 Input unit
25 Storage unit
30 Character operation control unit
35 Appearance control unit
40 Fighting control unit
45 Fighting result determining unit
50 Character state determining unit
55 Ally character control unit
57 Special character control unit
60 Experience value assigning unit
62 Point assignment control unit
64 Evolution control unit
70 Scoring unit
80 Base control unit
85 Victory/defeat determining unit
87 Restriction generating unit
90 Limit time control unit
200 Input screen
210 Input control unit
212 Movement instruction input area
214 Direction display area
216 Direction instruction section
250 Character information storage unit
252 Team information storage unit
254 Player information storage unit
256 Play field information storage unit
300 Play field
302 Ally headquarter
304 Enemy headquarter
306 Lane
310 Ally base
312 Enemy base
314 Neutral area
316 Center part
318 Entire view
320 Character storage area
322 Storage character display
324 Count-down display
330 Endurance value
332 Remaining endurance value
400, 402, 404, 406 Player character
410, 410a Neutral character
412 Ally character
414 First special character
411, 411a, 415 Status
416 Second special character
420 Enemy player character
430, 432 Effective range
500, 500a Ally team score
500b Base ally score
500c Total score
502, 502a Enemy team score
502b Base enemy-side score
502c Total score
504 Remaining game time
506 Player score
510, 510a, 511 Status
512, 514, 516, 518 Point display
520, 522 Total graph
530, 532 Mark
550 Time axis
560, 560a, 560b, 560c, 560d Ally player character score progress
562, 562a, 562b, 562c, 562d Enemy player character score progress
570 Switching tap
600 Attack instruction area
602 Technique generation area
700 Return instruction area
800 Performance display
802 Display
900 Restriction area

1. A game system in which an ally team to which a player belongs and an enemy team to which other players belong contend with each other on a play field displayed on a display, the game system comprising:
processing circuitry configured to
control display of the display;
control assignment of predetermined points associated with a neutral character to the player based on a result of a fight when the neutral character that operates without being operated by the player and the other players and is associated with the predetermined points and the player character fight each other;
set points assigned to the player as a score of the ally team in a case in which the player character is positioned inside a predetermined area disposed inside the play field; and
determine victory or defeat by comparing a score of the ally team with a score of the enemy team,
wherein the display, before victory or defeat is determined, does not display totals of scores of the ally team and the enemy team on the display, and after victory or defeat is determined, displays totals of scores of the ally team and the enemy team and displays score progress of each of one or more player characters belonging to the ally team on the display.

2. The game system according to claim 1,
wherein the neutral character includes a special character, and
wherein, in a case in which points associated with the special character are acquired by the player in accordance with the player character winning a fight against the special character, the processing circuitry is further configured to display the score progress including a predetermined mark at a time point of this victory.

3. The game system according to claim 2,
wherein the predetermined area is an enemy base of the enemy team disposed inside the play field,
wherein, in a case in which the player character is positioned in the enemy base, the processing circuitry is further configured to
set the points owned by the player as a score of the ally team in accordance with a predetermined operation of the player, and
supply a supply value corresponding to the score to the enemy base to accumulate the supply value in the enemy base, and
wherein an endurance value is set in advance for the enemy base,
wherein the processing circuitry is further configured to stop a function of the enemy base in a case in which a sum value of the supply values accumulated in the enemy base becomes equal to or greater than the endurance value.

4. The game system according to claim 3, wherein the processing circuitry is further configured to
display a value acquired by subtracting the supply value from the endurance value and the endurance value near the enemy base.

5. A game method of a game system in which an ally team to which a player belongs and an enemy team to which other players belong contend with each other on a play field displayed on a display, the game method comprising:
controlling display of the display;
controlling assignment of predetermined points associated with a neutral character to the player based on a result of a fight when the neutral character that operates without being operated by the player and the other players and is associated with the predetermined points and the player character fight each other;
setting points assigned to the player as a score of the ally team in a case in which the player character is positioned inside a predetermined area disposed inside the play field; and
determining victory or defeat by comparing a score of the ally team with a score of the enemy team,
wherein, before victory or defeat is determined, totals of scores of the ally team and the enemy team are not displayed on the display, and after victory or defeat is determined, totals of scores of the ally team and the enemy team are displayed and score progress of each of one or more player characters belonging to the ally team are displayed on the display.

6. A non-transitory computer-readable storage medium storing computer-readable instructions thereon corresponding to game program instructions for a game system in which an ally team to which a player belongs and an enemy team to which other players belong contend with each other on a play field displayed on a display, which when executed by a computer cause the computer to perform a method, the method comprising:
controlling display of the display;
controlling assignment of predetermined points associated with a neutral character to the player on the basis of a result of a fight when the neutral character that operates without being operated by the player and the other players and is associated with the predetermined points and the player character fight each other;
setting points assigned to the player as a score of the ally team in a case in which the player character is positioned inside a predetermined area disposed inside the play field; and
determining victory or defeat by comparing a score of the ally team with a score of the enemy team,
wherein before victory or defeat is determined, totals of scores of the ally team and the enemy team are not displayed on the display, and after victory or defeat is determined, totals of scores of the ally team and the enemy team and score progress of each of one or more player characters belonging to the ally team are displayed on the display.

7. A game server providing a game in which an ally team to which a player belongs and an enemy team to which other players belong contend with each other on a play field displayed on a display, the game server comprising:
processing circuitry configured to
control display of the display;
control assignment of predetermined points associated with a neutral character to the player based on a result of a fight when the neutral character that operates without being operated by the player and the other players and is associated with the predetermined points and the player character fight each other;
set points assigned to the player as a score of the ally team in a case in which the player character is positioned inside a predetermined area disposed inside the play field; and
determine victory or defeat by comparing a score of the ally team with a score of the enemy team,
wherein before victory or defeat is determined, does not display totals of scores of the ally team and the enemy team on the display unit, and after victory or defeat is determined, display totals of scores of the ally team and the enemy team and display score progress of each of one or more player characters belonging to the ally team on the display.

8. The game server of claim 7,
wherein the neutral character includes a special character, and
wherein, in a case in which points associated with the special character are acquired by the player in accordance with the player character winning a fight against the special character, the processing circuitry is further configured to display the score progress including a predetermined mark at a time point of this victory.

9. The game server of claim 8,
wherein the predetermined area is an enemy base of the enemy team disposed inside the play field,
wherein, in a case in which the player character is positioned in the enemy base, the processing circuitry is further configured to
set the points owned by the player as a score of the ally team in accordance with a predetermined operation of the player, and
supply a supply value corresponding to the score to the enemy base to accumulate the supply value in the enemy base, and
wherein an endurance value is set in advance for the enemy base,
wherein the processing circuitry is further configured to stop a function of the enemy base in a case in which a sum value of the supply values accumulated in the enemy base becomes equal to or greater than the endurance value.

10. The game server of claim 9, wherein the processing circuitry is further configured to
display a value acquired by subtracting the supply value from the endurance value and the endurance value near the enemy base.

11. The game method of claim 5, further comprising:
wherein the neutral character includes a special character, and
wherein, in a case in which points associated with the special character are acquired by the player in accordance with the player character winning a fight against the special character, displaying the score progress including a predetermined mark at a time point of this victory.

12. The method of claim 11, further comprising:
wherein the predetermined area is an enemy base of the enemy team disposed inside the play field,
wherein, in a case in which the player character is positioned in the enemy base,
setting the points owned by the player as a score of the ally team in accordance with a predetermined operation of the player; and
supplying a supply value corresponding to the score to the enemy base to accumulate the supply value in the enemy base; and
wherein an endurance value is set in advance for the enemy base,
stopping a function of the enemy base in a case in which a sum value of the supply values accumulated in the enemy base becomes equal to or greater than the endurance value.

13. The method of claim 12, further comprising:
displaying a value acquired by subtracting the supply value from the endurance value and the endurance value near the enemy base.

14. The non-transitory computer-readable storage medium of claim 6, further comprising:
wherein the neutral character includes a special character, and
wherein, in a case in which points associated with the special character are acquired by the player in accordance with the player character winning a fight against the special character, displaying the score progress including a predetermined mark at a time point of this victory.

15. The non-transitory computer-readable storage medium of claim 14, further comprising:
wherein the predetermined area is an enemy base of the enemy team disposed inside the play field,
wherein, in a case in which the player character is positioned in the enemy base,
setting the points owned by the player as a score of the ally team in accordance with a predetermined operation of the player; and
supplying a supply value corresponding to the score to the enemy base to accumulate the supply value in the enemy base; and
wherein an endurance value is set in advance for the enemy base,
stopping a function of the enemy base in a case in which a sum value of the supply values accumulated in the enemy base becomes equal to or greater than the endurance value.

16. The non-transitory computer-readable storage medium of claim 15, further comprising:
displaying a value acquired by subtracting the supply value from the endurance value and the endurance value near the enemy base.
